(19) United States
(12) Patent Application Publication
(10) Pub. No.: US 2015/0309973 A1
(43) Pub. Date: Oct. 29, 2015

(54) METHODS, SYSTEMS, AND DEVICES FOR MACHINES AND MACHINE STATES THAT FACILITATE MODIFICATION OF DOCUMENTS BASED ON VARIOUS CORPORA AND/OR MODIFICATION DATA

(71) Applicant: Elwha LLC, Bellevue, WA (US)

(72) Inventors: Ehren Brav, Bainbridge Island, WA (US); Alexander J. Cohen, Mill Valley, CA (US); Edward K.Y. Jung, Bellevue, WA (US); Royce A. Levien, Lexington, MA (US); Richard T. Lord, Gig Harbor, WA (US); Robert W. Lord, Seattle, WA (US); Mark A. Malamud, Seattle, WA (US); Clarence T. Tegreene, Mercer Island, WA (US)

(73) Assignee: Elwha LLC,

(21) Appl. No.: 14/315,945

(22) Filed: Jun. 26, 2014

Related U.S. Application Data
(63) Continuation-in-part of application No. 14/263,816, filed on Apr. 28, 2014.
Application No. 14/263,816 is a continuation-in-part of application No. 14/291,826, filed on May 30, 2014.
Application No. 14/291,826 is a continuation of application No. 14/291,354, filed on May 30, 2014.

(51) Int. Cl. G06F 17/24; G06F 17/21

(52) U.S. Cl. CPC G06F 17/24; G06F 17/212

(57) ABSTRACT

Computationally implemented methods and systems include accepting a submission of a particular document that includes at least one particular lexical unit, facilitating acquisition of document modification data that includes data configured to be used to determine a modification to the particular document, and receiving an updated document in which at least a portion of at least one occurrence of the at least one particular lexical unit has been replaced with at least a portion of an acquired replacement lexical unit that is at least partly based on the document modification data. In addition to the foregoing, other aspects are described in the claims, drawings, and text.

### CROSS-REFERENCE TO RELATED APPLICATIONS

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application constitutes a continuation-in-part of U.S. patent application Ser. No. 14/263,816, entitled METHODS, SYSTEMS, AND DEVICES FOR MACHINES AND MACHINE STATES THAT ANALYZE AND MODIFY DOCUMENTS AND VARIOUS CORPORA, naming Ehren Bray, Alex Cohen, Edward K. Y. Jung, Royce A. Levien, Richard T. Lord, Robert W. Lord, Mark A. Malamud, and Clarence T. Tegreene, filed 28 Apr. 2014 with attorney docket no. 0913-003-001-000000, which is currently co-pending or is an application of which a currently co-pending application is entitled to the benefit of the filing date.

The present application constitutes a continuation-in-part of U.S. patent application Ser. No. 14/291,826, entitled METHODS, SYSTEMS, AND DEVICES FOR MACHINES AND MACHINE STATES THAT FACILITATE MODIFICATION OF DOCUMENTS BASED ON VARIOUS CORPORA, naming Ehren Bray, Alex Cohen, Edward K. Y. Jung, Royce A. Levien, Richard T. Lord, Robert W. Lord, Mark A. Malamud, and Clarence T. Tegreene, as inventors, filed 30 May 2014 with attorney docket no. 0913-003-010-000000, which is currently co-pending or is an application of which a currently co-pending application is entitled to the benefit of the filing date, and which is a continuation of U.S. patent application Ser. No. 14/291,354, entitled METHODS, SYSTEMS, AND DEVICES FOR MACHINES AND MACHINE STATES THAT FACILITATE MODIFICATION OF DOCUMENTS BASED ON VARIOUS CORPORA, naming Ehren Bray, Alex Cohen, Edward K. Y. Jung, Royce A. Levien, Richard T. Lord, Robert W. Lord, Mark A. Malamud, and Clarence T. Tegreene, as inventors, filed 30 May 2014 with attorney docket no. 0913-003-003-000000.

### RELATED APPLICATIONS

None.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BACKGROUND

This application is related to machines and machine states for analyzing and modifying documents, and machines and machine states for retrieval and comparison of similar documents, through corpora of persons or related works.

### SUMMARY

Recently, there has been an increase in an availability of documents, whether through public wide-area networks (e.g., the Internet), private networks, “cloud” based networks, distributed storage, and the like. These available documents may be collected and/or grouped in a corpus, and it may be possible to view or find many corpora (the plural of corpus) that would have required substantial physical resources to search or collect in the past.

In addition, persons now collect various works of research, science, and literature in electronic format. The rise of e-books allows people to store large libraries, which otherwise would take rooms of books to store, in a relatively compact space. Moreover, the rise of e-books and other online publications, e.g., blogs, e-magazines, self-publishing, and the like, has removed many of the barriers to entry to publishing original works, whether fiction, research, analysis, or criticism.

Therefore, a need has arisen for systems and methods that can modify documents based on an analysis of one or more corpora. The following pages disclose methods, systems, and devices for analyzing and modifying documents, and machines and machine states for retrieval and comparison of similar documents, through corpora of persons or related works.

In one or more various aspects, a method includes, but is not limited to, accepting a submission of a particular document that includes at least one particular lexical unit, facilitating acquisition of document modification data that includes data configured to be used to determine a modification to the particular document, and receiving an updated document in which at least a portion of at least one occurrence of the at least one particular lexical unit has been replaced with at least a portion of an acquired replacement lexical unit that is at least partly based on the document modification data. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for carrying out the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

In one or more various aspects, a system includes, but is not limited to, means for accepting a submission of a particular document that includes at least one particular lexical unit, means for facilitating acquisition of document modification data that includes data configured to be used to determine a modification to the particular document, and means for receiving an updated document in which at least a portion of at least one occurrence of the at least one particular lexical unit has been replaced with at least a portion of an acquired replacement lexical unit that is at least partly based on the document modification data. In addition to the foregoing, other system aspects are described in the claims, drawings, and text forming a part of the disclosure set forth herein.

In one or more various aspects, a system includes, but is not limited to, circuitry for accepting a submission of a particular document that includes at least one particular lexical unit, circuitry for facilitating acquisition of document modification data that includes data configured to be used to determine a modification to the particular document, and circuitry for receiving an updated document in which at least a portion of at least one occurrence of the at least one particular lexical unit has been replaced with at least a portion of an acquired replacement lexical unit that is at least partly based on the document modification data. In addition to the foregoing, other system aspects are described in the claims, drawings, and text forming a part of the disclosure set forth herein.

In one or more various aspects, a computer program product, comprising a signal bearing medium, bearing one or more instructions including, but not limited to, one or more instructions for accepting a submission of a particular document that includes at least one particular lexical unit, one or more instructions for facilitating acquisition of document modification data that includes data configured to be used to determine a modification to the particular document, and one or more instructions for receiving an updated document in which at least a portion of at least one occurrence of the at least one particular lexical unit has been replaced with at least a portion of an acquired replacement lexical unit that is at least partly based on the document modification data. In addition to the foregoing, other computer program product aspects are described in the claims, drawings, and text forming a part of the disclosure set forth herein.

In one or more various aspects, a device is defined by a computational language, such that the device comprises one or more interchained physical machines ordered for accepting a submission of a particular document that includes at least one particular lexical unit, one or more interchained physical machines ordered for facilitating acquisition of document modification data that includes data configured to be used to determine a modification to the particular document, and one or more interchained physical machines ordered for receiving an updated document in which at least a portion of at least one occurrence of the at least one particular lexical unit has been replaced with at least a portion of an acquired replacement lexical unit that is at least partly based on the document modification data.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1, including FIGS. 1A through 1AD, shows a high-level system diagram of one or more exemplary environments in which transactions and potential transactions may be carried out, according to one or more embodiments. FIG. 1 forms a partially schematic diagram of an environment(s) and/or an implementation(s) of technologies described herein when FIGS. 1A through 1AD are stitched together in the manner shown in FIG. 1Z, which is reproduced below in table format.

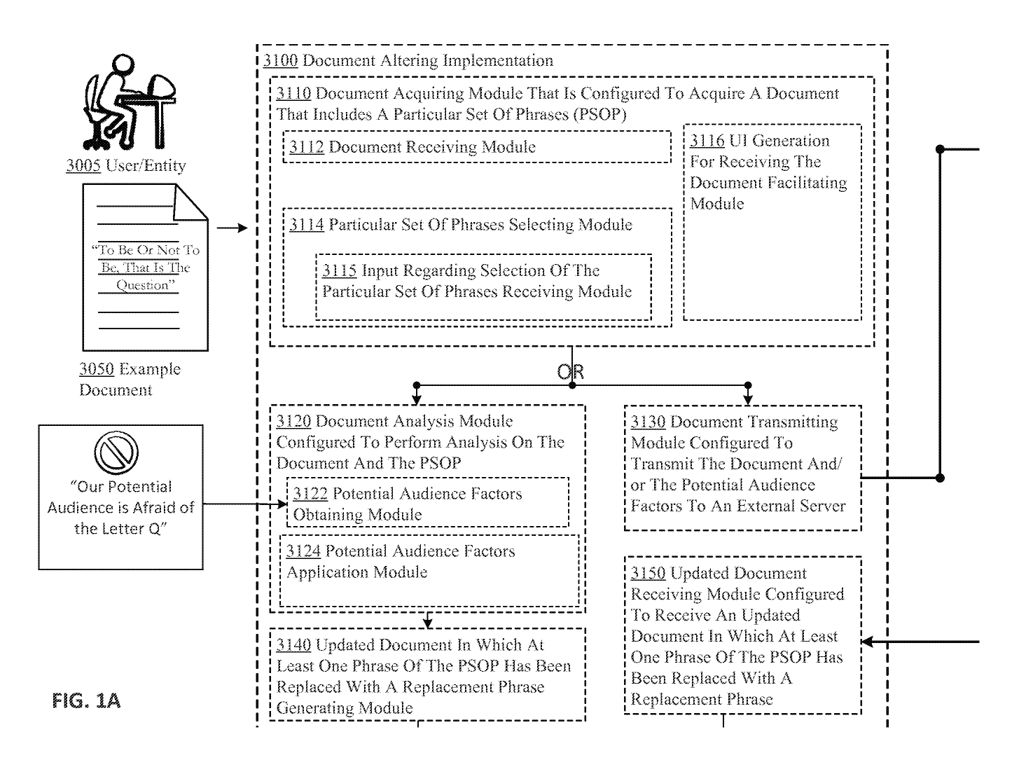

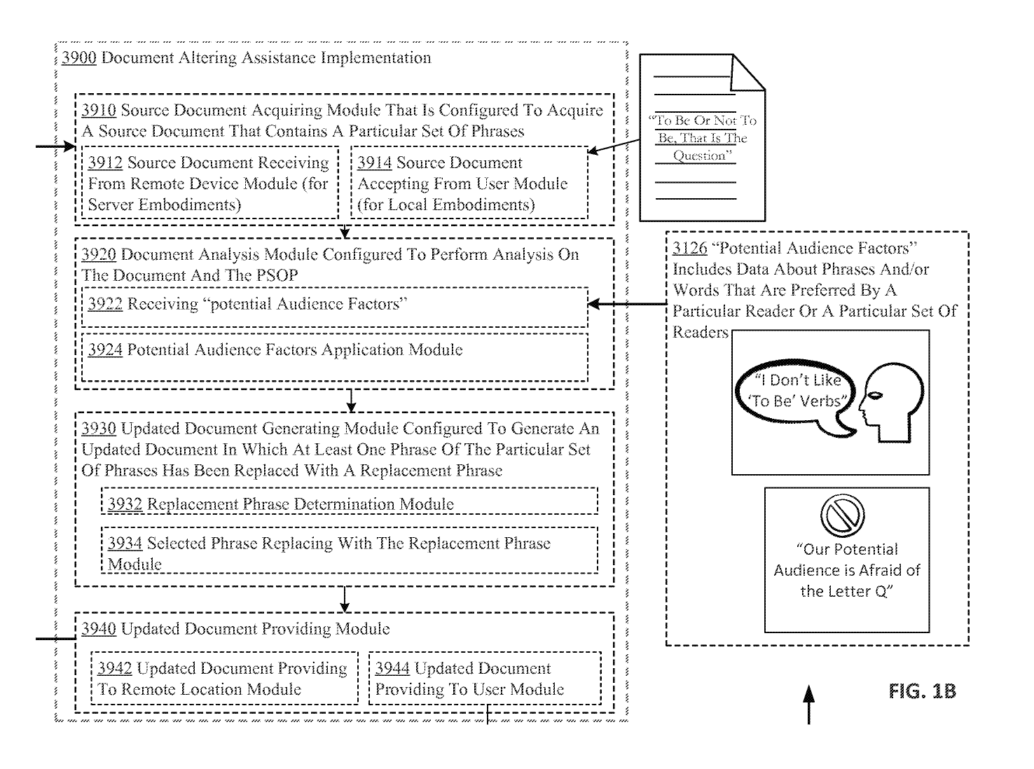

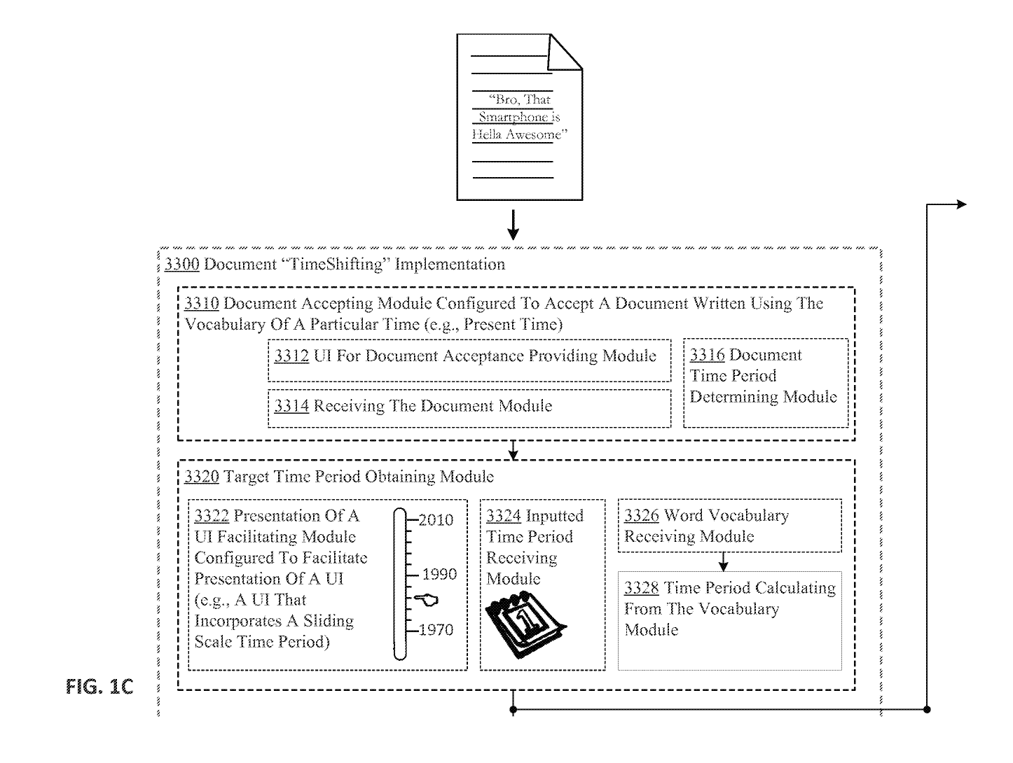

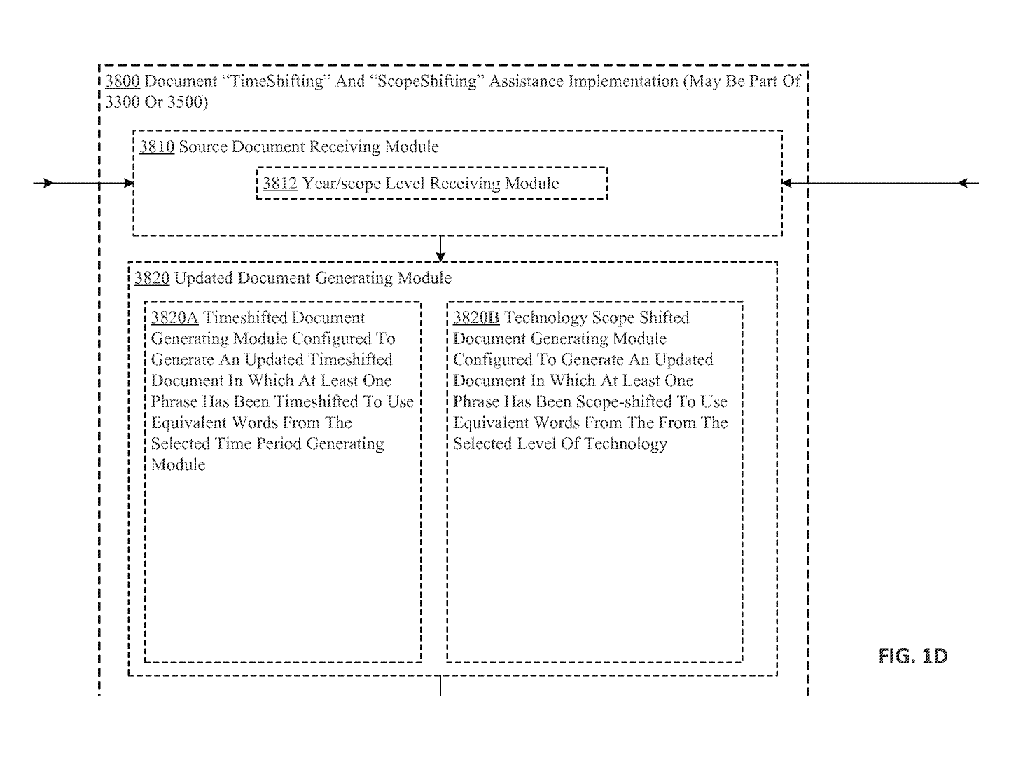

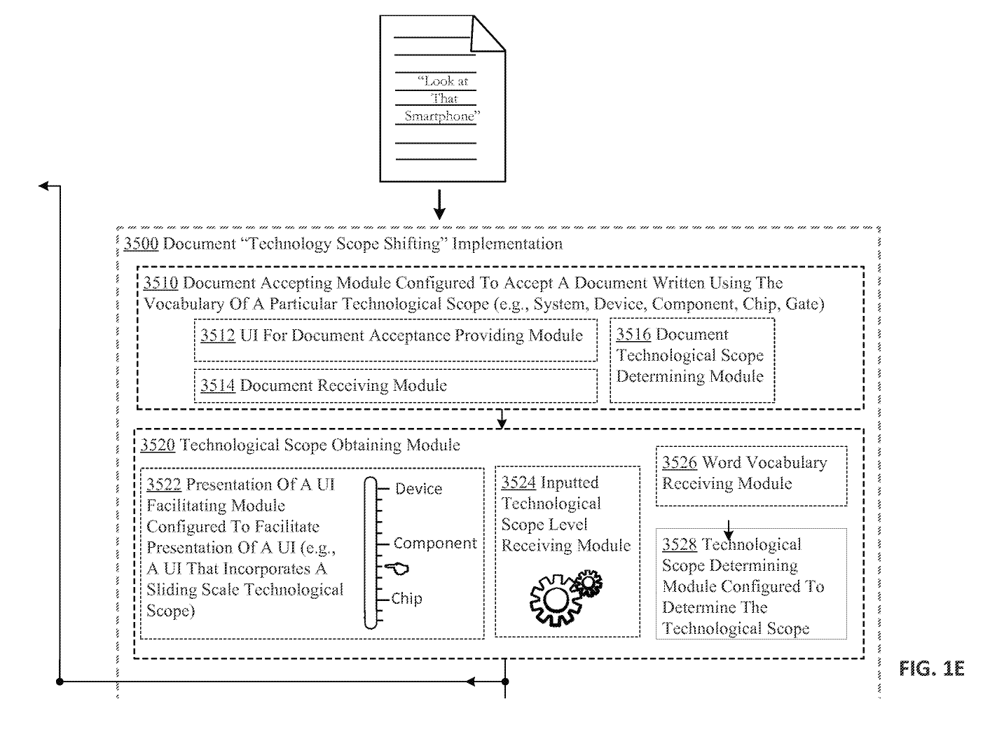

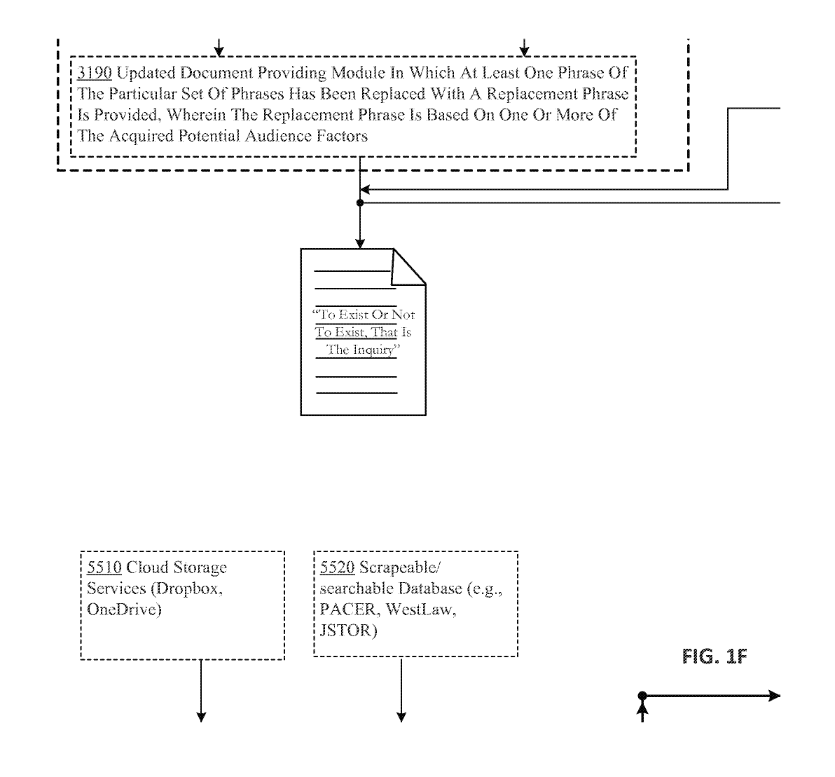

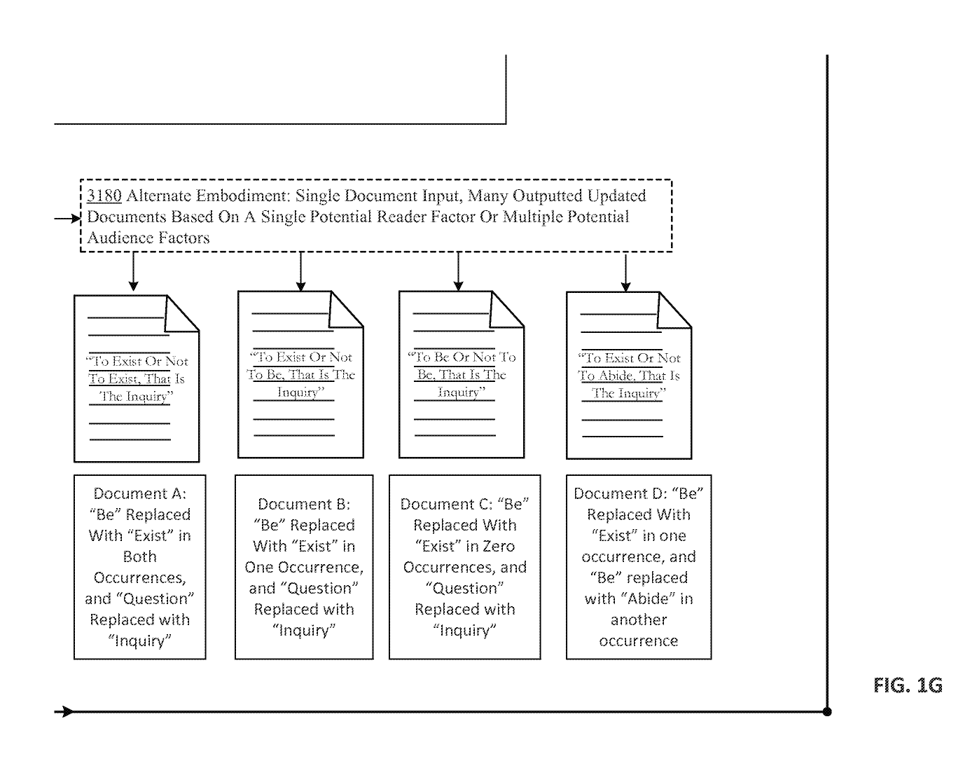

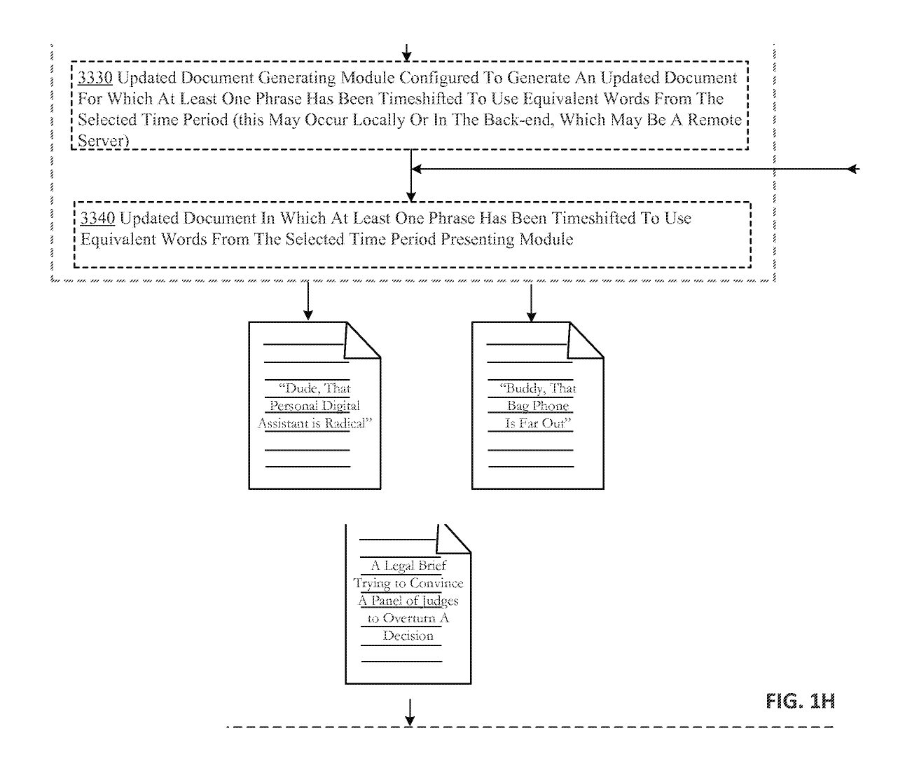

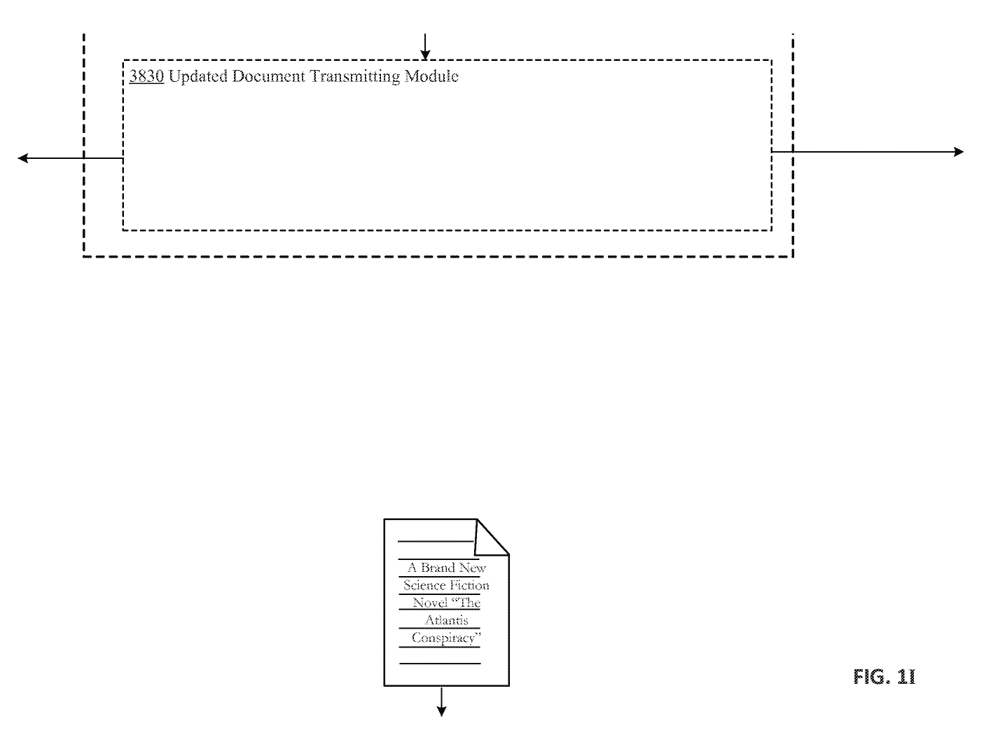

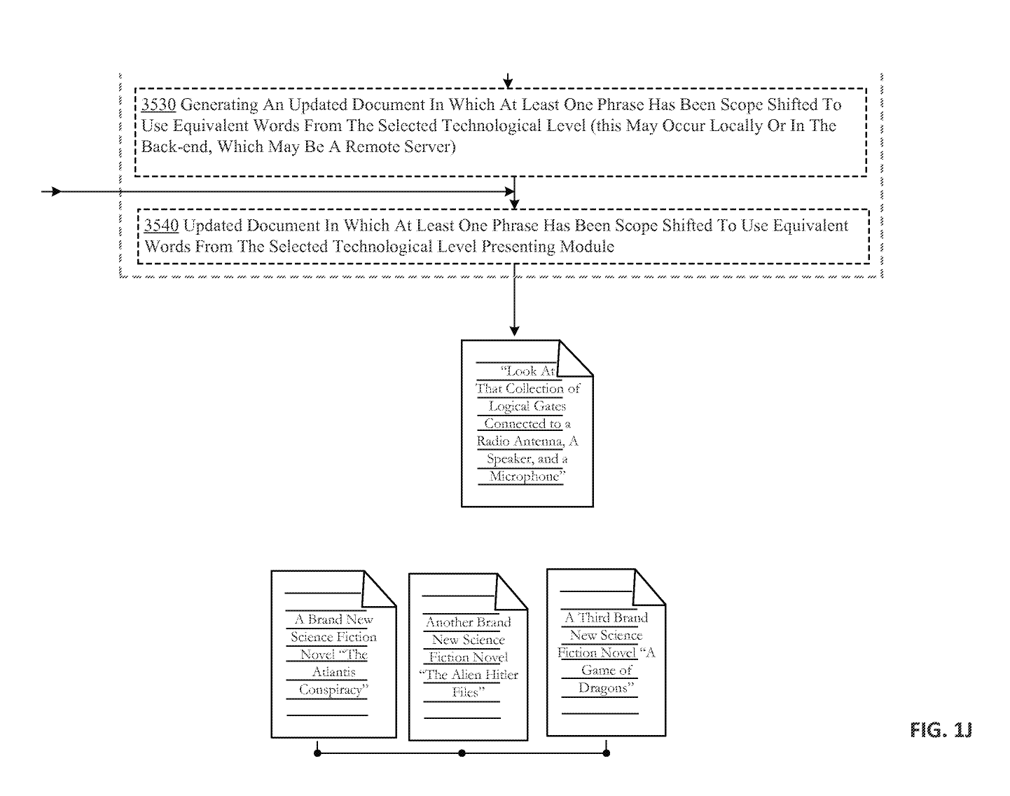

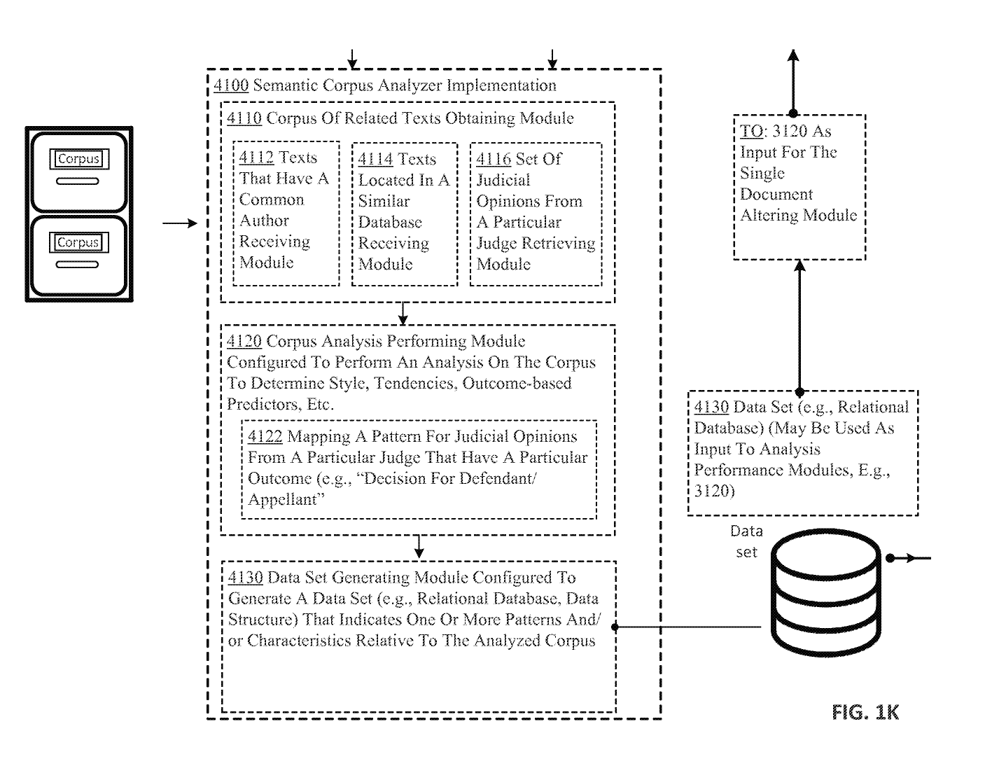

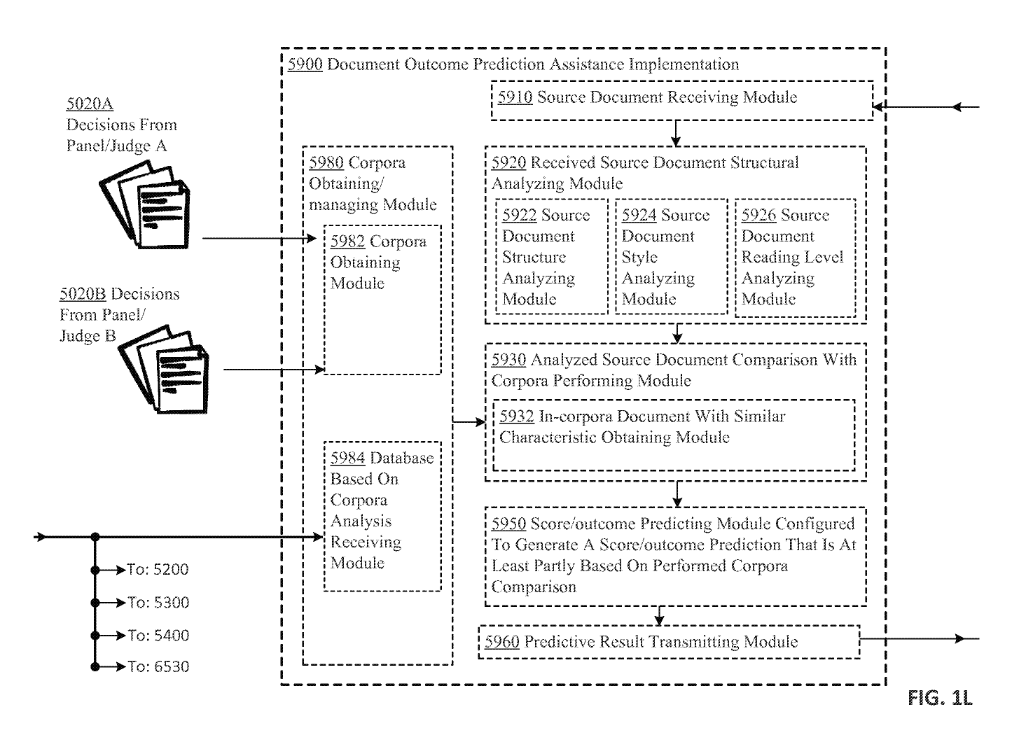

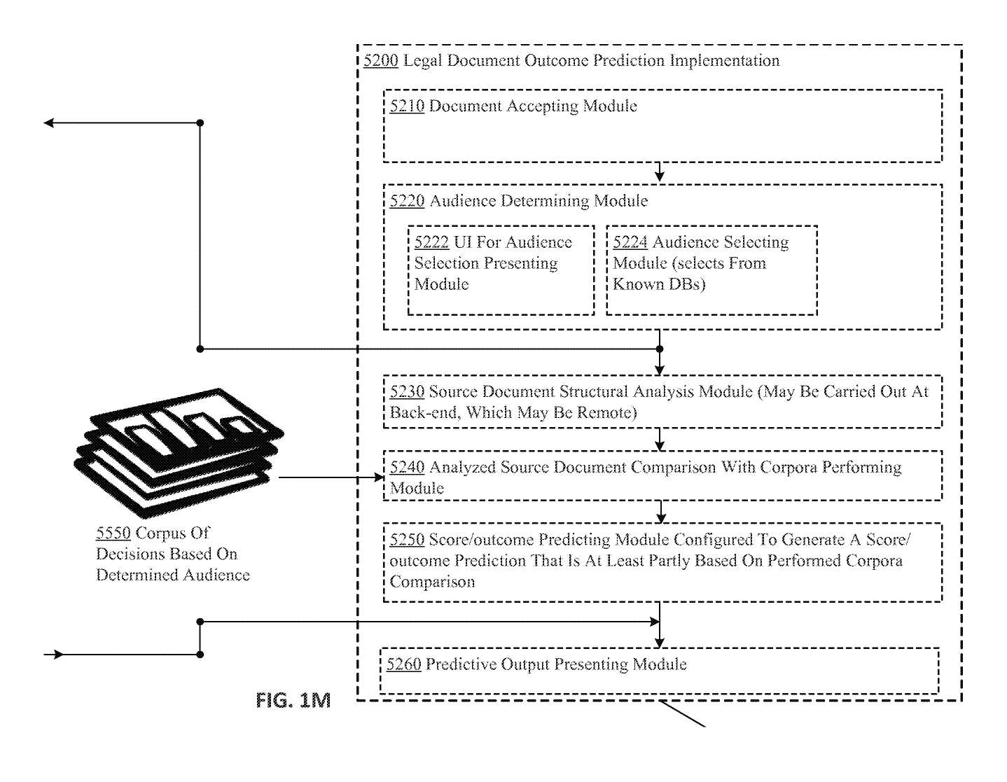

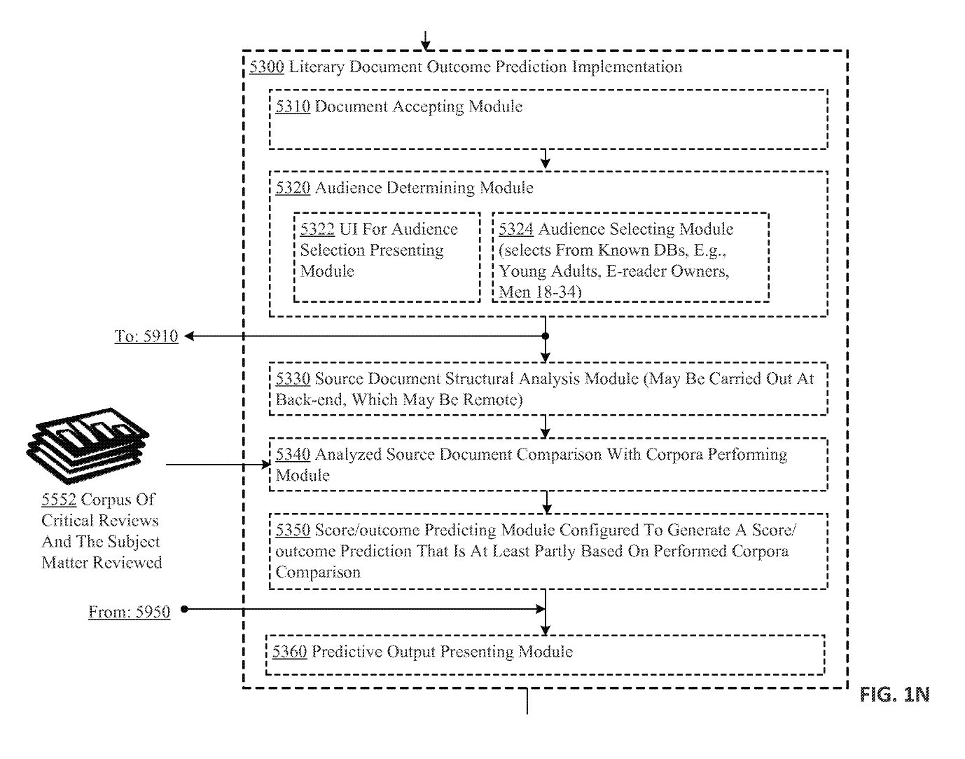

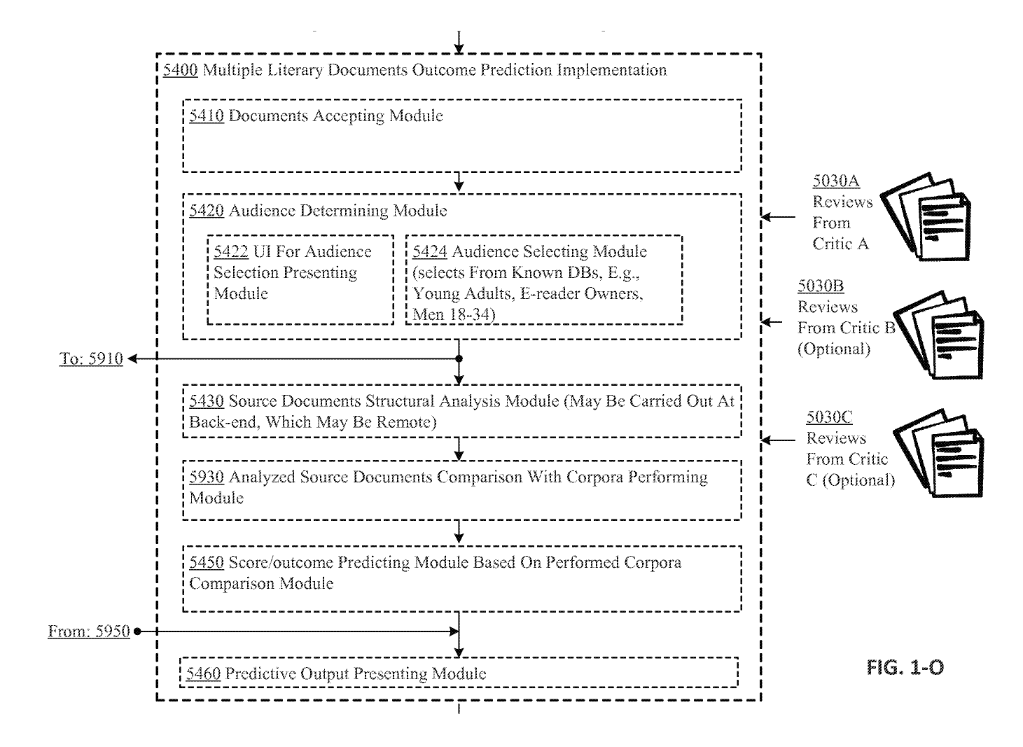

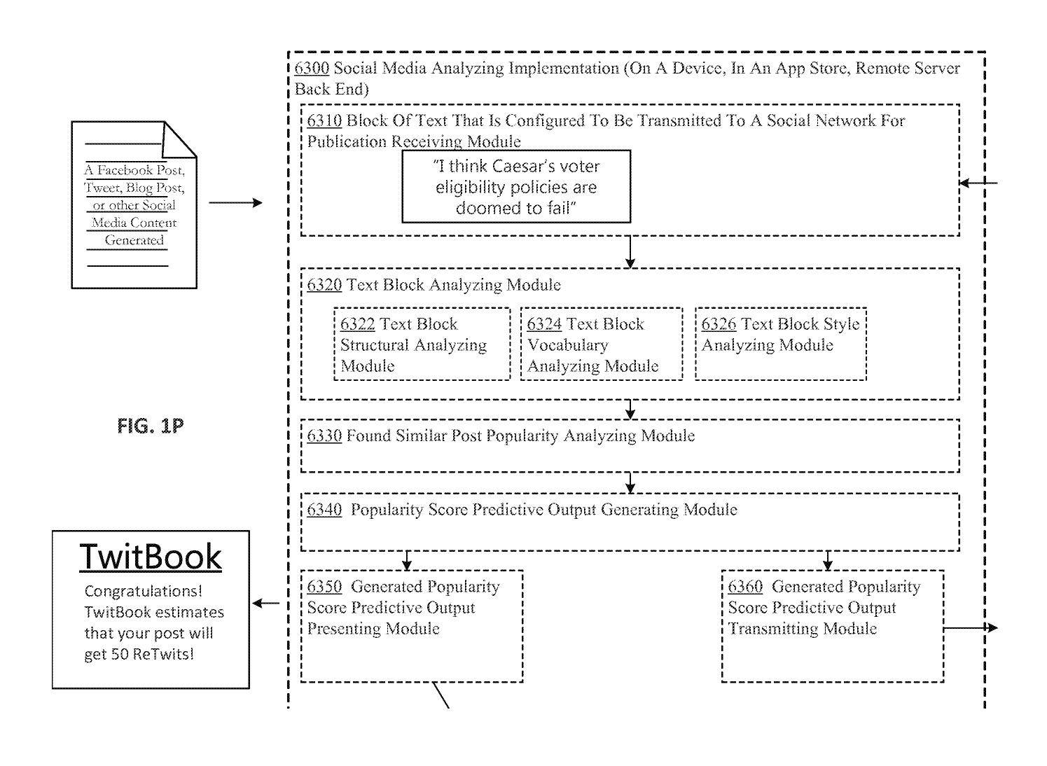

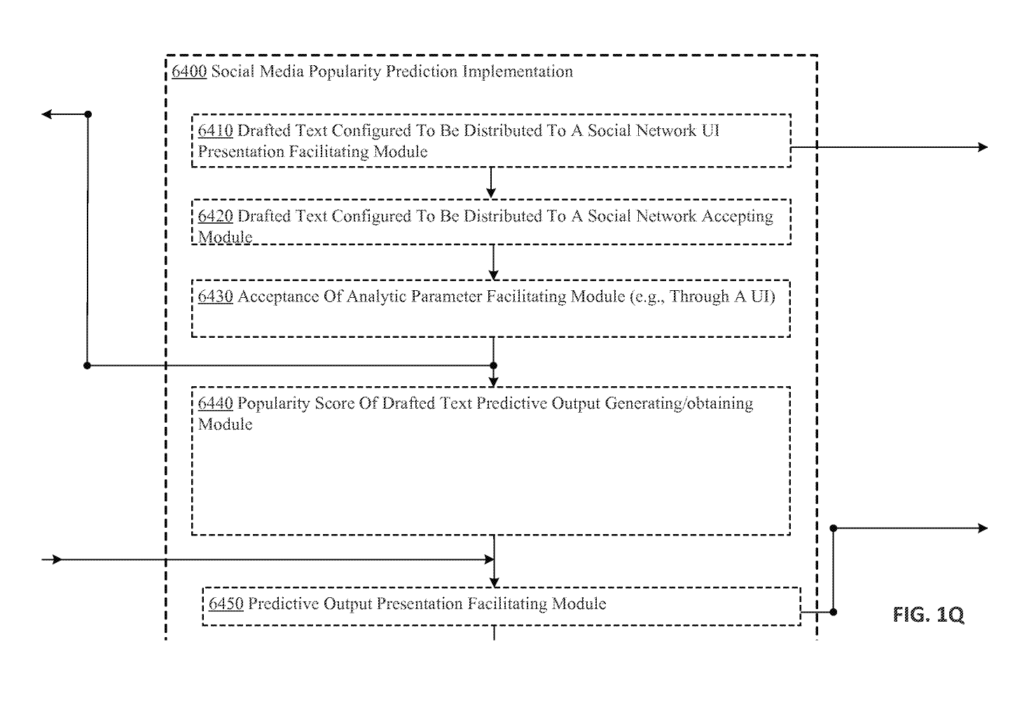

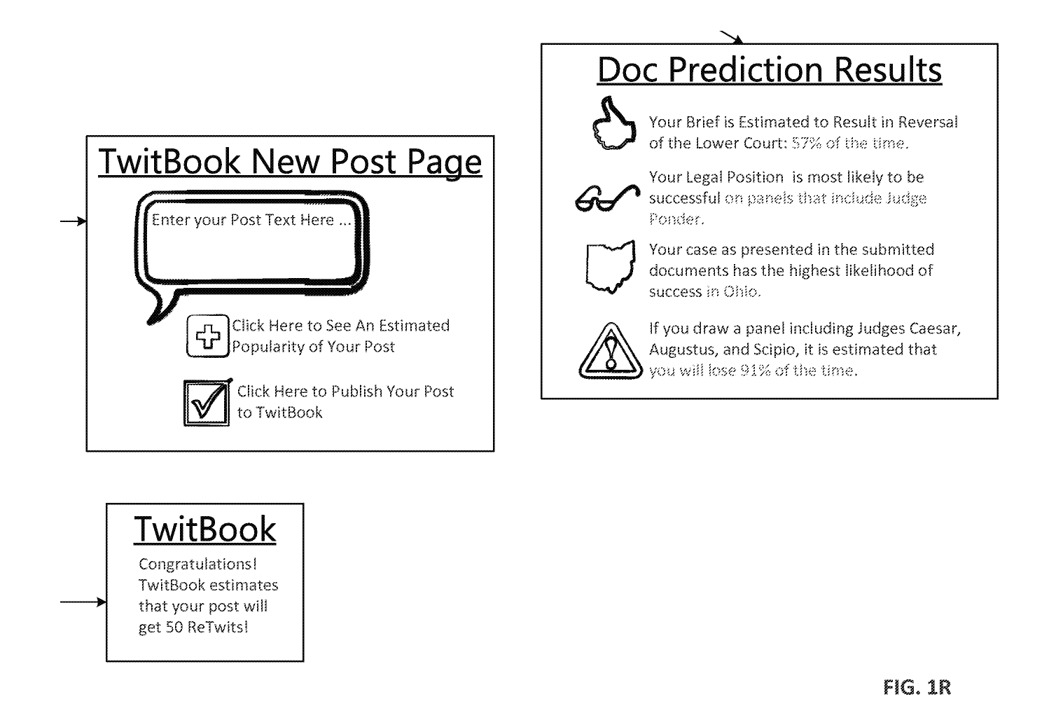

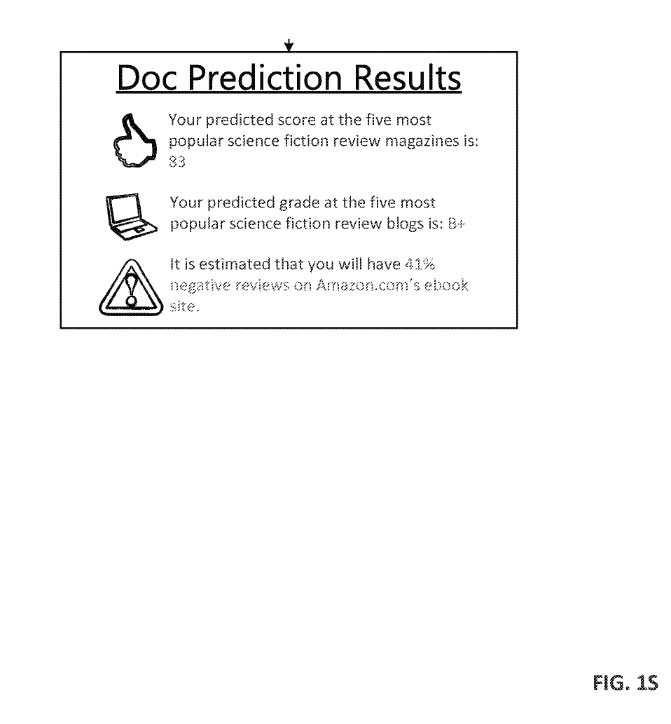

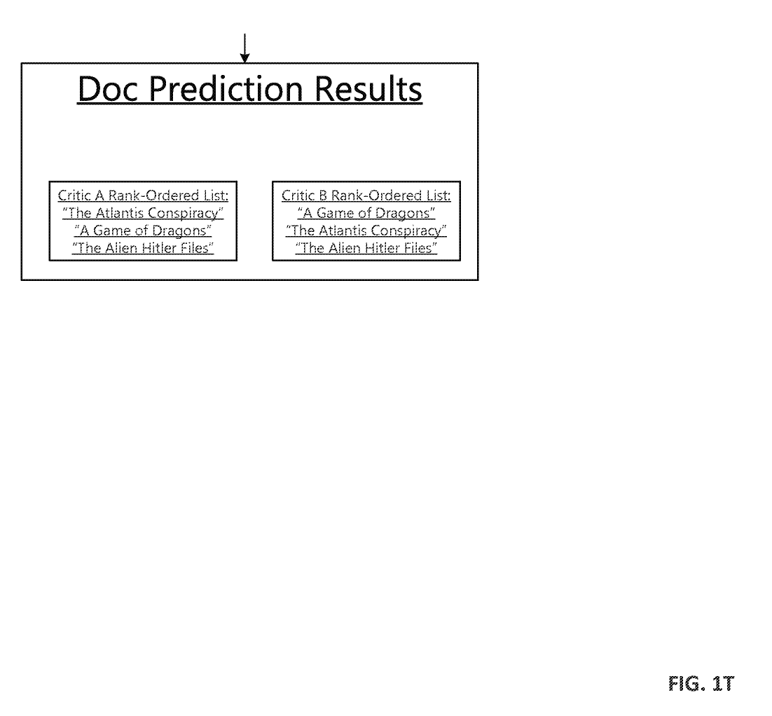

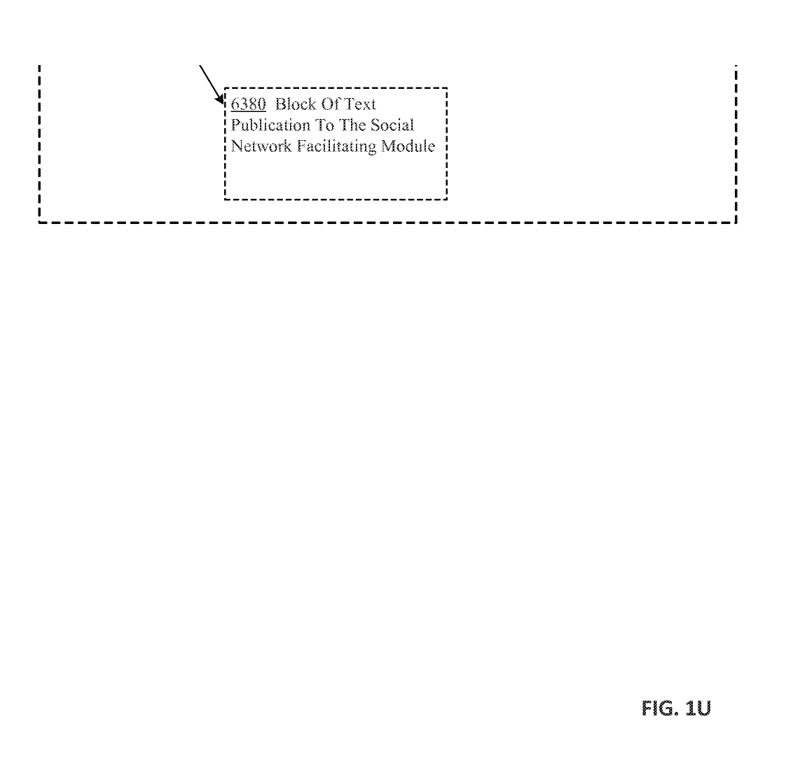

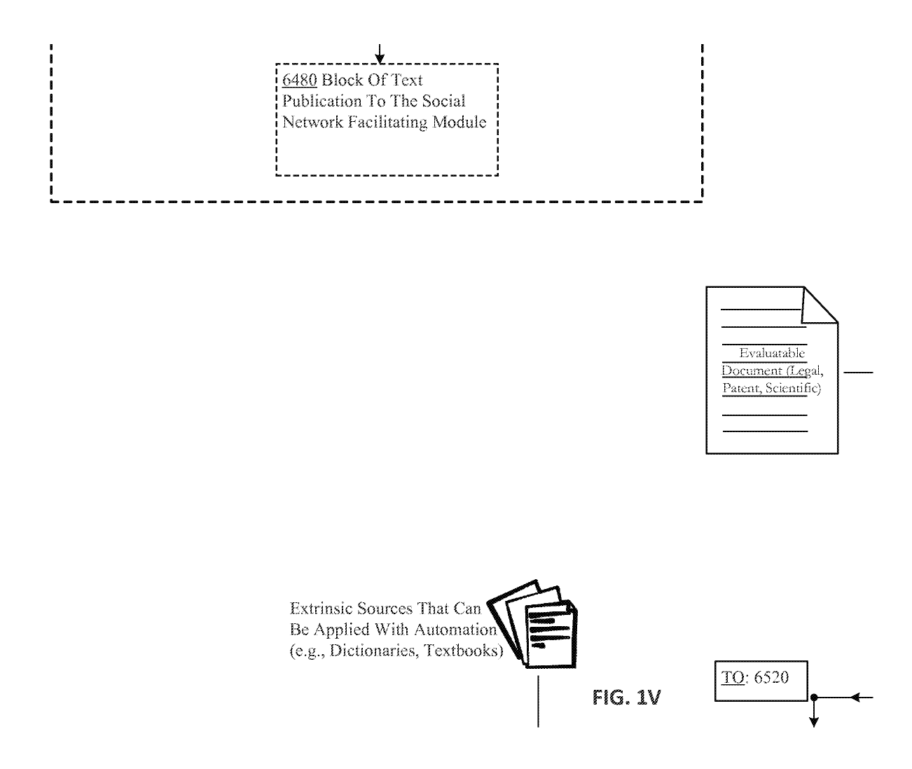

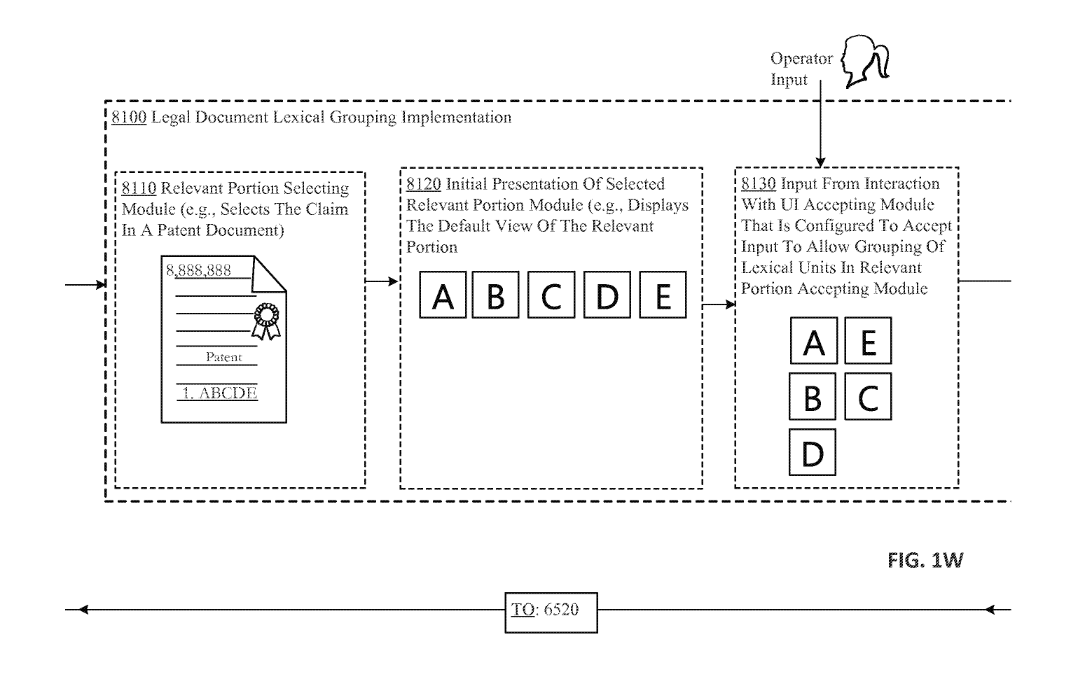

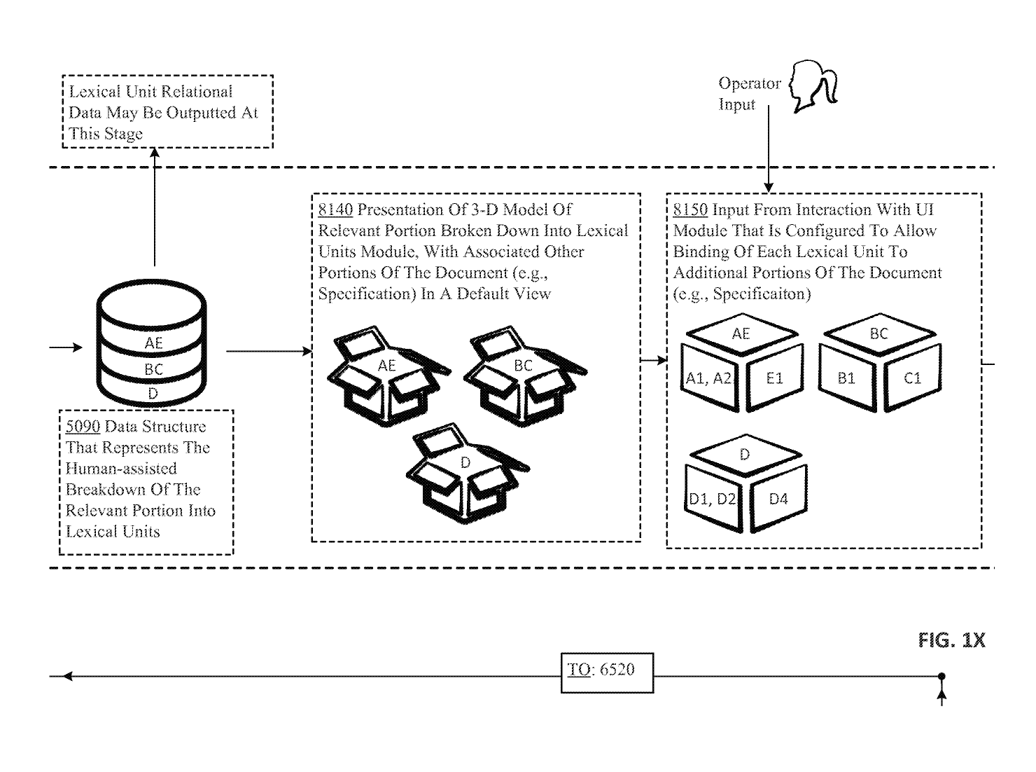

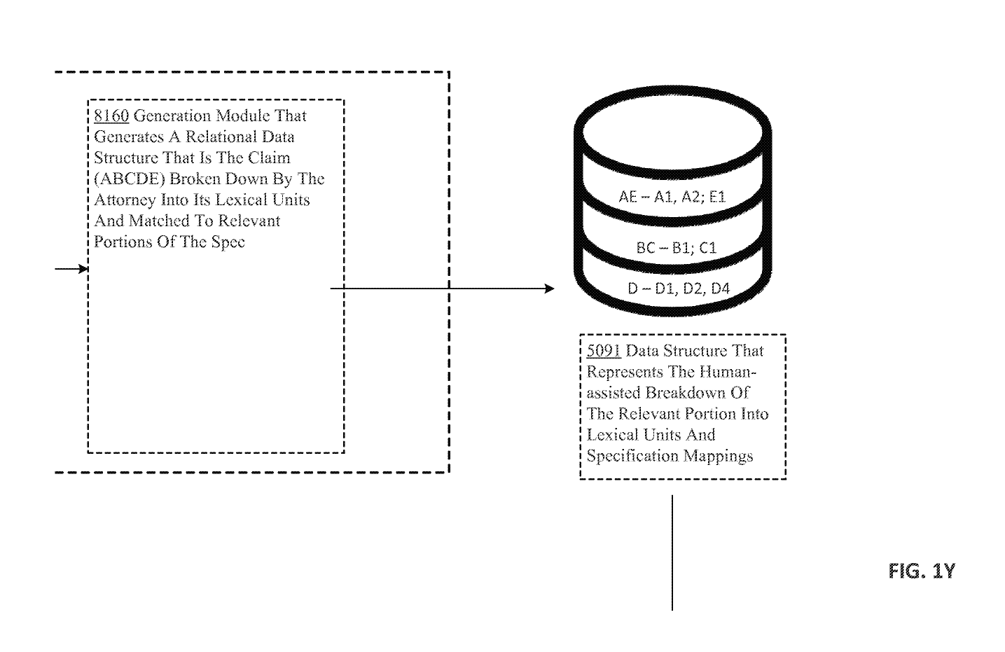

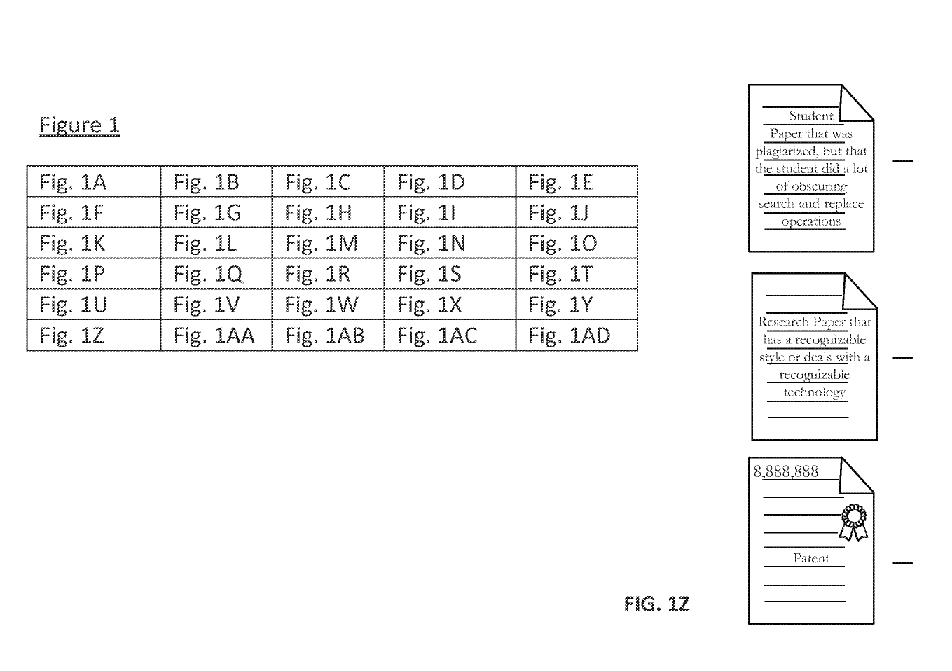

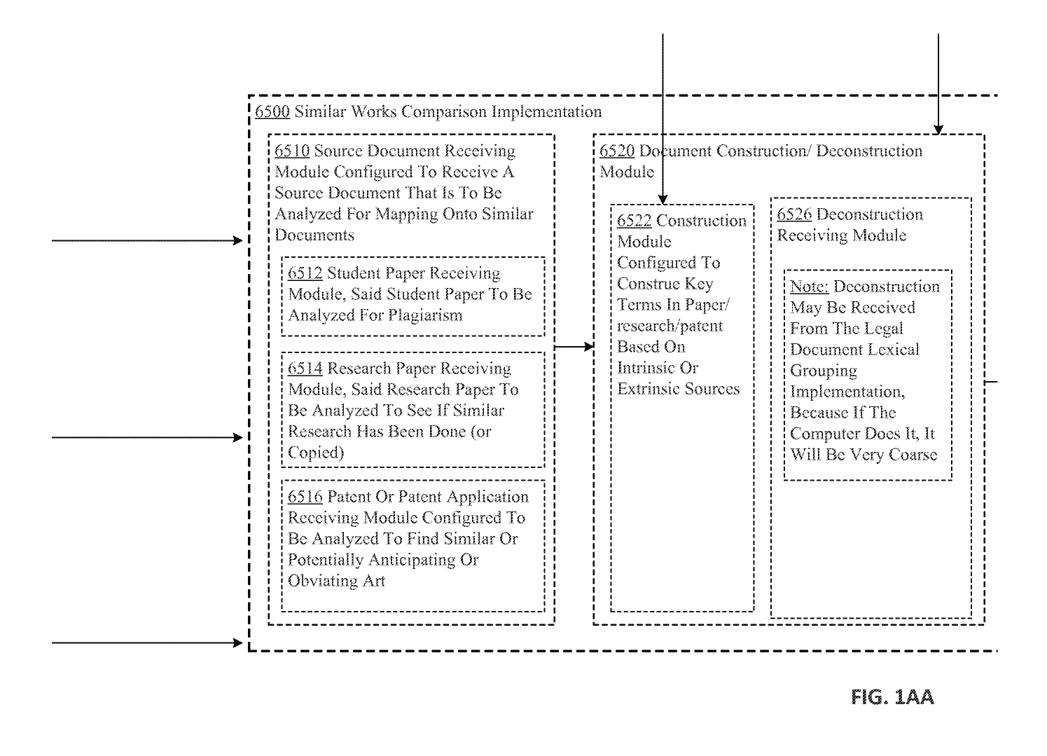

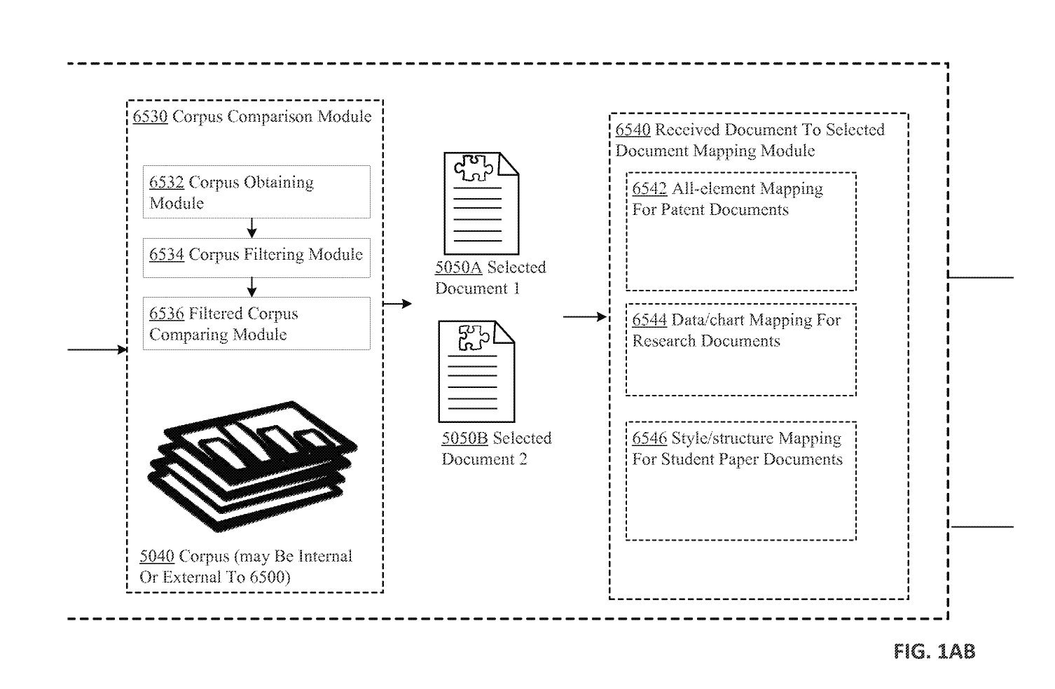

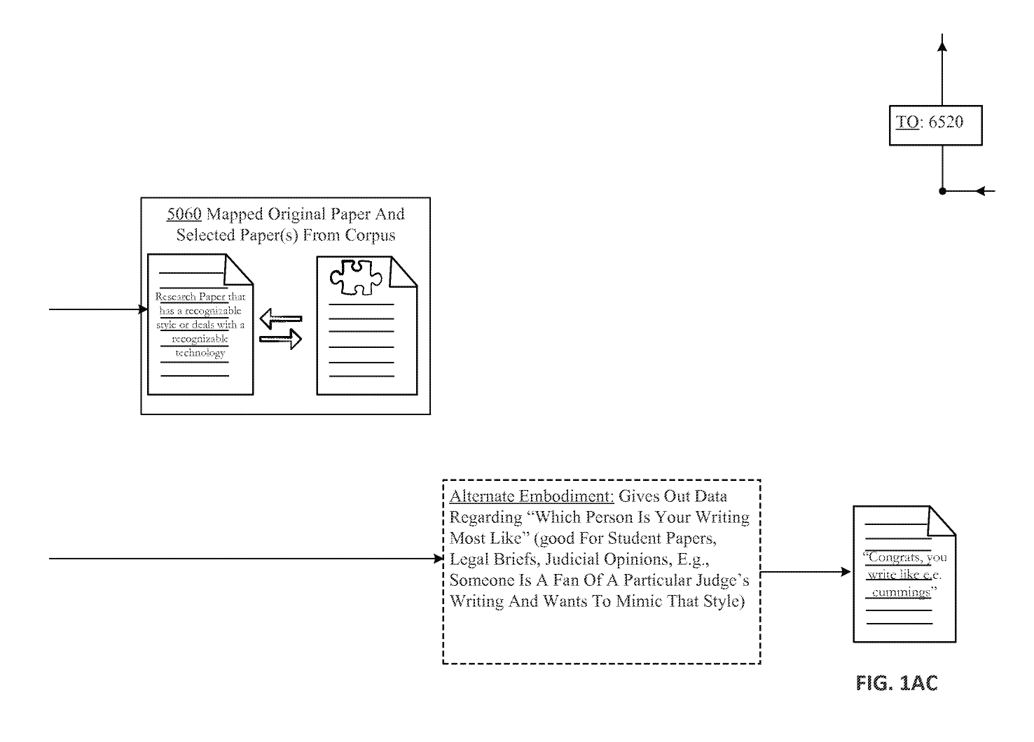

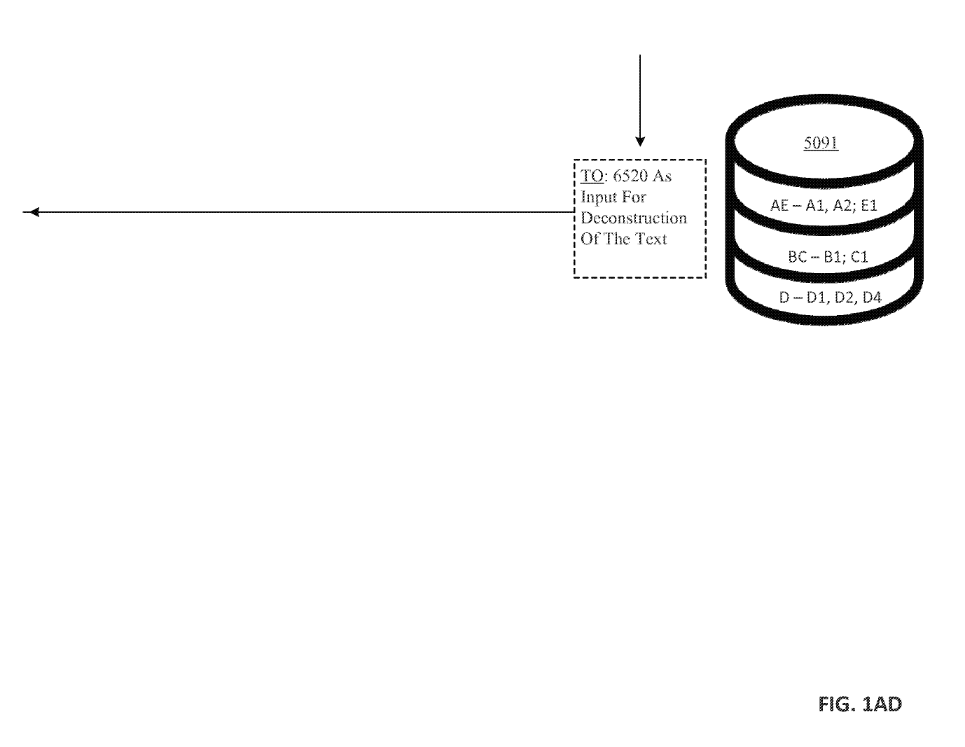

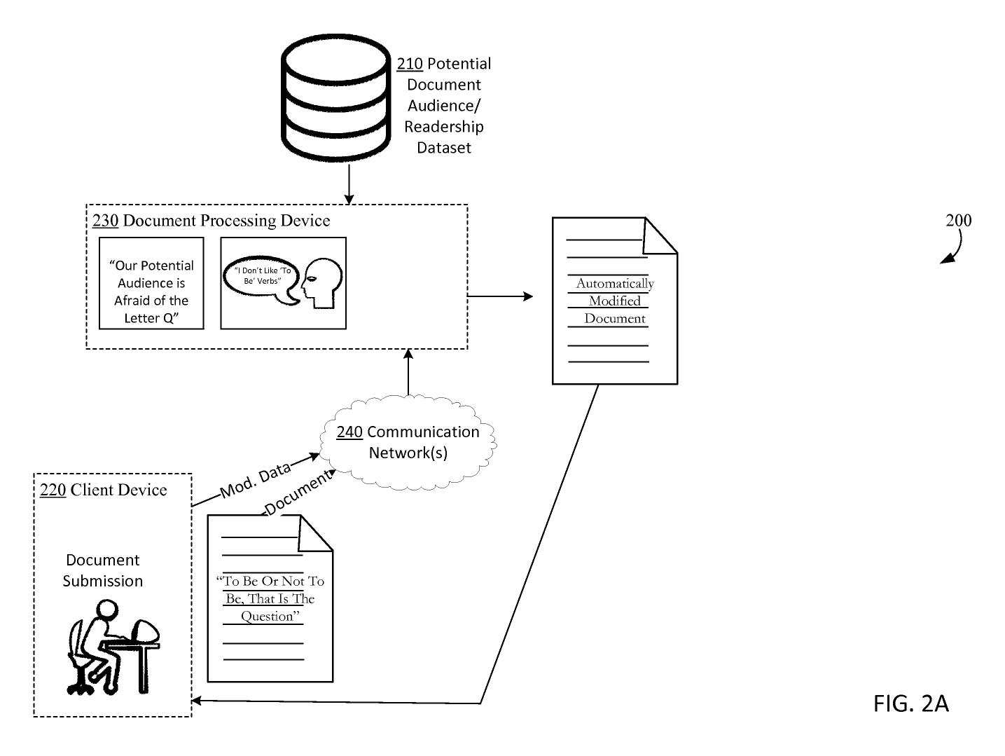

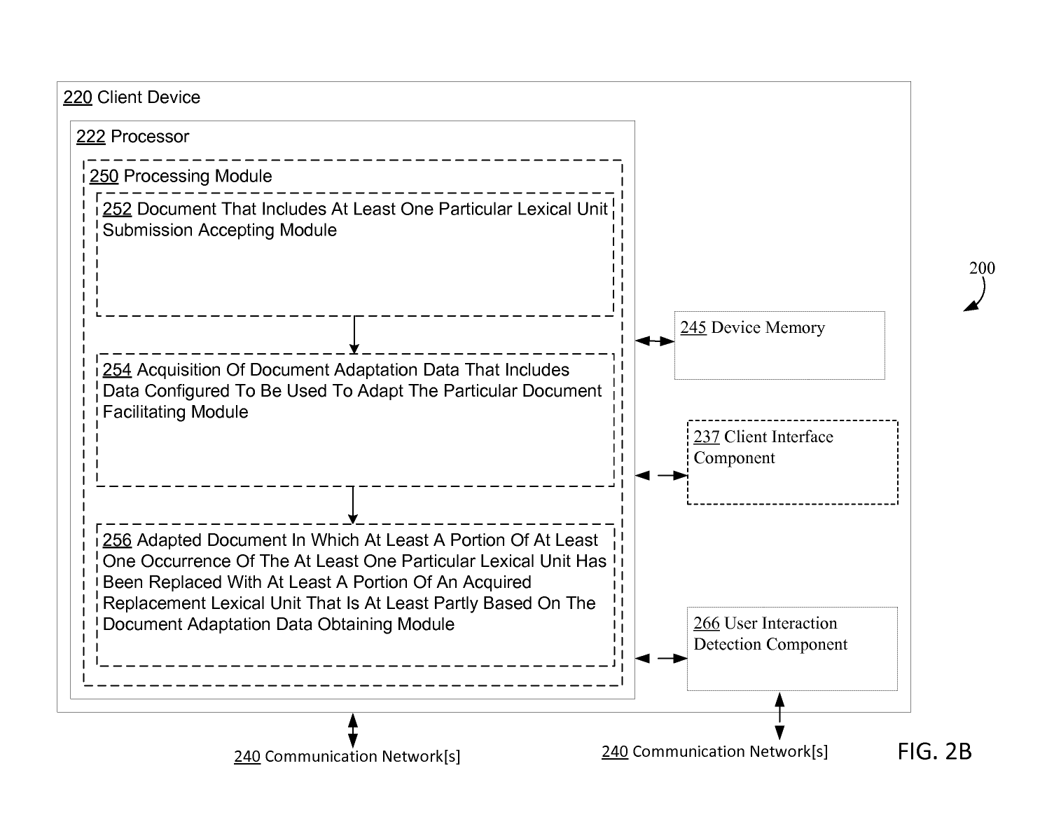

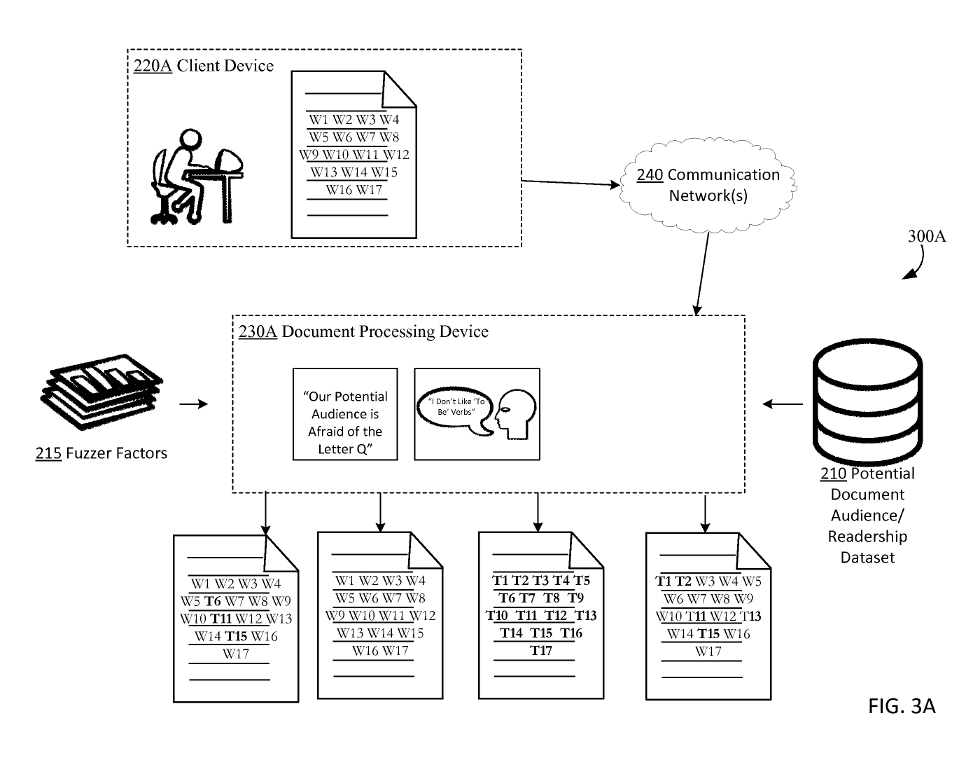

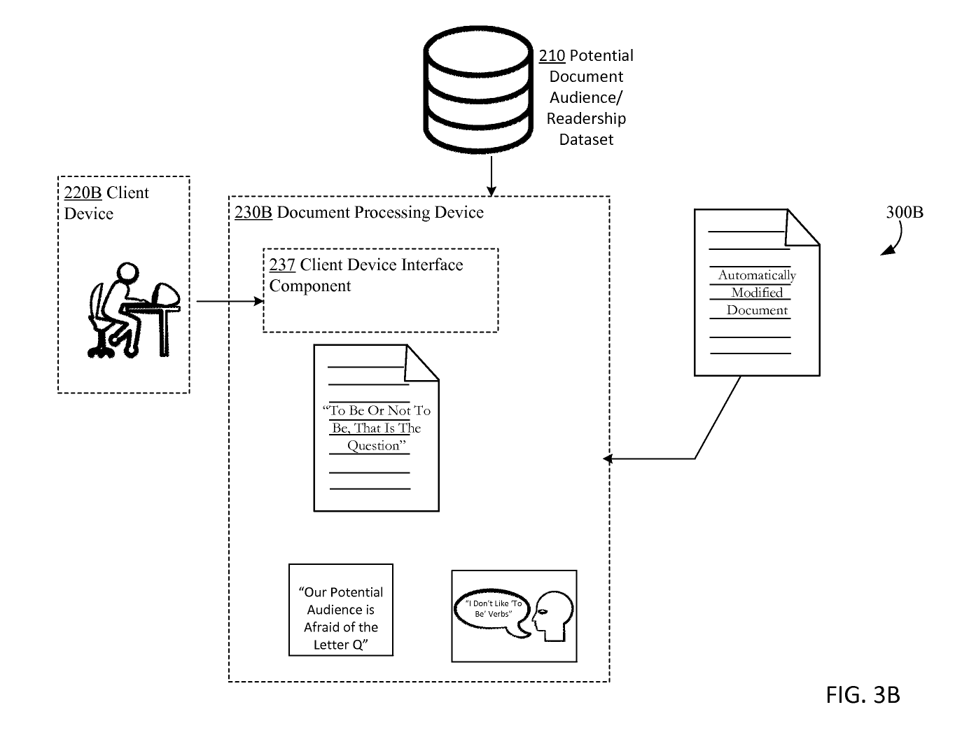

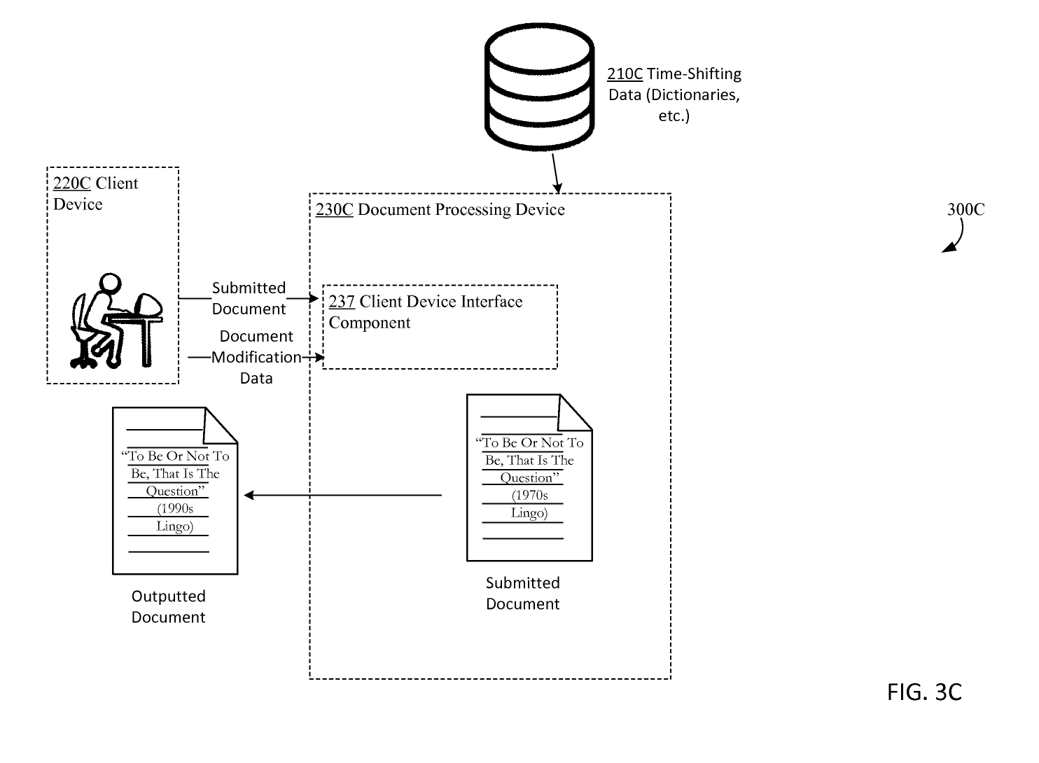

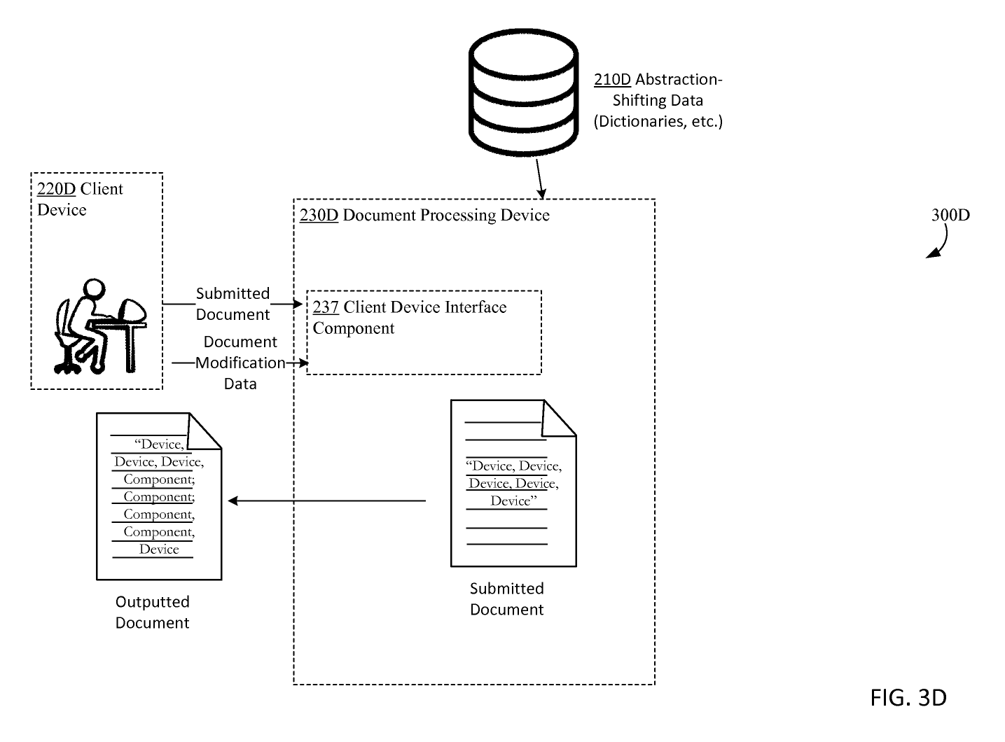

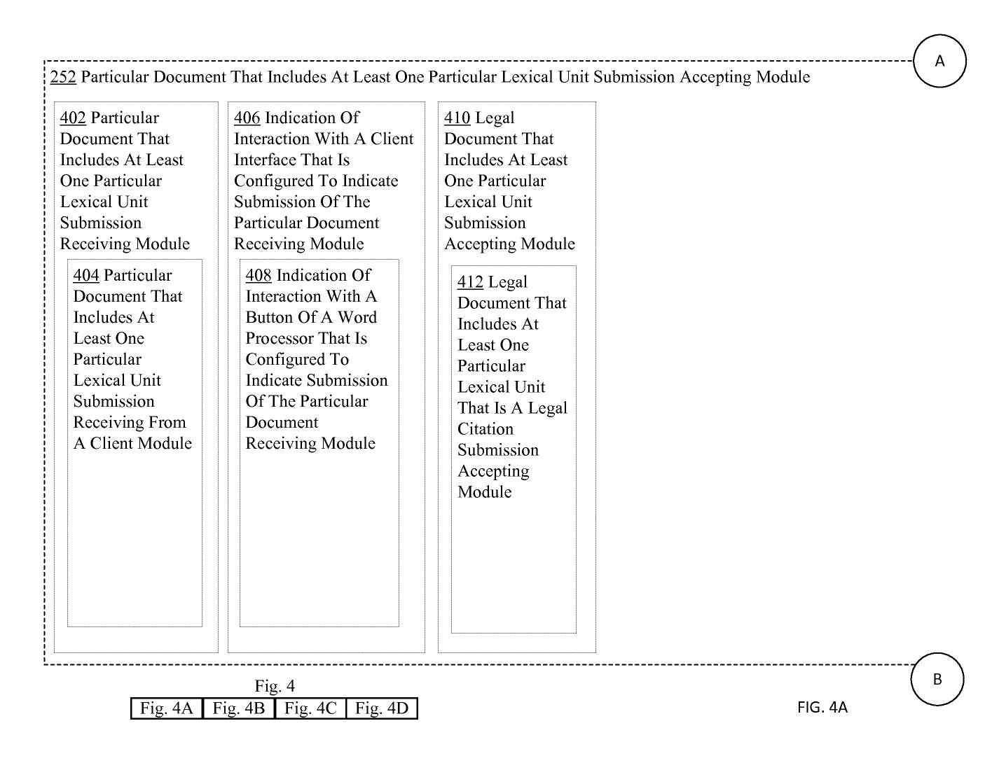

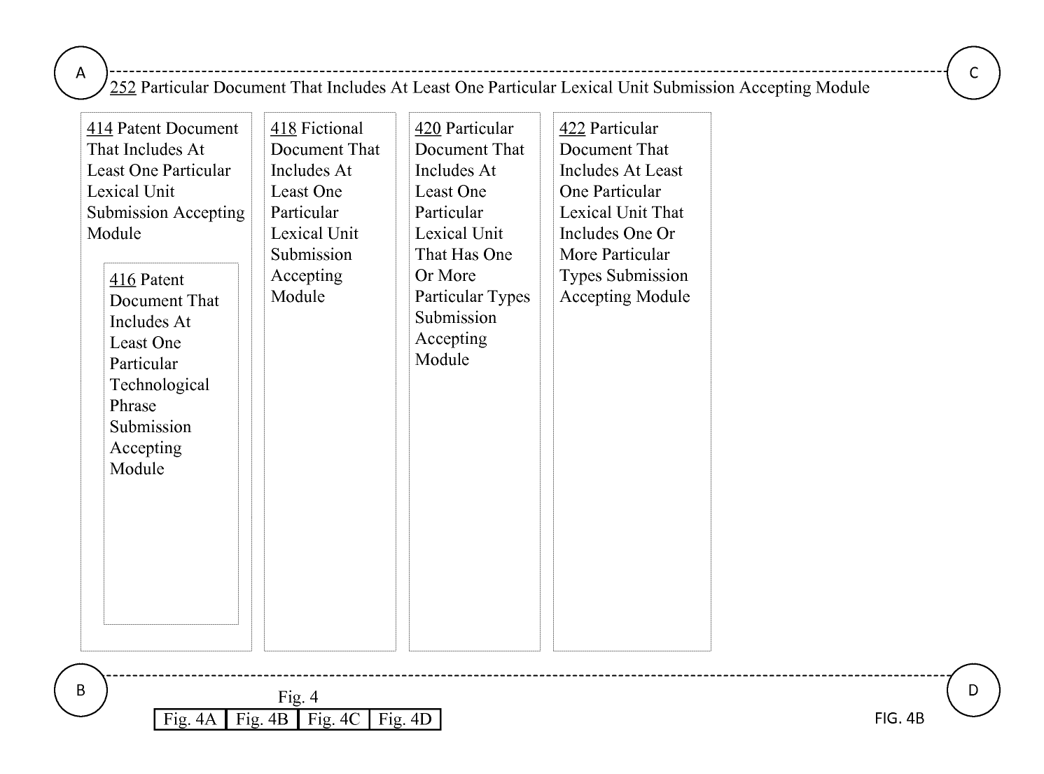

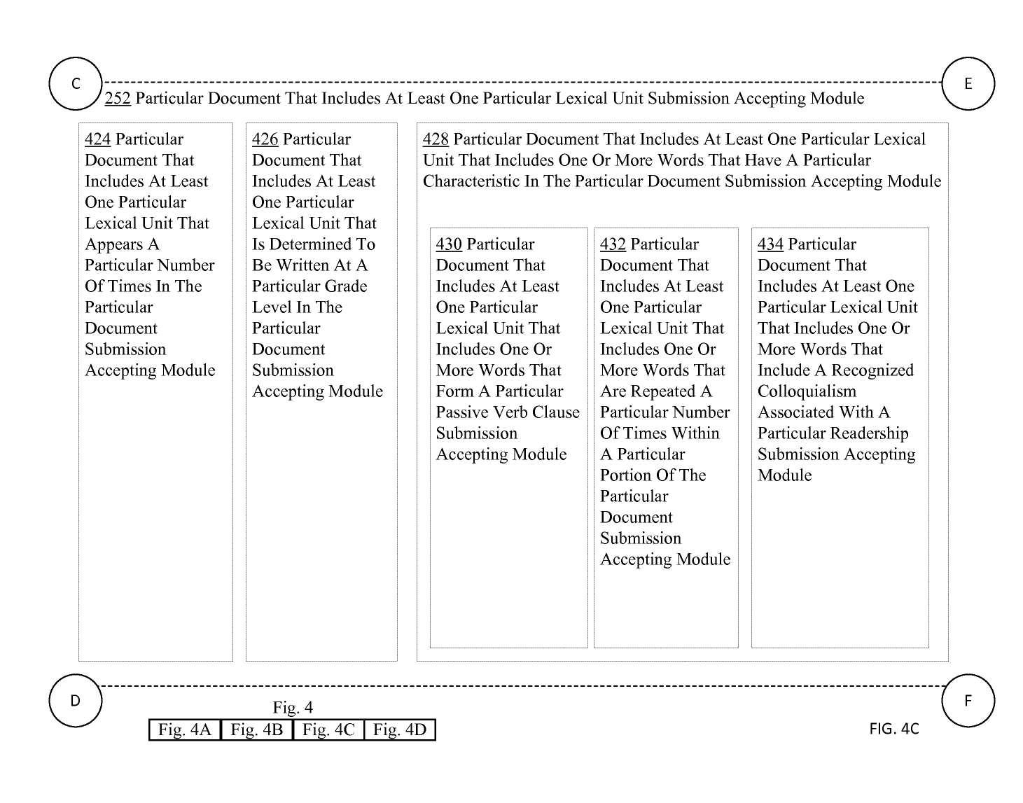

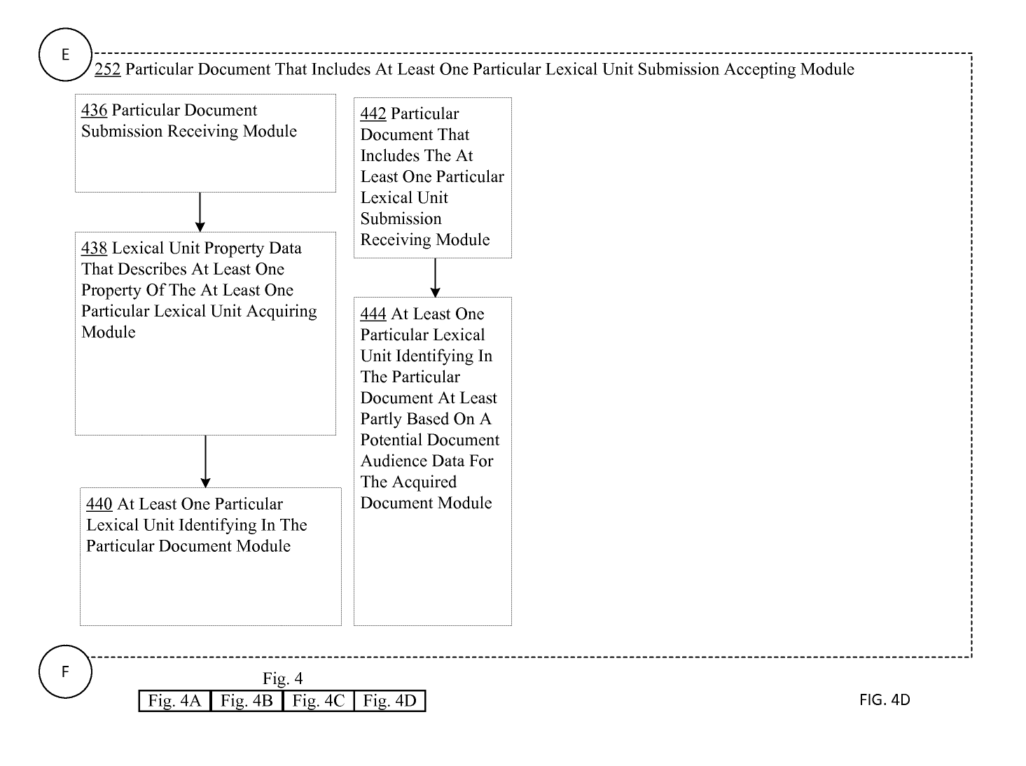

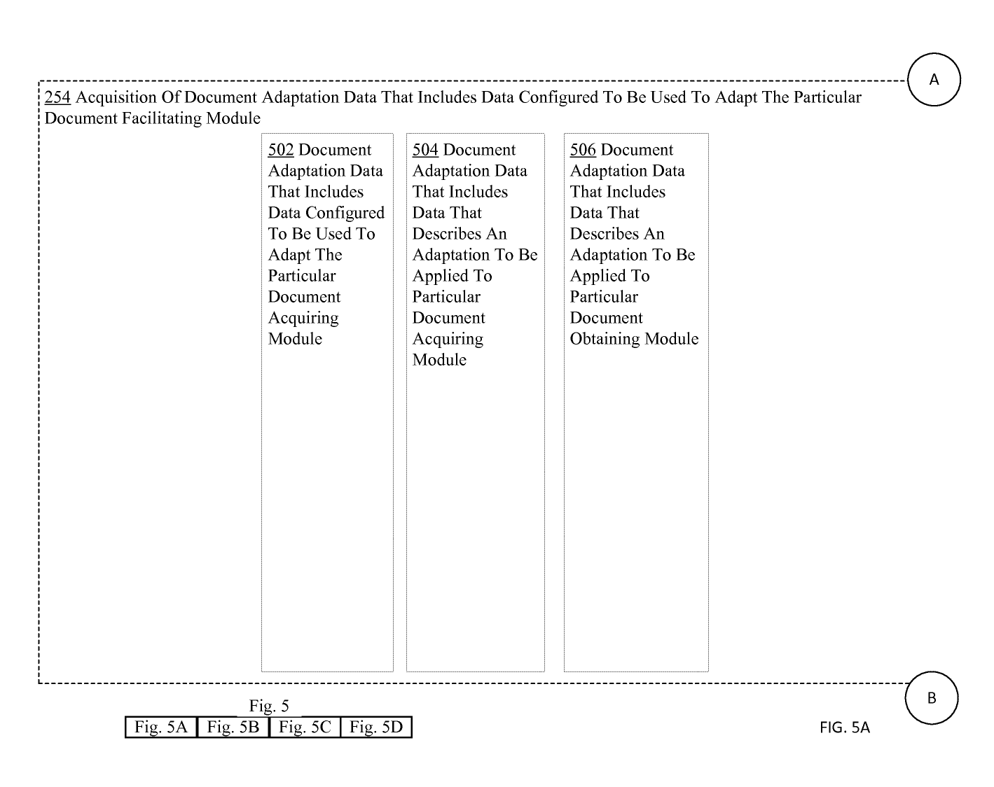

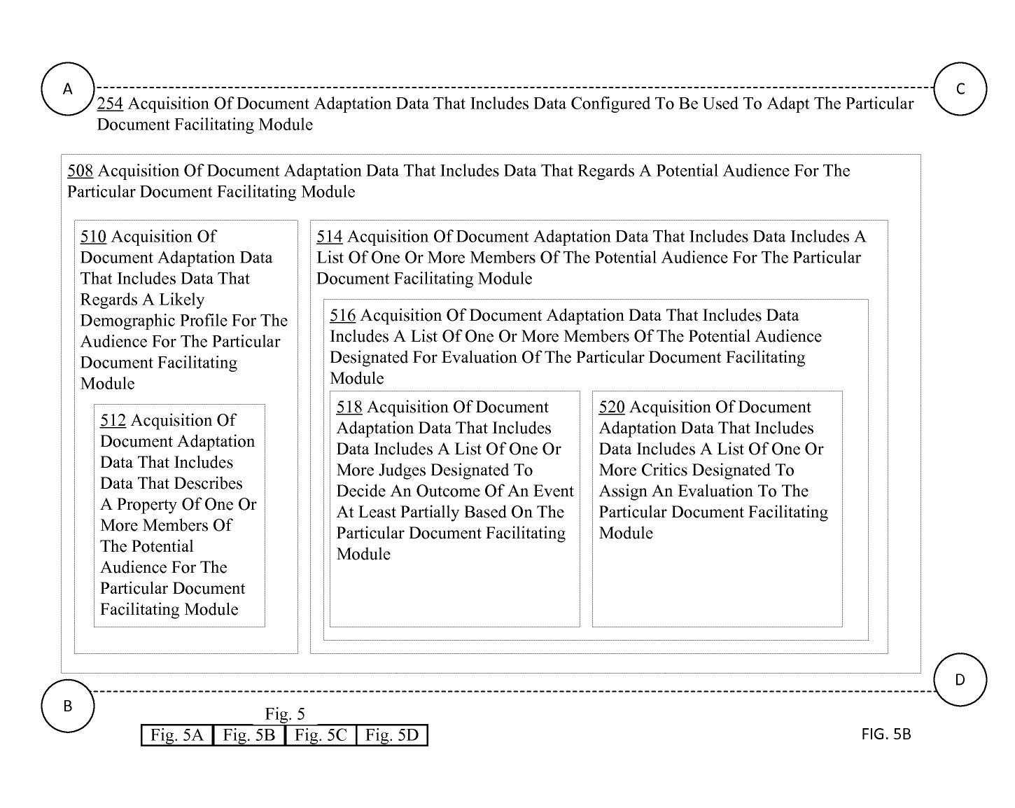

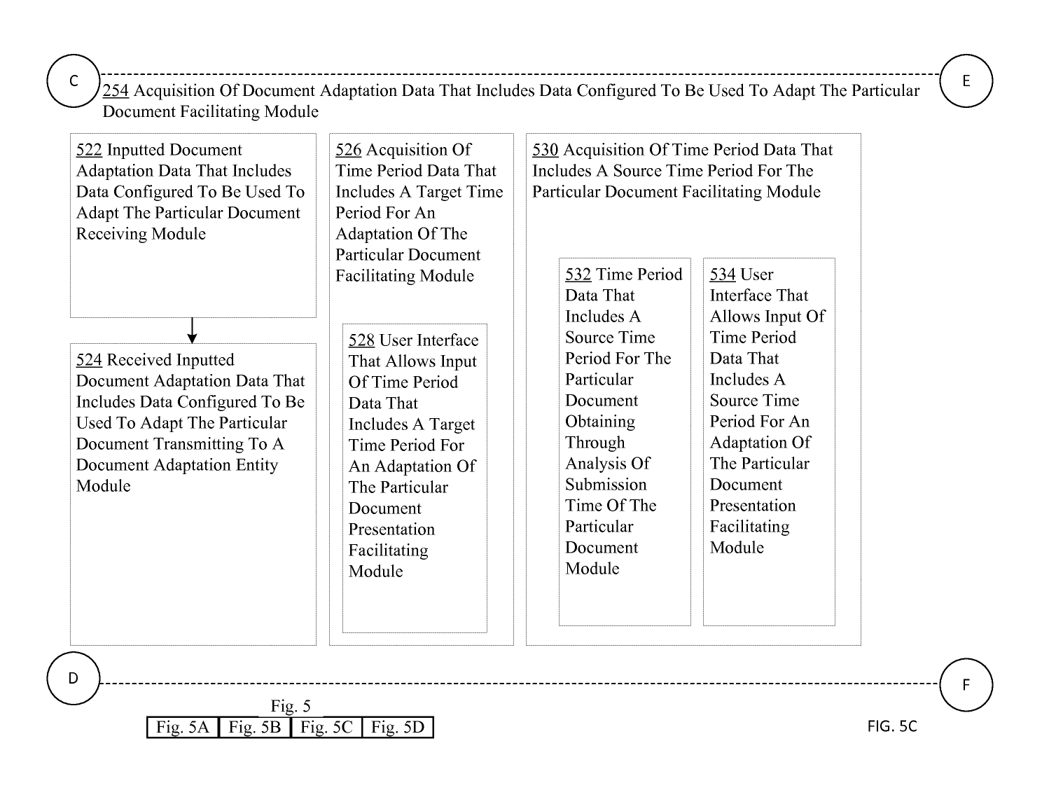

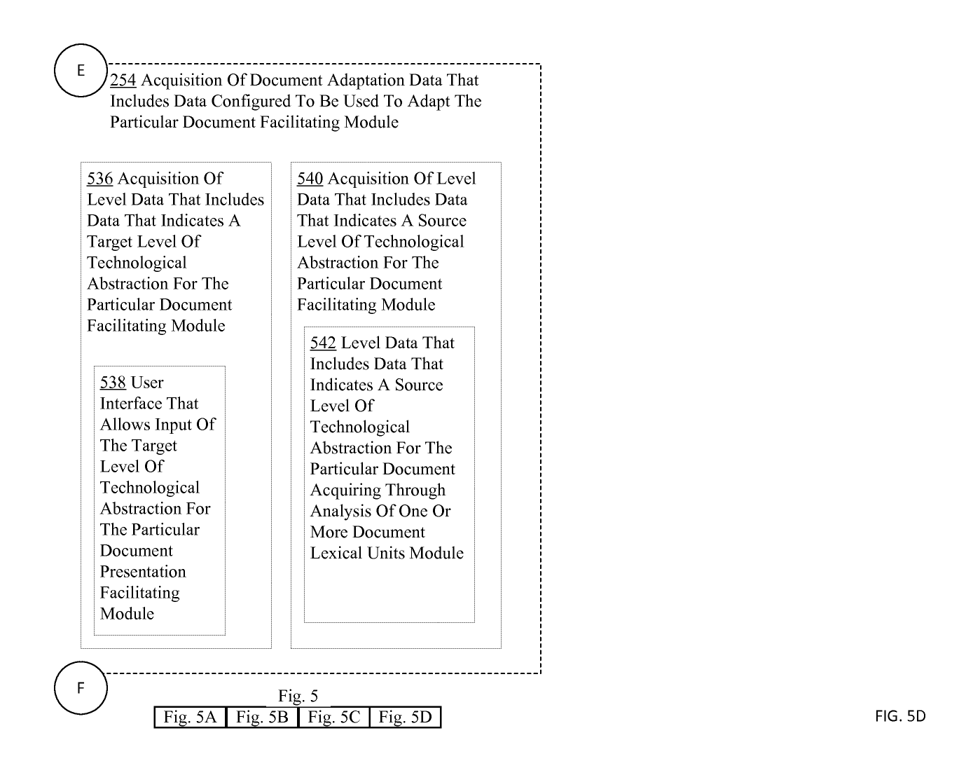

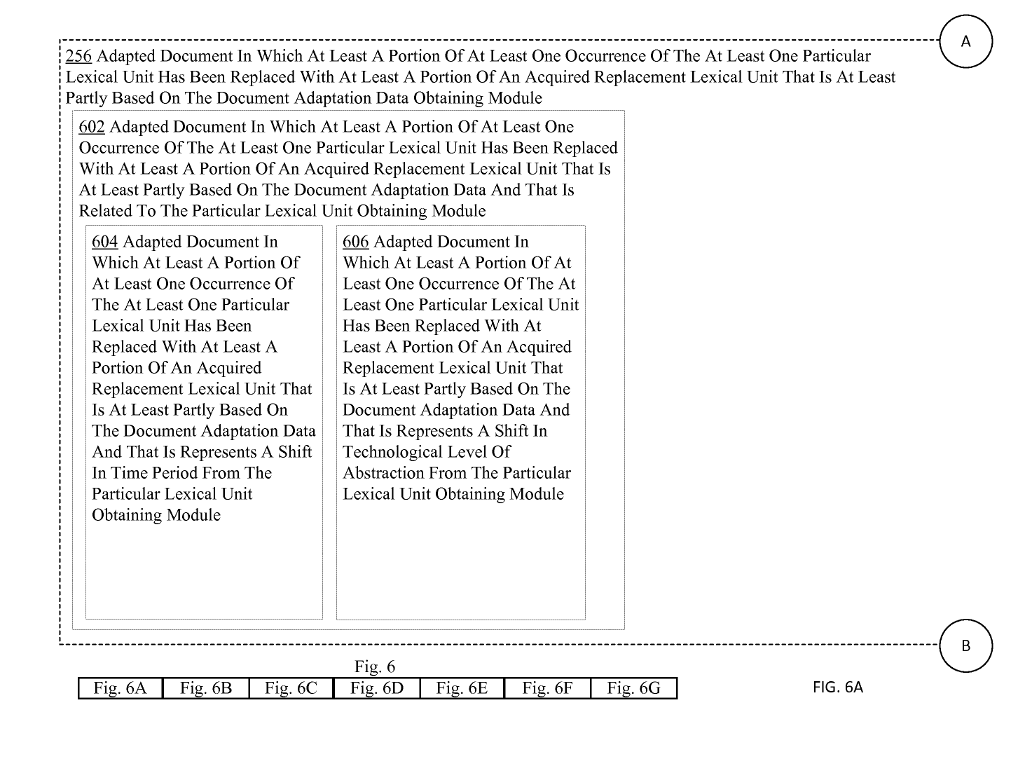

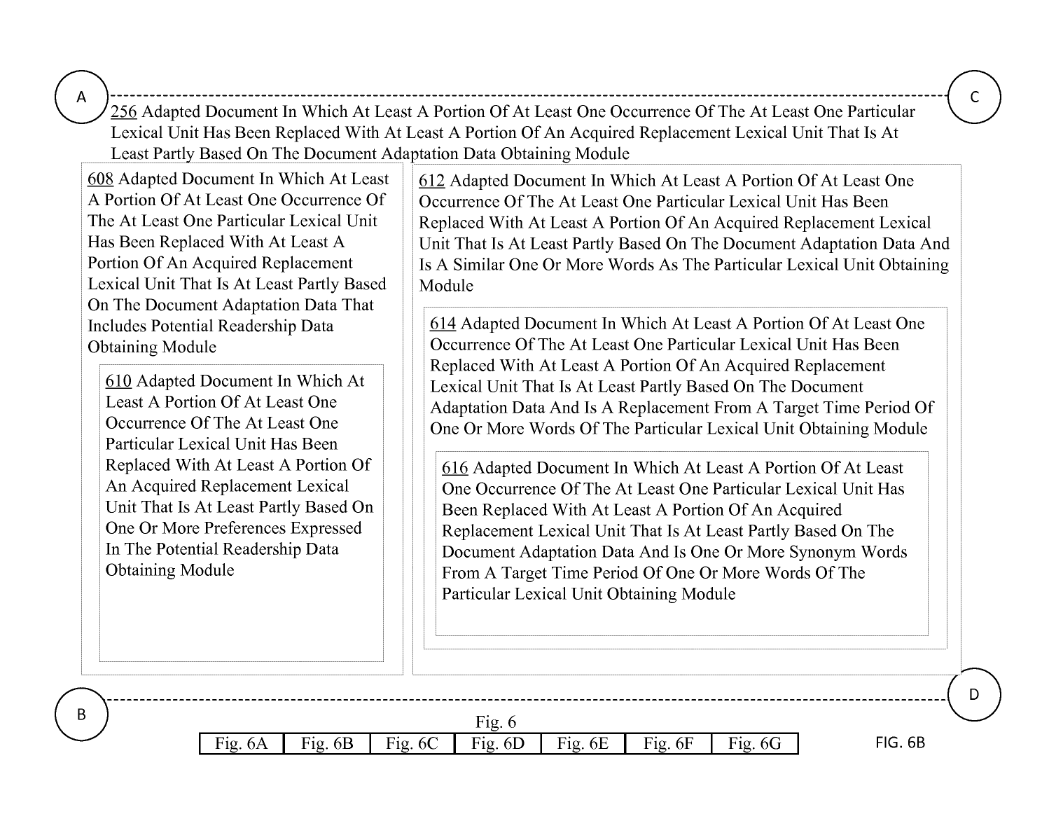

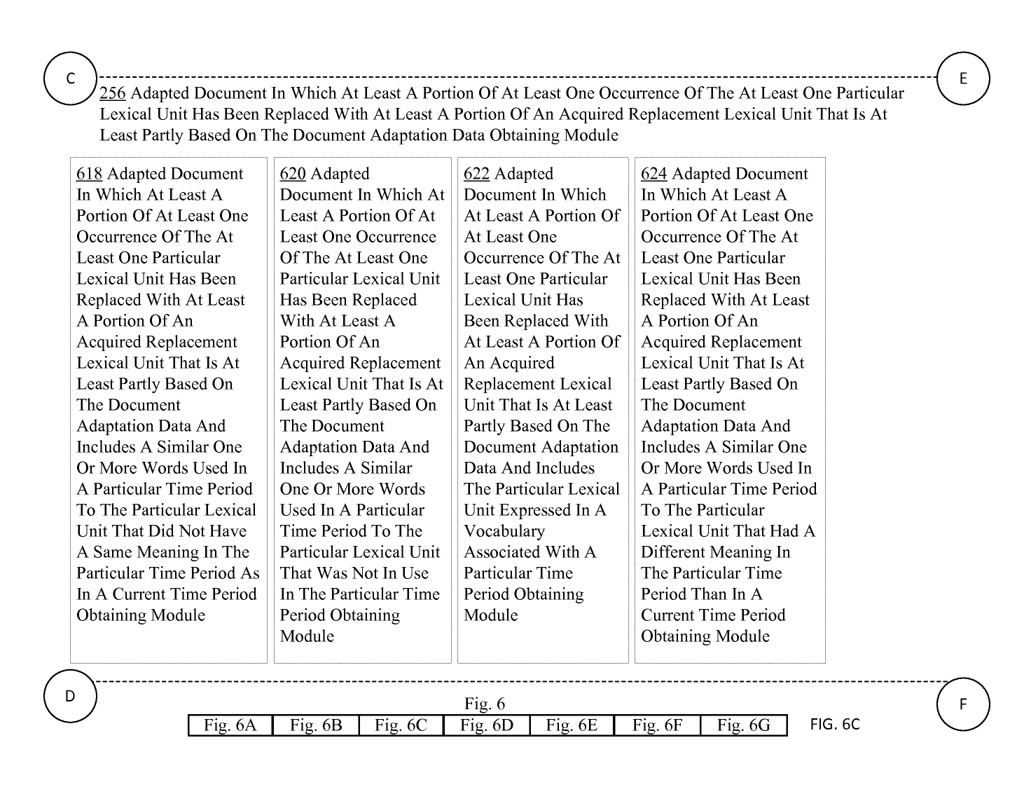

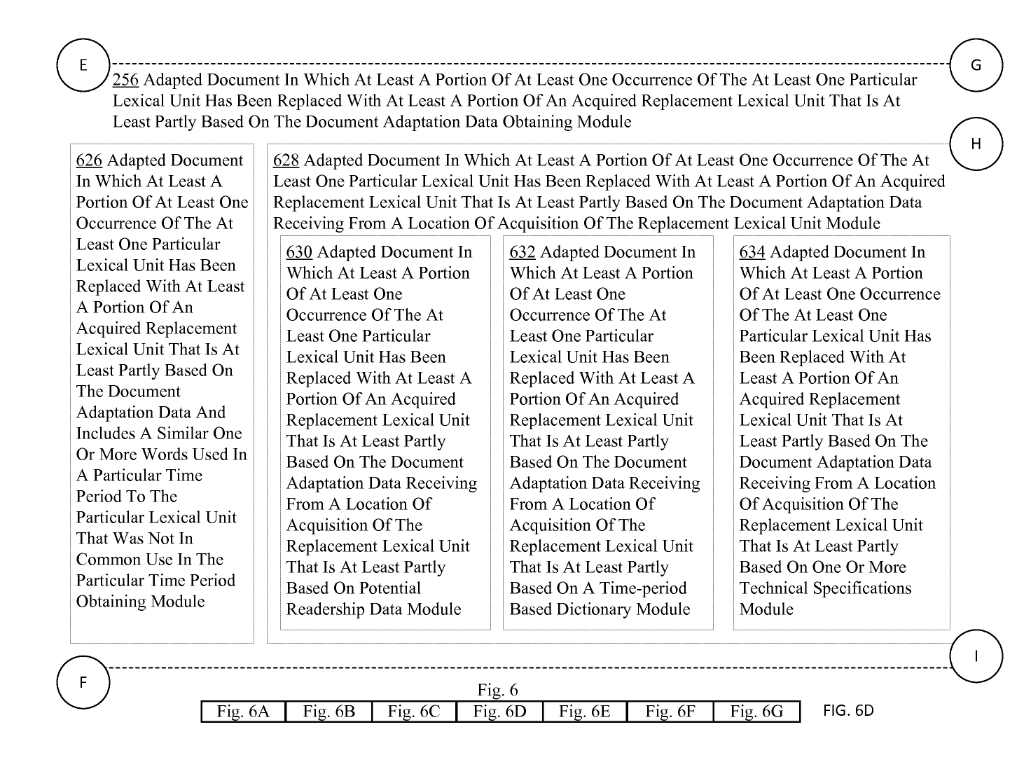

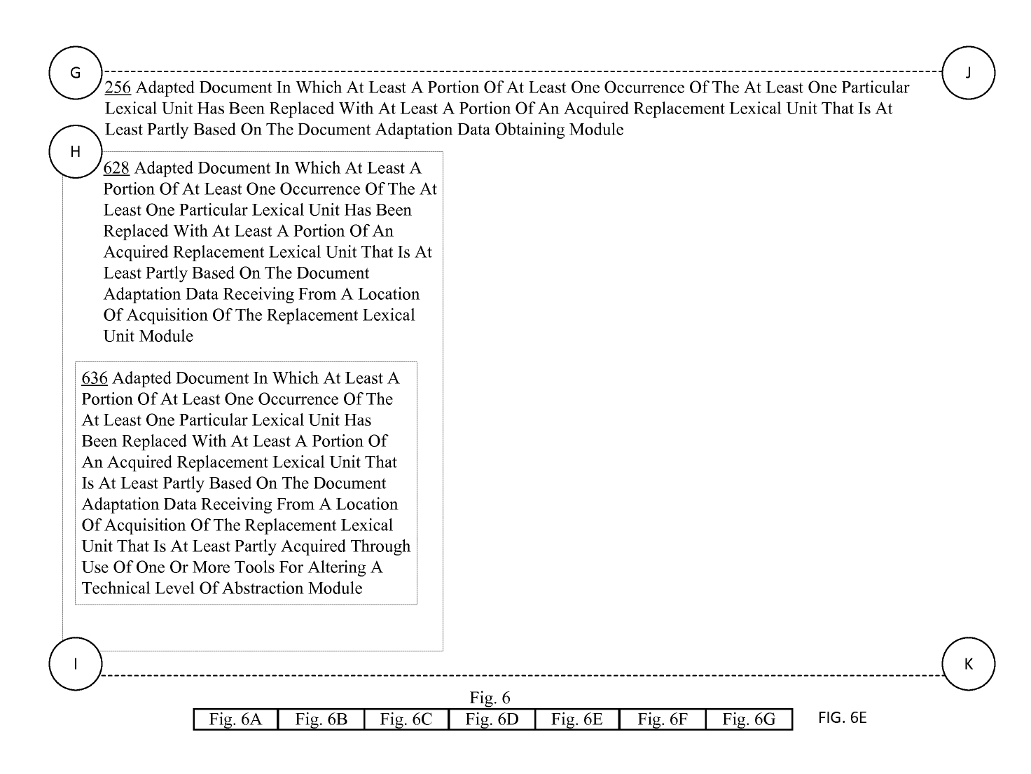

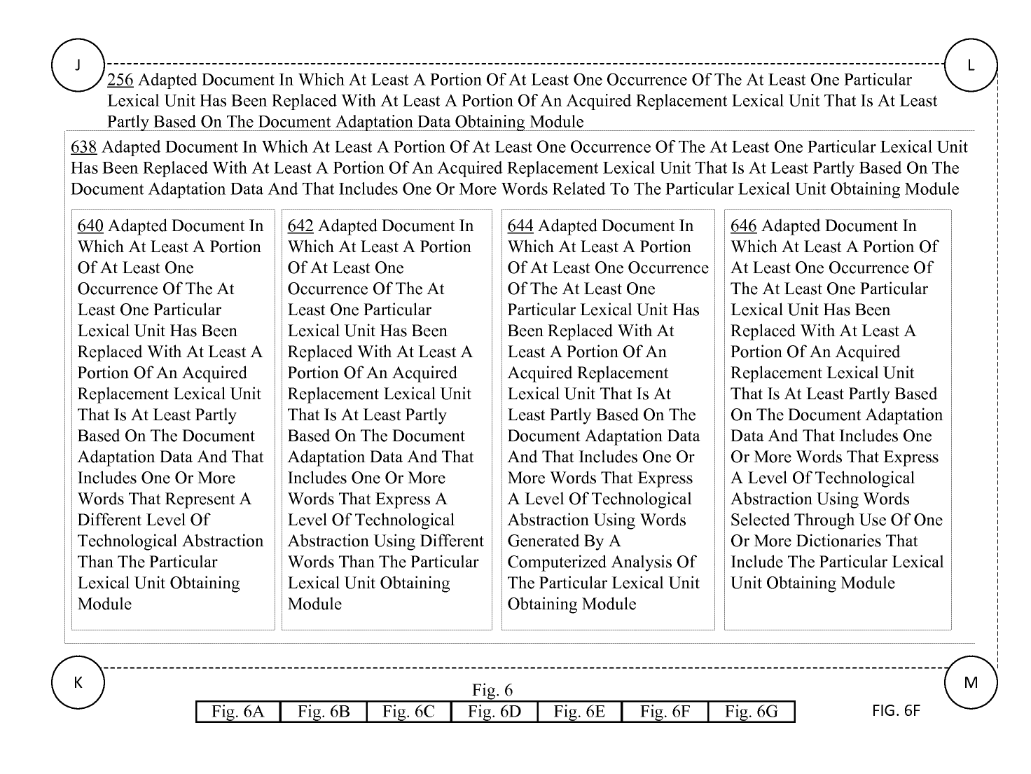

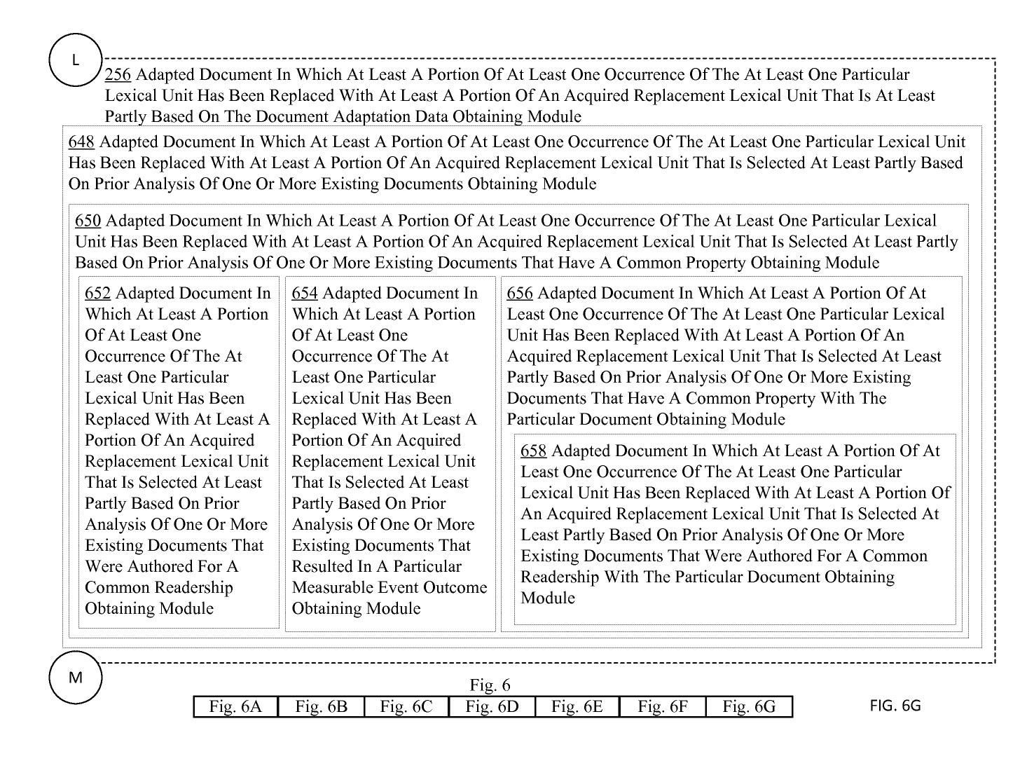

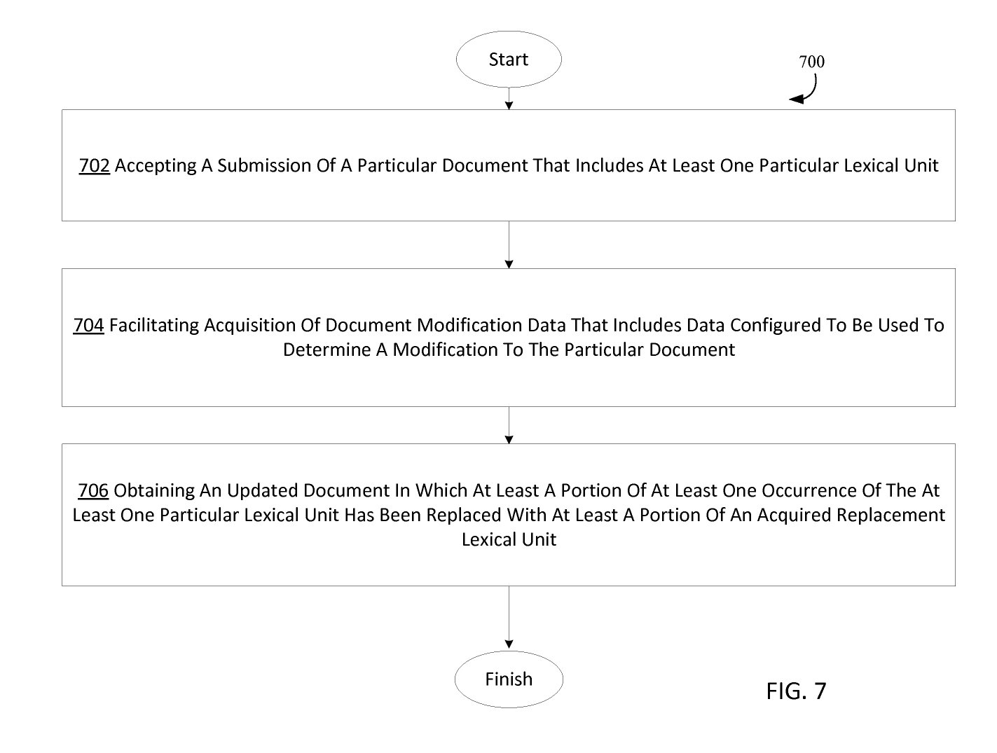

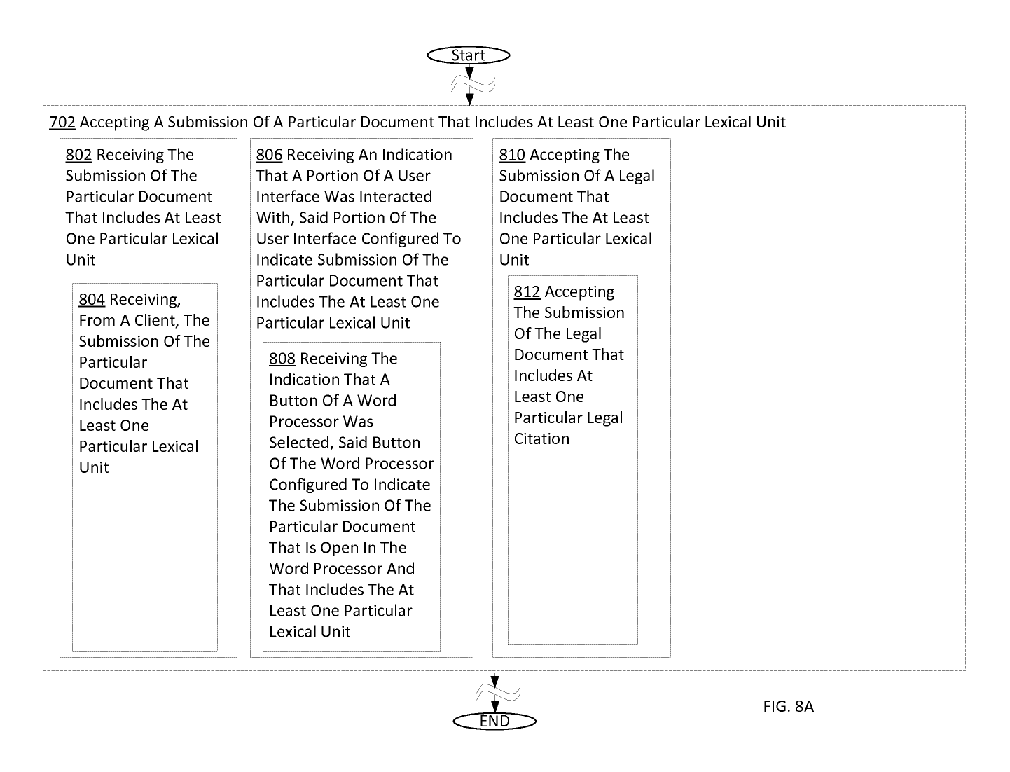

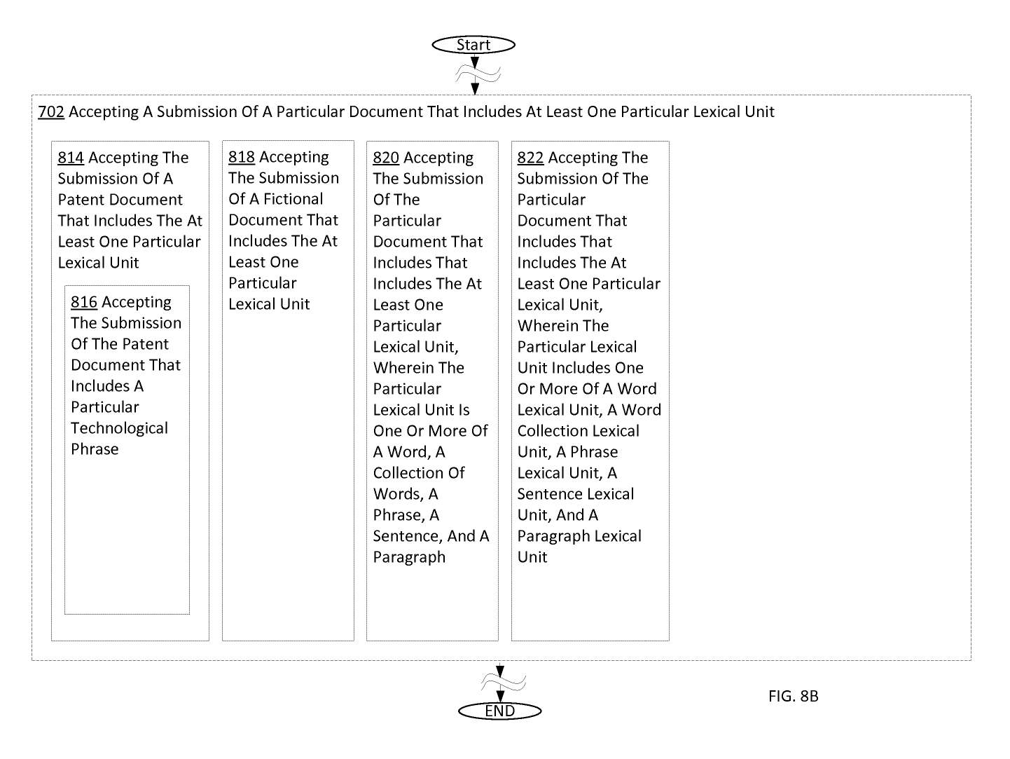

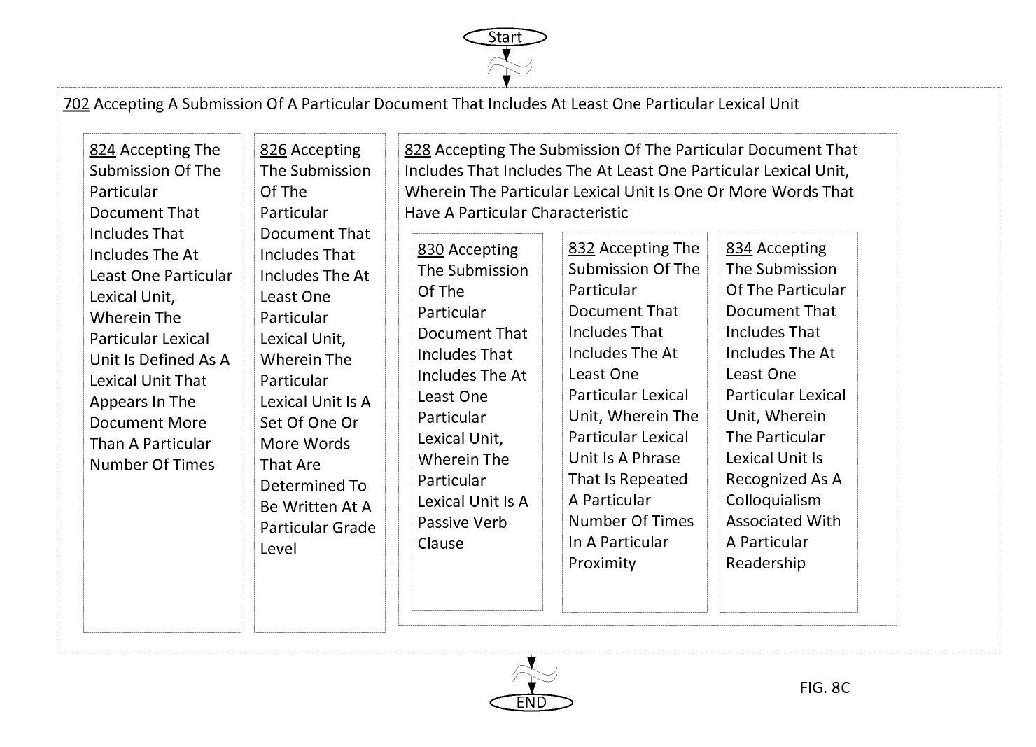

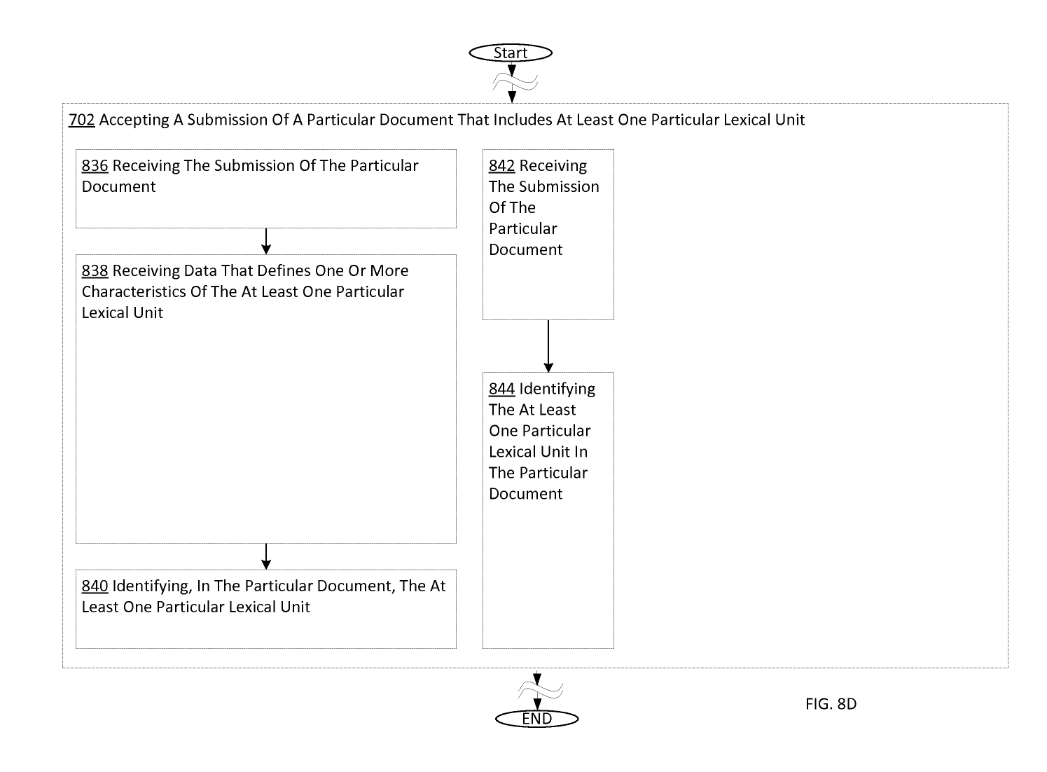

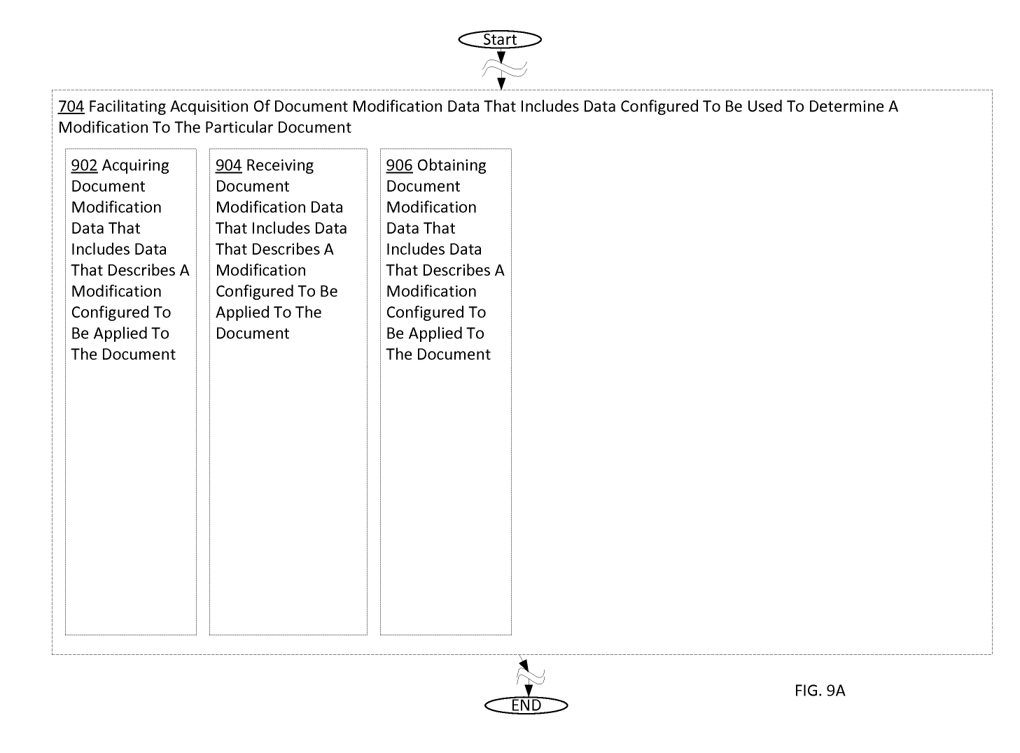

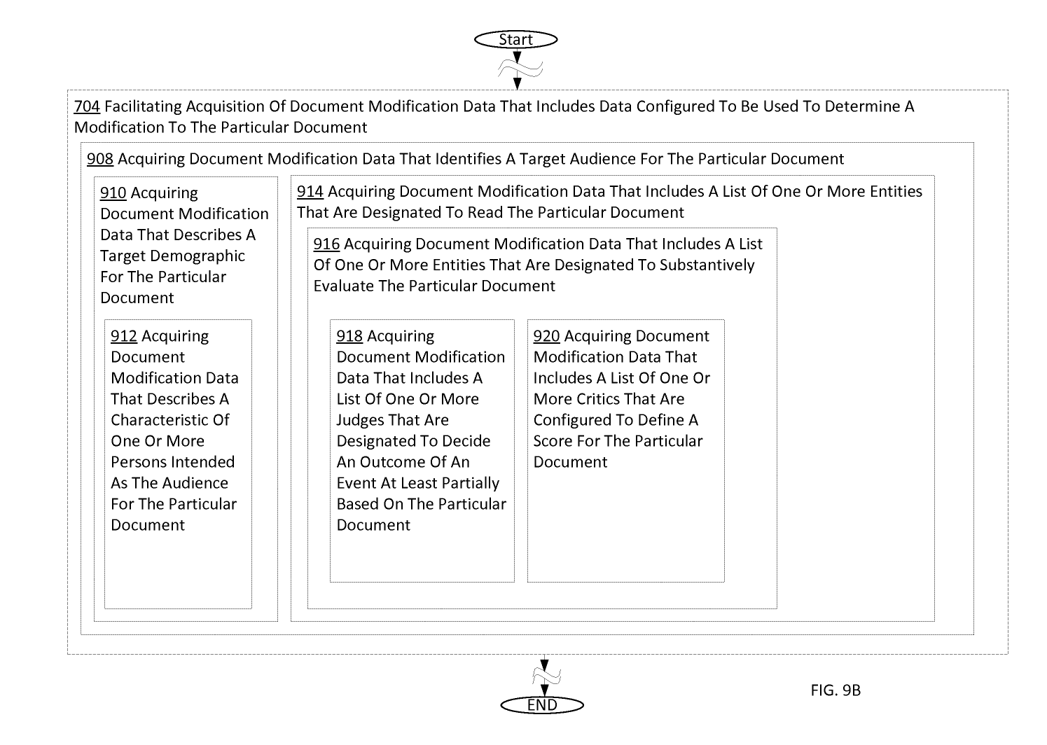

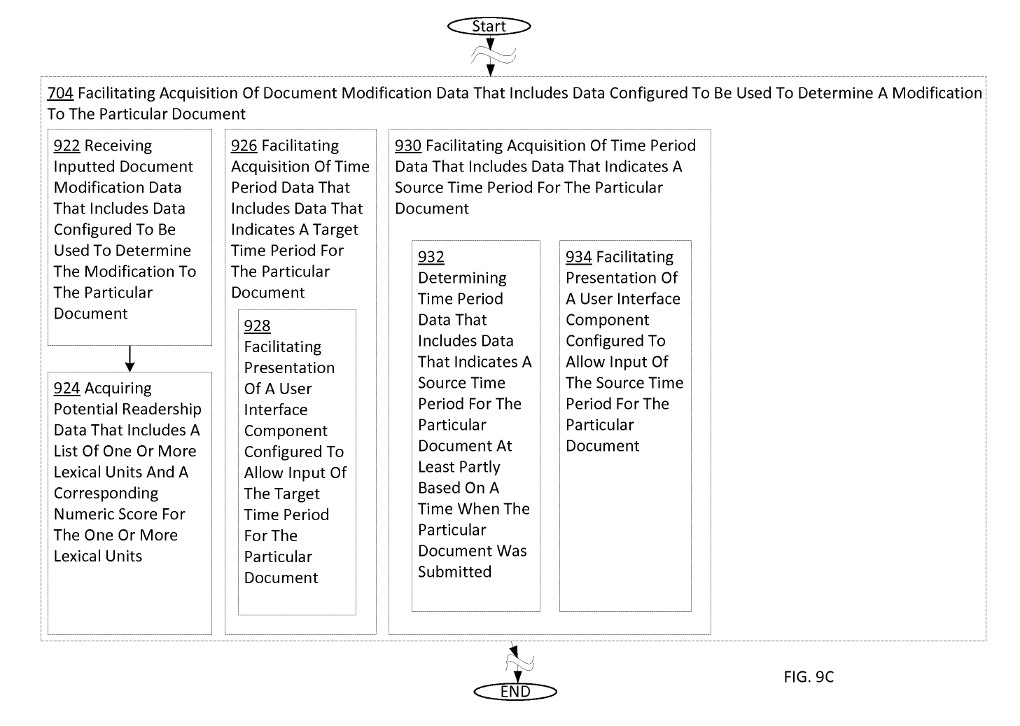

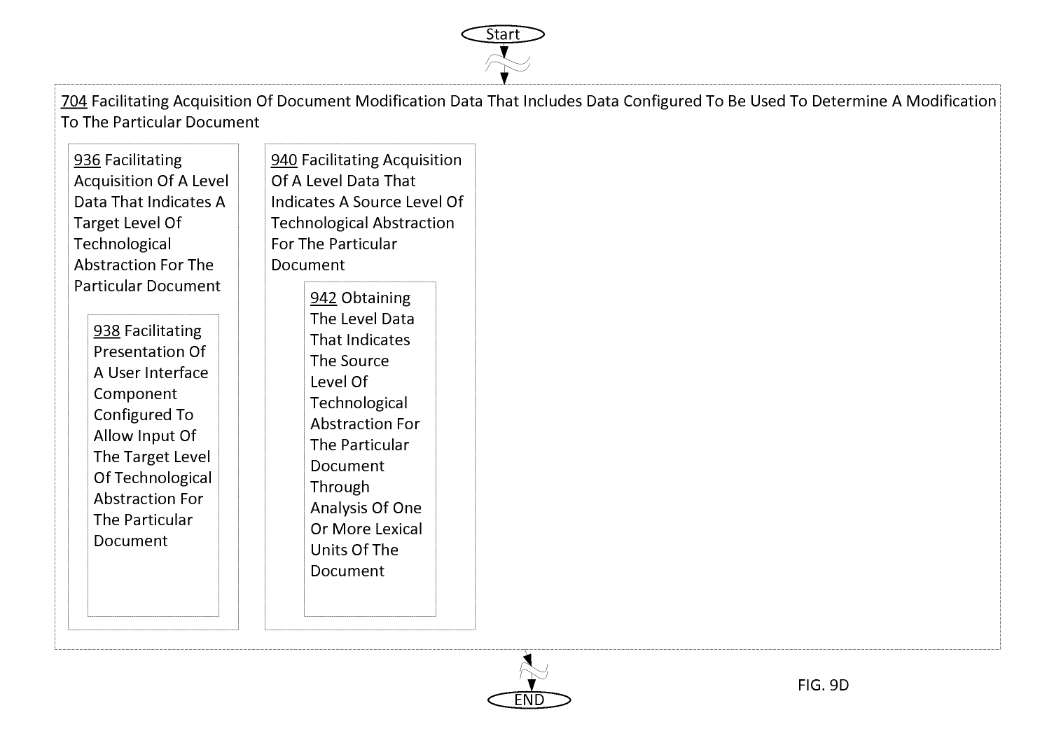

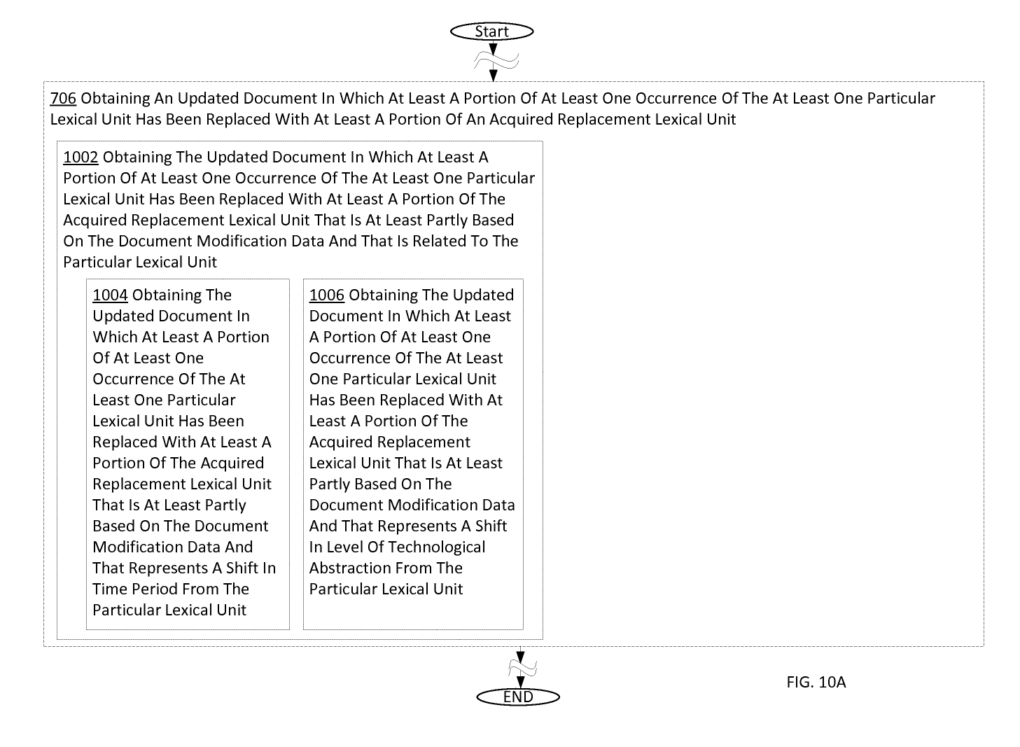

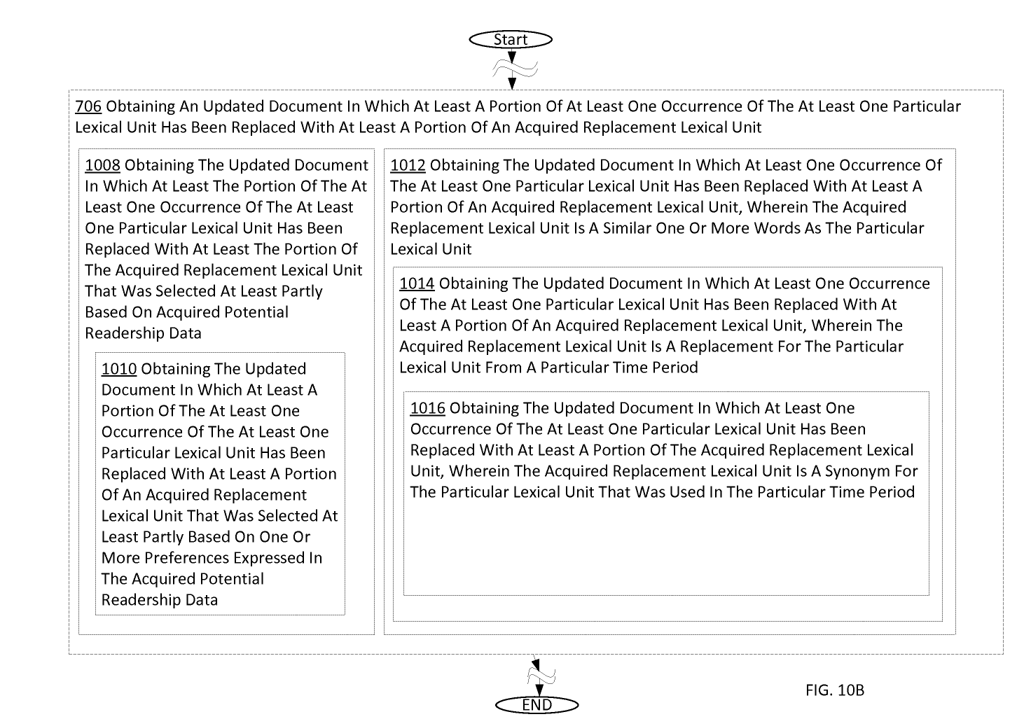

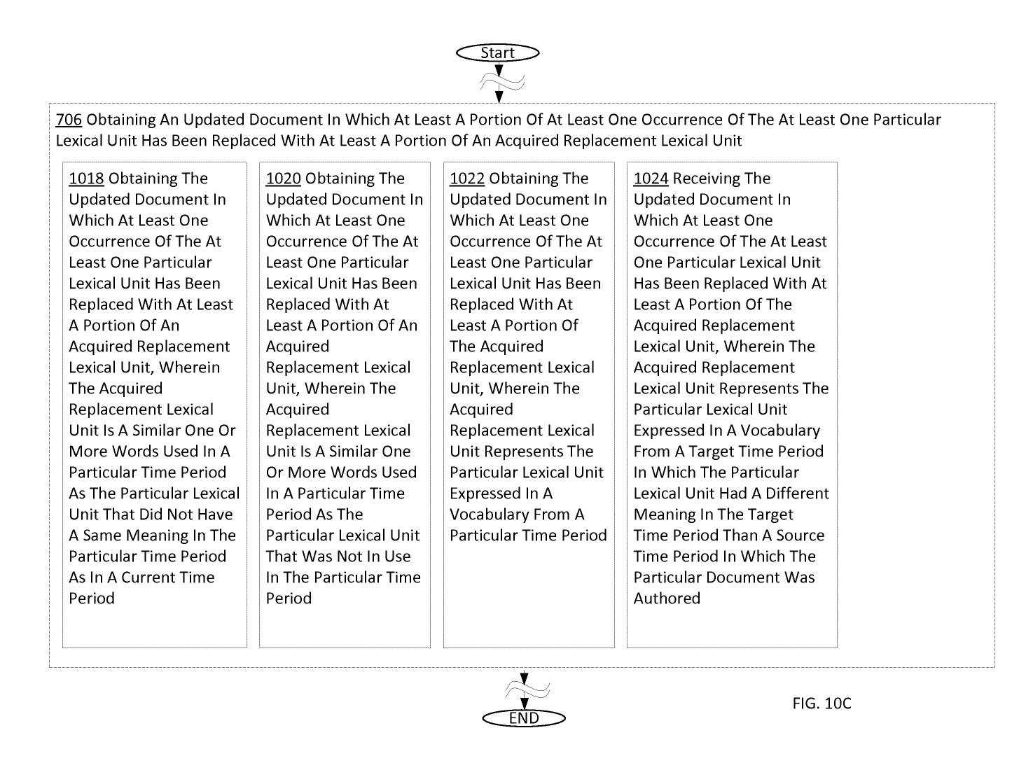

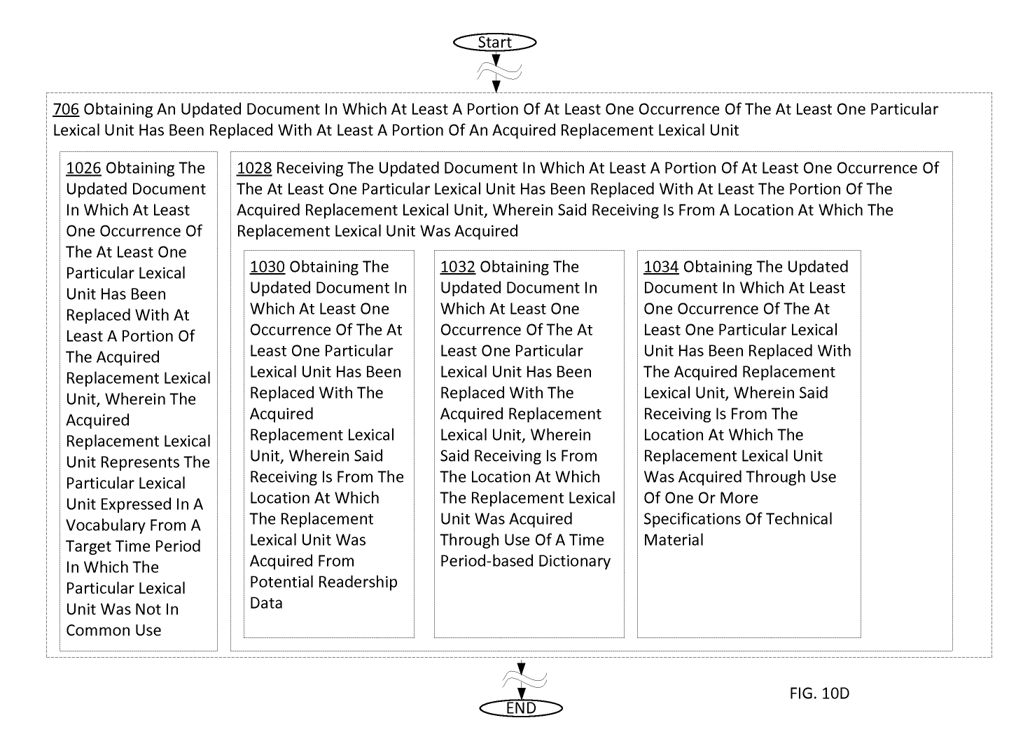

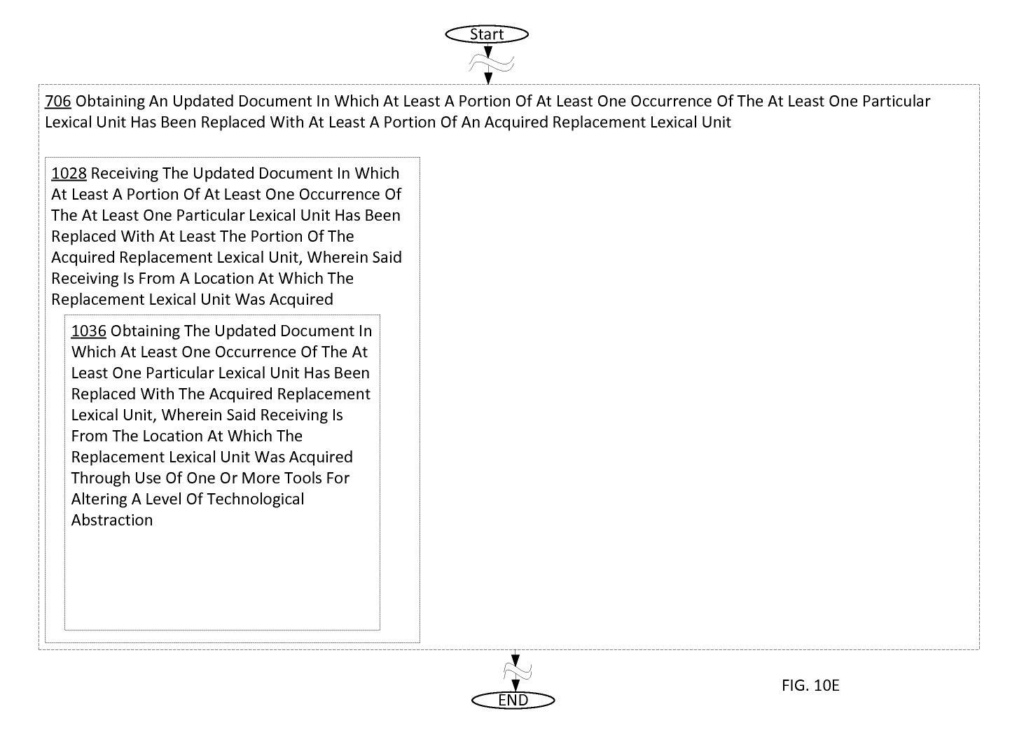

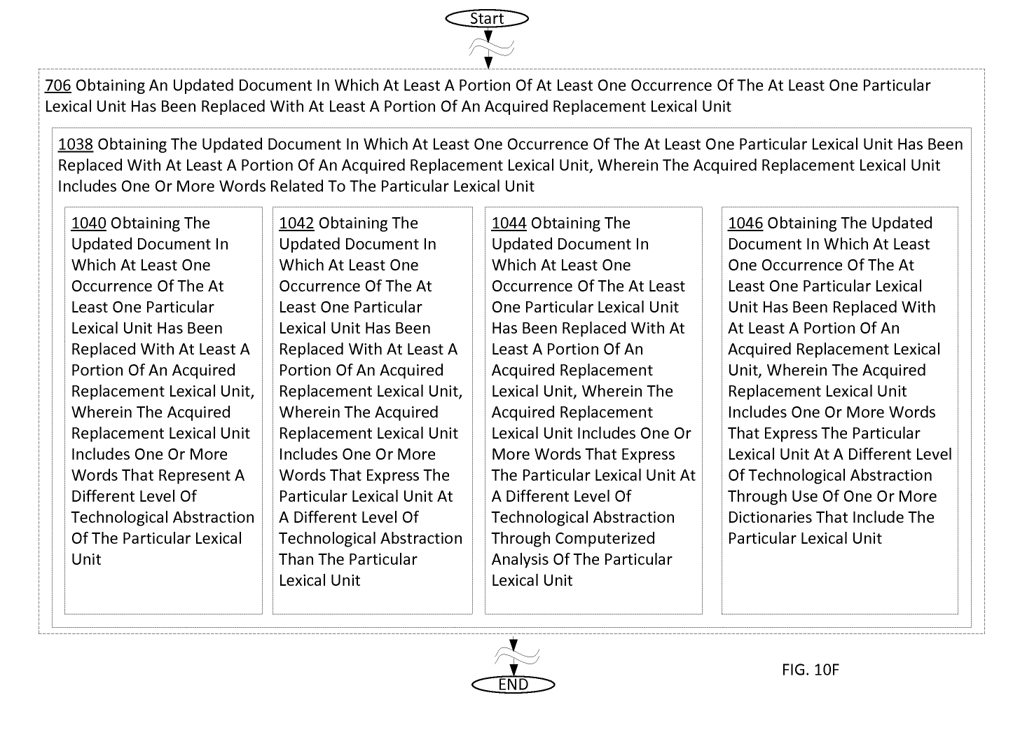

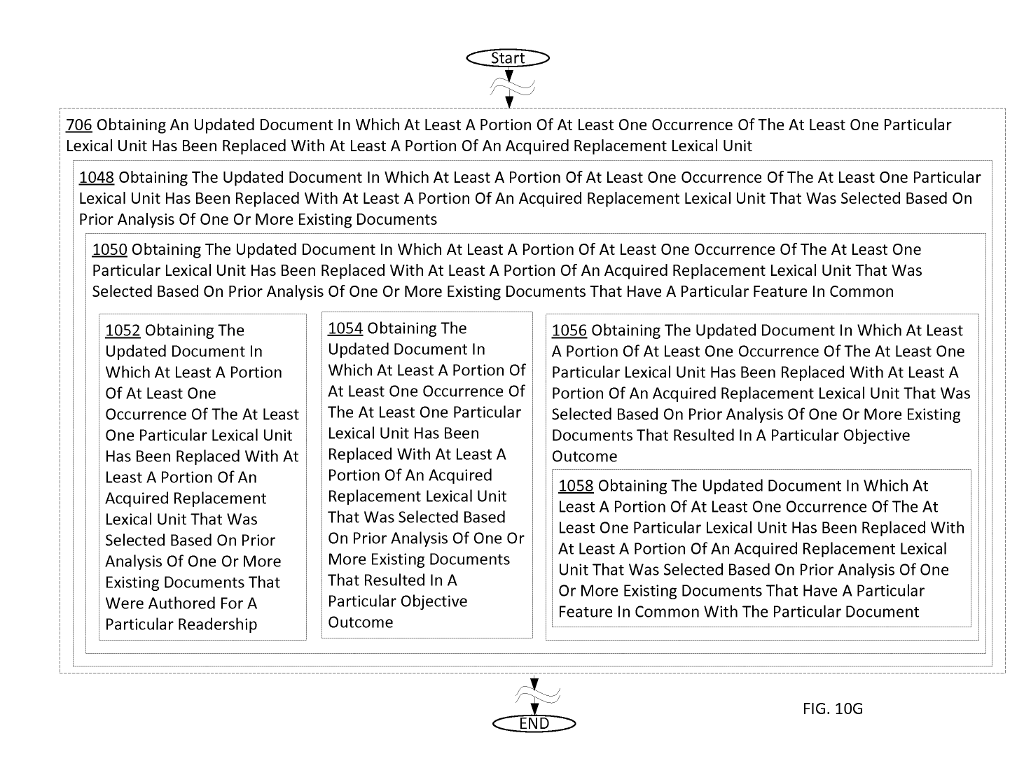

In accordance with 37 C.F.R. §1.84(h)(2), FIG. 1 shows “a view of a large machine or device in its entirety . . . broken into partial views . . . extended over several sheets” labeled FIG. 1A through FIG. 1AD (Sheets 1-30). The “views on two or more sheets form, in effect, a single complete view, [and] the views on the several sheets . . . [are] so arranged that the complete figure can be assembled” from “partial views drawn on separate sheets . . . linked edge to edge. Thus, in FIG. 1, the partial view FIGS. 1A through 1AD are ordered alphabetically, by increasing in columns from left to right, and increasing in rows top to bottom, as shown in the following table:

TABLE 1
Table showing alignment of enclosed drawings to form partial schematic of one
or more environments.

| Pos. (0,0) | X-Position 1 | X-Position 2 | X-Position 3 | X-Position 4 | X-Position 5 |
|---|---|---|---|---|---|
| Y-Pos. 1 | (1,1): FIG. 1A | (1,2): FIG. 1B | (1,3): FIG. 1C | (1,4): FIG. 1D | (1,5): FIG. 1E |
| Y-Pos. 2 | (2,1): FIG. 1F | (2,2): FIG. 1G | (2,3): FIG. 1H | (2,4): FIG. 1I | (2,5): FIG. 1J |
| Y-Pos. 3 | (3,1): FIG. 1K | (3,2): FIG. 1L | (3,3): FIG. 1M | (3,4): FIG. 1N | (3,5): FIG. 1-O |
| Y-Pos. 4 | (4,1): FIG. 1P | (4,2): FIG. 1Q | (4,3): FIG. 1R | (4,4): FIG. 1S | (4,5): FIG. 1T |
| Y-Pos. 5 | (5,1): FIG. 1U | (5,2): FIG. 1V | (5,3): FIG. 1W | (5,4): FIG. 1X | (5,5): FIG. 1Y |
| Y-Pos. 6 | (6,1): FIG. 1Z | (6,2): FIG. 1AA | (6,3): FIG. 1AB | (6,4): FIG. 1AC | (6,5): FIG. 1AD |

In accordance with 37 C.F.R. §1.84(h)(2), FIG. 1 is “ . . . a view of a large machine or device in its entirety . . . broken into partial views . . . extended over several sheets . . . [with] no loss in facility of understanding the view.” The partial views drawn on the several sheets indicated in the above table are capable of being linked edge to edge, so that no partial view contains parts of another partial view. As here, “where views on two or more sheets form, in effect, a single complete view, the views on the several sheets are so arranged that the complete figure can be assembled without concealing any part of any of the views appearing on the various sheets.” 37 C.F.R. §1.84(h)(2).

It is noted that one or more of the partial views of the drawings may be blank, or may be absent of substantive elements (e.g., may show only lines, connectors, arrows, and/or the like). These drawings are included in order to assist readers of the application in assembling the single complete view from the partial sheet format required for submission by the USPTO, and, while their inclusion is not required and may be omitted in this or other applications without subtracting from the disclosed matter as a whole, their inclusion is proper, and should be considered and treated as intentional.

FIG. 1A, when placed at position (1,1), forms at least a portion of a partially schematic diagram of an environment(s) and/or an implementation(s) of technologies described herein.

FIG. 1B, when placed at position (1,2), forms at least a portion of a partially schematic diagram of an environment(s) and/or an implementation(s) of technologies described herein.

FIG. 1C, when placed at position (1,3), forms at least a portion of a partially schematic diagram of an environment(s) and/or an implementation(s) of technologies described herein.

FIG. 1D, when placed at position (1,4), forms at least a portion of a partially schematic diagram of an environment(s) and/or an implementation(s) of technologies described herein.

FIG. 1E, when placed at position (1,5), forms at least a portion of a partially schematic diagram of an environment(s) and/or an implementation(s) of technologies described herein.

FIG. 1F, when placed at position (2,1), forms at least a portion of a partially schematic diagram of an environment(s) and/or an implementation(s) of technologies described herein.

FIG. 1G, when placed at position (2,2), forms at least a portion of a partially schematic diagram of an environment(s) and/or an implementation(s) of technologies described herein.

FIG. 1H, when placed at position (2,3), forms at least a portion of a partially schematic diagram of an environment(s) and/or an implementation(s) of technologies described herein.

FIG. 1I, when placed at position (2,4), forms at least a portion of a partially schematic diagram of an environment(s) and/or an implementation(s) of technologies described herein.

FIG. 1J, when placed at position (2,5), forms at least a portion of a partially schematic diagram of an environment(s) and/or an implementation(s) of technologies described herein.

FIG. 1K, when placed at position (3,1), forms at least a portion of a partially schematic diagram of an environment(s) and/or an implementation(s) of technologies described herein.

FIG. 1L, when placed at position (3,2), forms at least a portion of a partially schematic diagram of an environment(s) and/or an implementation(s) of technologies described herein.

FIG. 1M, when placed at position (3,3), forms at least a portion of a partially schematic diagram of an environment(s) and/or an implementation(s) of technologies described herein.

FIG. 1N, when placed at position (3,4), forms at least a portion of a partially schematic diagram of an environment(s) and/or an implementation(s) of technologies described herein.

FIG. 1-O (which format is changed to avoid confusion as FIG. “10” or “ten”), when placed at position (3,5), forms at least a portion of a partially schematic diagram of an environment(s) and/or an implementation(s) of technologies described herein.

FIG. 1P, when placed at position (4,1), forms at least a portion of a partially schematic diagram of an environment(s) and/or an implementation(s) of technologies described herein.

FIG. 1Q, when placed at position (4,2), forms at least a portion of a partially schematic diagram of an environment(s) and/or an implementation(s) of technologies described herein.

FIG. 1R, when placed at position (4,3), forms at least a portion of a partially schematic diagram of an environment(s) and/or an implementation(s) of technologies described herein.

FIG. 1S, when placed at position (4,4), forms at least a portion of a partially schematic diagram of an environment(s) and/or an implementation(s) of technologies described herein.

FIG. 1T, when placed at position (4,5), forms at least a portion of a partially schematic diagram of an environment(s) and/or an implementation(s) of technologies described herein.

FIG. 1U, when placed at position (5,1), forms at least a portion of a partially schematic diagram of an environment(s) and/or an implementation(s) of technologies described herein.

FIG. 1V, when placed at position (5,2), forms at least a portion of a partially schematic diagram of an environment(s) and/or an implementation(s) of technologies described herein.

FIG. 1W, when placed at position (5,3), forms at least a portion of a partially schematic diagram of an environment(s) and/or an implementation(s) of technologies described herein.

FIG. 1X, when placed at position (5,4), forms at least a portion of a partially schematic diagram of an environment(s) and/or an implementation(s) of technologies described herein.

FIG. 1Y, when placed at position (5,5), forms at least a portion of a partially schematic diagram of an environment(s) and/or an implementation(s) of technologies described herein.

FIG. 1Z, when placed at position (6,1), forms at least a portion of a partially schematic diagram of an environment(s) and/or an implementation(s) of technologies described herein.

FIG. 1AA, when placed at position (6,2), forms at least a portion of a partially schematic diagram of an environment(s) and/or an implementation(s) of technologies described herein.

FIG. 1AB, when placed at position (6,3), forms at least a portion of a partially schematic diagram of an environment(s) and/or an implementation(s) of technologies described herein.

FIG. 1AC, when placed at position (6,4), forms at least a portion of a partially schematic diagram of an environment(s) and/or an implementation(s) of technologies described herein.

FIG. 1AD, when placed at position (6,5), forms at least a portion of a partially schematic diagram of an environment(s) and/or an implementation(s) of technologies described herein.

FIG. 2A shows a high-level block diagram of an exemplary environment 200, including client device 220, according to one or more embodiments.

FIG. 2B shows a high-level block diagram of a computing device, e.g., a client device 220 operating in an exemplary environment 200, according to one or more embodiments.

FIG. 3A shows a high-level block diagram of an exemplary environment 300A, including client device 220A, according to one or more embodiments.

FIG. 3B shows a high-level block diagram of an exemplary environment 300B, including client device 220B, according to one or more embodiments.

FIG. 3C shows a high-level block diagram of an exemplary environment 300C, including client device 220C, according to one or more embodiments.

FIG. 3D shows a high-level block diagram of an exemplary environment 300D, including client device 220D, according to one or more embodiments.

FIG. 4, including FIGS. 4A-4D, shows a particular perspective of a document that includes at least one particular lexical unit submission accepting module 252 of processing module 250 of client device 220 of FIG. 2B, according to an embodiment.

FIG. 5, including FIGS. 5A-5D, shows a particular perspective of a acquisition of document adaptation data that includes data configured to be used to adapt the particular document facilitating module 254 of processing module 250 of client device 220 of FIG. 2B, according to an embodiment.

FIG. 6, including FIGS. 6A-6G, shows a particular perspective of an adapted document in which at least a portion of at least one occurrence of the at least one particular lexical unit has been replaced with at least a portion of an acquired replacement lexical unit that is at least partly based on the document adaptation data obtaining module 256 of processing module 250 of client device 220 of FIG. 2B, according to an embodiment.

FIG. 7 is a high-level logic flowchart of a process, e.g., operational flow 700, including one or more operations of an accepting a submission of a particular document operation, a facilitating acquisition of document modification data operation, and an obtaining an updated document operation, according to an embodiment.

FIG. 8A is a high-level logic flow chart of a process depicting alternate implementations of an accepting a submission of a particular document operation 702, according to one or more embodiments.

FIG. 8B is a high-level logic flow chart of a process depicting alternate implementations of an accepting a submission of a particular document operation 702, according to one or more embodiments.

FIG. 8C is a high-level logic flow chart of a process depicting alternate implementations of an accepting a submission of a particular document operation 702, according to one or more embodiments.

FIG. 8D is a high-level logic flow chart of a process depicting alternate implementations of an accepting a submission of a particular document operation 702, according to one or more embodiments.

FIG. 9A is a high-level logic flow chart of a process depicting alternate implementations of a facilitating acquisition of document modification data operation 704, according to one or more embodiments.

FIG. 9B is a high-level logic flow chart of a process depicting alternate implementations of a facilitating acquisition of document modification data operation 704, according to one or more embodiments.

FIG. 9C is a high-level logic flow chart of a process depicting alternate implementations of a facilitating acquisition of document modification data operation 704, according to one or more embodiments.

FIG. 9D is a high-level logic flow chart of a process depicting alternate implementations of a facilitating acquisition of document modification data operation 704, according to one or more embodiments.

FIG. 10A is a high-level logic flow chart of a process depicting alternate implementations of an obtaining an updated document operation 706, according to one or more embodiments.

FIG. 10B is a high-level logic flow chart of a process depicting alternate implementations of an obtaining an updated document operation 706, according to one or more embodiments.

FIG. 10C is a high-level logic flow chart of a process depicting alternate implementations of an obtaining an updated document operation 706, according to one or more embodiments.

FIG. 10D is a high-level logic flow chart of a process depicting alternate implementations of an obtaining an updated document operation 706, according to one or more embodiments.

FIG. 10E is a high-level logic flow chart of a process depicting alternate implementations of an obtaining an updated document operation 706, according to one or more embodiments.

FIG. 10F is a high-level logic flow chart of a process depicting alternate implementations of an obtaining an updated document operation 706, according to one or more embodiments.

FIG. 10G is a high-level logic flow chart of a process depicting alternate implementations of an obtaining an updated document operation 706, according to one or more embodiments.

### DETAILED DESCRIPTION

In the following detailed description, reference is made to the accompanying drawings, which form a part hereof In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Thus, in accordance with various embodiments, computationally implemented methods, systems, circuitry, articles of manufacture, ordered chains of matter, and computer program products are designed to, among other things, provide an interface for accepting a submission of a particular document that includes at least one particular lexical unit, facilitating acquisition of document modification data that includes data configured to be used to determine a modification to the particular document, and receiving an updated document in which at least a portion of at least one occurrence of the at least one particular lexical unit has been replaced with at least a portion of an acquired replacement lexical unit that is at least partly based on the document modification data.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software (e.g., a high-level computer program serving as a hardware specification)).

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. In order to facilitate human comprehension, in many instances, high-level programming languages resemble or even share symbols with natural languages.

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software (e.g., a high-level computer program serving as a hardware specification), and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software (e.g., a high-level computer program serving as a hardware specification), and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software (e.g., a high-level computer program serving as a hardware specification) implementation; or, yet again alternatively, the implementer may opt for some combination of hardware, software (e.g., a high-level computer program serving as a hardware specification), and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software (e.g., a high-level computer program serving as a hardware specification), and or firmware.

In some implementations described herein, logic and similar implementations may include computer programs or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software (e.g., a high-level computer program serving as a hardware specification) or firmware, or of gate arrays or programmable hardware, such as by performing a reception of or a transmission of one or more instructions in relation to one or more operations described herein. Alternatively or additionally, in some variants, an implementation may include special-purpose hardware, software (e.g., a high-level computer program serving as a hardware specification), firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operation described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The term module, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of module (e.g., at a first time), as a second type of module (e.g., at a second time, which may in some instances coincide with, overlap, or follow a first time), and/or as a third type of module (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first module that has a first purpose, then a second module that has a second purpose and then, a third module that has a third purpose, and so on. The transition of a reconfigurable and/or controllable component may occur in as little as a few nanoseconds, or may occur over a period of minutes, hours, or days.

In some such examples, at the time the component is configured to carry out the second purpose, the component may no longer be capable of carrying out that first purpose until it is reconfigured. A component may switch between configurations as different modules in as little as a few nanoseconds. A component may reconfigure on-the-fly, e.g., the reconfiguration of a component from a first module into a second module may occur just as the second module is needed. A component may reconfigure in stages, e.g., portions of a first module that are no longer needed may reconfigure into the second module even before the first module has finished its operation. Such reconfigurations may occur automatically, or may occur through prompting by an external source, whether that source is another component, an instruction, a signal, a condition, an external stimulus, or similar.

For example, a central processing unit of a personal computer may, at various times, operate as a module for displaying graphics on a screen, a module for writing data to a storage medium, a module for receiving user input, and a module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple modules, the example includes the possibility that the same hardware may implement more than one of the recited modules, either contemporaneously or at discrete times or timings. The implementation of multiple modules, whether using more components, fewer components, or the same number of components as the number of modules, is merely an implementation choice and does not generally affect the operation of the modules themselves. Accordingly, it should be understood that any recitation of multiple discrete modules in this disclosure includes implementations of those modules as any number of underlying components, including, but not limited to, a single component that reconfigures itself over time to carry out the functions of multiple modules, and/or multiple components that similarly reconfigure, and/or special purpose reconfigurable components.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

To the extent that formal outline headings are present in this application, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, any use of formal outline headings in this application is for presentation purposes, and is not intended to be in any way limiting.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although one or more users maybe shown and/or described herein, e.g., in FIG. 1, and other places, as a single illustrated figure, those skilled in the art will appreciate that one or more users may be representative of one or more human users, robotic users (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

System Architecture

FIG. 1, including FIGS. 1A to 1AD, shows partial views that, when assembled, form a complete view of an entire system, of which at least a portion will be described in more detail. An overview of the entire system of FIG. 1 is now described herein, with a more specific reference to at least one subsystem of FIG. 1 to be described later with respect to FIGS. 3-15.

Document Altering Implementation 3100 and Document Altering Server Implementation 3900

Referring now to FIG. 1, e.g., FIG. 1A, in an embodiment, an entity, e.g., a user 3005 may interact with the document altering implementation 3100. Specifically, in an embodiment, user 3005 may submit a document, e.g., an example document 3050 to the document altering implementation. This submission of the document may be facilitated by a user interface that is generated, in whole or in part, by document altering implementation 3100. Document altering implementation 3100, like all other implementations mentioned in this application, unless otherwise specifically excluded, may be implemented as an application on a computer, as an application on a mobile device, as an application that runs in a web browser, as an application that runs over a thin client, or any other implementation that allows interaction with a user through a computational medium.

For clarity in understanding an exemplary embodiment, a simple example is used herein, however substantially more complex examples of document alterations may occur, as will be discussed herein. In the exemplary embodiment shown in FIG. 1A, an example document 3050 may include, among other text, the phrase “to be or not to be, that is the question.” In an embodiment, this text may be uploaded to a document acquiring module 3110 that is configured to acquire a document that includes a particular set of phrases. In another embodiment, the document acquiring module 3110 may obtain the text of example document 3050 through a text entry window, e.g., through typing by the user 3005 or through a cut-and-paste operation. Document acquiring module 3110 may include a UI generation for receiving the document facilitating module 3116 that facilitates the interface for the user 3005 to input the text of the document into the system, e.g., through a text window, or through an interface to copy/upload a file, for example.

Document acquiring module 3110 may include a document receiving module 3112 that receives the document from the user 3005. Document acquiring module 3110 also may include a particular set of phrases selecting module 3114, which may select the particular set of phrases that are to be analyzed. For example, there may be portions of the document that specifically may be targeted for modification, e.g., the claims of a patent application. In an embodiment, the automation of particular set of phrases selecting module 3114 may select the particular set of phrases based on pattern recognition of a document, e.g., the particular set of phrases selecting module 3114 may pick up a cue at the “what is claimed is” language from a patent application, and begin marking the particular set of phrases from that point forward, for example. In another embodiment, the particular set of phrases selecting module 3114 may include an input regarding selection of the particular set of phrases receiving module 3115, which may request and/or receive user input regarding the particular set of phrases (“PSOP”).

After processing is completed by the document acquiring module 3110 of document altering implementation 3100, there are two different paths through which the operations may continue, depending on whether there is a document altering assistance implementation present, e.g., document altering assistance implementation 3900, e.g., as shown in FIG. 1B. Document altering assistance implementation 3900 will be discussed in more detail herein. For the following example, in an embodiment, processing may shift to the left-hand branch, e.g., from document acquiring module 3110 to document analysis performing module 3120, that is configured to perform analysis on the document and the particular set of phrases. Document analysis module 3120 may include a potential readership factors obtaining module 3122 and a potential readership factors application module 3124 that is configured to apply the potential readership factors to determine a selected phrase of the particular set of phrases.

In one of the examples shown in FIG. 1A, the potential readership factor is “our potential readership is afraid of the letter ‘Q.’ This example is merely for exemplary purposes, and is rather simple to facilitate illustration of this implementation. More complex implementations may be used for the potential reader factors. For example, a potential reader factor for a scientific paper may be “our potential readership does not like graphs that do not have zero as their origin.” A potential reader factor for a legal paper may be “this set of judges does not like it when dissents are cited,” or “this set of judges does not like it when cases from the Northern District of California are cited.” These potential reader factors may be delivered in the form of a relational data structure, e.g., a relational database, e.g., relational database 4130. The process for deriving the potential readership factors will be described in more detail herein, however, it is noted that, although some implementations of the obtaining of potential readership factors may use artificial intelligence (AI) or human intervention, such is not required. A corpus of documents that have quantifiable outcomes (e.g., judicial opinions based on legal briefs, or literary criticisms that end with a numerical score/letter grade) may have their text analyzed, with an attempt to draw correlations using intelligence amplification. For example, it may be noted that for a particular judge, when a legal brief that cites dissenting opinions appears, that side loses 85% of the time. These correlations do not imply causation, and in some embodiments the implication of causation is not required, e.g., it is enough to see the correlation and suggest changes that move away from the correlation.

Referring again to FIG. 1A, in an embodiment, processing may move to updated document generating module 3140, which may be configured to generate an updated document in which at least one phrase of the particular set of phrases is replaced with a replacement phrase. For example, in the illustrated example, the word “question” is replaced with the word “inquiry.” The word that is replaced is not necessarily always the same word, although it could be. For example, in an embodiment, when the word “question” appears twenty-five times in a document, five each of the twenty-five times, the word may be replaced with a synonym for the word “question” which may be pulled from a thesaurus. In an embodiment, when the word question appears twenty-five times in the document, then in any number of the twenty-five occurrences, including zero and twenty-five, the word may be left unaltered, depending upon the algorithm that is used to process the document and/or a human input. In an embodiment, the user may be queried to find a replacement word (e.g., in the case of citations to legal authority, if those cannot be duplicated using automation (e.g., searching relevant case law for similar texts), then the user may be queried to enter a different citation that may be used in place of the citation that is determined to be replaced.

Referring now to FIG. 1F (to the “south” of FIG. 1A), document altering implementation 3100 may include updated document providing module 3190, which may provide the updated document to the user 3005, e.g., through a display of the document, or through a downloadable link or text document.

Referring now to FIG. 1G (to the “east” of FIG. 1F and “southeast” of FIG. 1A), in an alternate embodiment, one document may be inputted, and many documents may be outputted, each with a different level of phrase replacement. The phrase replacement levels may be based on feedback from the user, or through further analysis of the correlations determined in the data structure that includes the potential readership factors, or may be a representation of the estimated causation for the correlation, which may be user-inputted or estimated through automation.

Referring again to FIG. 1A, in an embodiment, from document acquiring module 3110, processing may flow to the “right” branch to document transmitting module 3130. Document transmitting module 3130 may transmit the document to document altering assistance implementation 3900 (depicted in FIG. 1B, to the “east” of FIG. 1A). Document altering assistance implementation 3900 will be discussed in more detail herein. Document acquiring module 3110 then may include updated document receiving module 3150 configured to receive an updated document in which at least one phrase of the particular set of phrases has been replaced with a replacement phrase. Similarly to the “left” branch of document altering implementation 3100, processing then may continue to updated document providing module 3190 (depicted in FIG. 1F), which may provide the updated document to the user 3005, e.g., through a display of the document, or through a downloadable link or text document.

Referring now to FIG. 1B, an embodiment of the invention may include document altering assistance implementation 3900. In an embodiment, document altering assistance implementation 3900 may act as a “back-end” server for document altering implementation 3100. In another embodiment, document altering assistance implementation 3900 may operate as a standalone implementation that interacts with a user (not depicted). In an embodiment, document altering assistance implementation 3900 may include source document acquiring module 3910 that is configured to acquire a source document that contains a particular set of phrases. Source document acquiring module 3910 may include source document receiving from remote device module 3912, which may be present in implementations in which document altering assistance implementation 3900 acts as an implementation that works with document altering implementation 3100. Source document receiving from remote device module 3912 may receive the source document (e.g., in this example, a document that includes the phrase “to be or not to be, that is the question”). In an embodiment, source document acquiring module 3910 may include source document accepting from user module 3914, which may operate similarly to document acquiring module 3110 of document altering implementation 3100 (depicted in FIG. 1A).

Referring again to FIG. 1B, document altering assistance implementation 3900 may include document analysis module 3920 that is configured to perform analysis on the document and the particular set of phrases. Document analysis module 3920 may be similar to document analysis module 3120 of document altering implementation 3100. For example, in an embodiment, document analysis module 3920 may include potential readership factors obtaining module 3922, which may receive potential readership factors 3126. As previously described with respect to document altering implementation 3100, potential readership factors 3126 may be generated by the semantic corpus analyzer implementation 4100, in a process that will be described in more detail herein.

Referring again to FIG. 1B, document altering assistance implementation 3900 may include updated document generating module 3930 that is configured to generate an updated document in which at least one phrase of the particular set of phrases has been replaced with a replacement phrase. In an embodiment, this module acts similarly to updated document generating module 3140 (depicted in FIG. 1A). In an embodiment, updated document generating module 3930 may contain replacement phrase determination module 3932 and selected phrase replacing with the replacement phrase module 3934, as shown in FIG. 1B.

Referring again to FIG. 1B, document altering assistance implementation 3900 may include updated document providing module 3940 that is configured to provide the updated document to a particular location. In an embodiment in which document altering assistance implementation 3900 is performing one or more steps for document altering implementation 3100, updated document providing module 3940 may provide the updated document to updated document receiving module 3150 of FIG. 1A. In an embodiment in which document altering assistance implementation 3900 is operating alone, updated document providing module 3940 may provide the updated document to the user 3005, e.g., through a user interface. In an embodiment, updated document providing module 3940 may include one or more of an updated document providing to remote location module 3942 and an updated document providing to user module 3944.

Referring again to FIG. 1B, one of the potential readership factors may be that the readership does not like “to be verbs,” in which case the updated document generating module may replace the various forms of “to be” verbs (am, is, are, was, were, be, been, and being) with other words selected from a thesaurus. Referring now to FIG. 1G, this selection may vary (e.g., one instance of “be” may be replaced with “exist,” and another instance of “be” may be replaced with “abide,” or only one or zero of the occurrences may be replaced, for example, in various embodiments.

Document TimeShifting Implementation 3300, Document Technology ScopeShifting Implementation 3500, and Document Shifting Assistance Implementation 3800 Altering Implementation 3100 and Document Altering Server Implementation 3900

Referring now to FIG. 1C, in an embodiment, there may be a document timeshifting implementation 3300 that accepts a document as input, and, using automation, rewrites that document using the language of a specific time period. The changes may be colloquial in nature (e.g., using different kinds of slang, replacing newer words with outdated words/spellings), or may be technical in nature (e.g., replacing “HDTV” with “television,” replacing “smartphone” with “cell phone” or “PDA”). In an embodiment, document timeshifting implementation 3300 may include a document accepting module 3310 configured to accept a document (e.g., through a user interface) that is written using the vocabulary of a particular time. For example, the time period of the document might be the present time. In an embodiment, document accepting module 3310 may include one or more of a user interface for document acceptance providing module 3312, a document receiving module 3314, and a document time period determining module 3316, which may use various dictionaries to analyze the document to determine which time period the document is from (e.g., by comparing the vocabulary of the document to vocabularies associated with particular times).

Referring again to FIG. 1C, in an embodiment, document timeshifting implementation 3300 may include target time period obtaining module 3320, which may be configured to receive the target time period that the user 3005 wants to transform the document into. In an embodiment, target time period obtaining module 3320 may include presentation of a UI facilitating module 3322 that presents a user interface to the user 3005. One example of this user interface may be a sliding scale time period that allows a user 3005 to drag the time period to the selected time. This example is merely exemplary, as other implementations of a user interface could be used to obtain the time period from the user 3005. For example, in an embodiment, target time period obtaining module 3320 may include inputted time period receiving module 3324 that may receive an inputted time period from the user 3005. In an embodiment of the invention, target time period obtaining module 3320 may include a word vocabulary receiving module 3326 that receives words inputted by the user 3005, either through direct input (e.g., keyboard or microphone), or through a text file, or a set of documents. Target time period obtaining module 3320 also may include time period calculating from the vocabulary module 3328 that takes the inputted vocabulary and determines, using time-period specific dictionaries, the time period that the user 3005 wants to target.

Referring now to FIG. 1H (to the “south” of FIG. 1C), in an embodiment, document timeshifting implementation 3300 may include updated document generating module 3330 that is configured to generate an updated document in which at least one phrase has been timeshifted to use similar or equivalent words from the selected time period. In an embodiment, this generation and processing, which includes use of dictionaries that are time-based, may be done locally, at document timeshifting implementation 3300, or in a different implementation, e.g., document timeshifting assistance implementation 3800, which may be local to document timeshifting implementation 3300 or may be remote from document timeshifting implementation 3300, e.g., connected by a network. Document timeshifting assistance implementation 3800 will be discussed in more detail herein.

Referring again to FIG. 1H, in an embodiment, document timeshifting implementation 3300 may include updated document presenting module 3340 which may be configured to present an updated document in which at least one phrase has been timeshifted to use equivalent or similar words from the selected time period. For example, in the examples illustrated in FIG. 1H, which are necessarily short for brevity's sake, the word “bro” has been replaced with “dude,” and the word “smartphone” is replaced with the word “personal digital assistant.” In another example, the word “bro” has been replaced with the word “buddy,” and the word “smartphone” has been replaced with the word “bag phone.”

Referring now to FIG. 1D, document timeshifting and scopeshifting assistance implementation 3800 may be present. Document timeshifting and scopeshifting assistance implementation 3800 may interface with document timeshifting implementation 3300 and/or document technology scope shifting implementation 3500 to perform the work in generating an updated document with the proper shifting taking place. In an embodiment, document timeshifting and scopeshifting assistance implementation 3800 may be part of document timeshifting implementation 3300 or document technology scope shifting implementation 3500. In another embodiment, document timeshifting and scopeshifting assistance implementation 3800 may be remote from document timeshifting implementation 3300 or document technology scope shifting implementation 3500, and may be connected through a network or through other means.

Referring again to FIG. 1D, document timeshifting and scopeshifting assistance implementation 3800 may include a source document receiving module 3810, which may receive the document that is to be time shifted (if received from document timeshifting implementation 3300) or to be technology scope shifted (if received from document technology scope shifting implementation 3500). Source document receiving module 3810 may include year/scope level receiving module 3812, which, in an embodiment, may also receive the time period or technological scope the document is to be shifted to.

Referring again to FIG. 1D, document timeshifting and scopeshifting assistance implementation 3800 may include updated document generating module 3820. Updated document generating module 3820 may include timeshifted document generating module 3820A that is configured to generate an updated timeshifted document in which at least one phrase has been timeshifted to use equivalent words from the selected time period generating module, in a similar manner as updated document generating module 3330. In an embodiment, updated document generating module 3820 may include technology scope shifted document generating module 3820B which may be configured to generate an updated document in which at least one phrase has been scope-shifted to use equivalent words from the from the selected level of technology. In an embodiment, technology scope shifted document generating module 3820B operates similarly to updated document generating module 3530 of document technology scope shifting implementation 3500, which will be discussed in more detail herein.

Referring now to FIG. 1I, to the “south” of FIG. 1D, in an embodiment, document timeshifting and scopeshifting assistance implementation 3800 may include updated document transmitting module 3830, which may be configured to deliver the updated document to the updated document presenting module 3340 of document timeshifting implementation 3300 or to the updated document presenting module 3540 of document technology scope shifting implementation 3500.

Referring now to FIG. 1E, in an embodiment, document technology scope shifting implementation 3500 may receive a document that includes one or more technical terms, and “shift” those terms downward in scope. For example, a complex device, like a computer, can be broken down into parts in increasingly larger diagrams. For example, a “computer” could be broken down into a “processor, memory, and an input/output.” These components could be further broken down into individual chips, wires, and logic gates. Because this process can be done in an automated manner to arrive at generic solutions (e.g., a specific computer may not be able to be broken down automatically in this way, but a generic “computer” device or a device which has specific known components can be). In another embodiment, a user may intervene to describe portions of the device to be broken down (e.g., has a hard drive, a keyboard, a monitor, 8 gigabytes of RAM, etc.) In another embodiment, schematics of common devices, e.g., popular cellular devices, e.g., an iPhone, that are static, may be stored for use and retrieval. It is noted that this implementation can work for software applications as well, which can be dissembled through automation all the way down to their assembly code.

Referring again to FIG. 1E, document technology scope shifting implementation 3500 may include document accepting module 3510 configured to accept a document that is written using the vocabulary of a particular technological scope. For example, document accepting module 3510 may include a user interface for document acceptance providing module 3512, which may be configured to accept the source document to which technological shifting is to be applied, e.g., through a document upload, typing into a user interface, or the like. In an embodiment, document accepting module 3510 may include a document receiving module 3514 which may be configured to receive the document. In an embodiment, document accepting module 3510 may include document technological scope determining module 3516 which may determine the technological scope of the document through automation by analyzing the types of words and diagrams used in the document (e.g., if the document uses logic gate terms, or chip terms, or component terms, or device terms).

Referring again to FIG. 1E, document technology scope shifting implementation 3500 may include technological scope obtaining module 3520. Technological scope obtaining module 3520 may be configured to obtain the desired technological scope for the output document from the user 3005, whether directly, indirectly, or a combination thereof. In an embodiment, technological scope obtaining module 3520 may include presentation of a user interface facilitating module 3522, which may be configured to facilitate presentation of a user interface to the user 3005, so that the user 3005 may input the technological scope desired by the user 3005. For example, one instantiation of the presented user interface may include a sliding scale bar for which a marker can be “dragged” from one end representing the highest level of technological scope, to the other end representing the lowest level of technological scope. This example is merely for illustrative purposes, as other instantiations of a user interface readily may be used.

Referring again to FIG. 1E, in an embodiment, technological scope obtaining module 3520 may include inputted technological scope level receiving module 3524 which may receive direct input from the user 3005 regarding the technological scope level to be used for the output document. In an embodiment, technological scope obtaining module 3520 may include word vocabulary receiving module 3526 that receives an inputted vocabulary from the user 3005 (e.g., either typed or through one or more documents), and technological scope determining module 3528 configured to determine the technological scope for the output document based on the submitted vocabulary by the user 3005.

Referring now to FIG. 1J, e.g., to the “south” of FIG. 1E, in an embodiment, document technology scope shifting implementation 3500 may include updated document generating module 3530 that is configured to generate an updated document in which at least one phrase has been technologically scope shifted to use equivalent words from the selected technological level. In an embodiment, this generation and processing, which includes use of general and device-specific schematics and thesauruses, may be done locally, at document technology scope shifting implementation 3500, or in a different implementation, e.g., document technology scope shifting assistance implementation 3800, which may be local to document technology scope shifting implementation 3500 or may be remote from document technology scope shifting implementation 3500, e.g., connected by a network. Document timeshifting assistance implementation 3800 previously was discussed with reference to FIGS. 1D and 1I.

Referring again to FIG. 1J, in an embodiment, document technology scope shifting implementation 3500 may include updated document presenting module 3540, which may present the updated document to the user 3005. For example, in the example shown in FIG. 1J, which is abbreviated for brevity's sake, the document “look at that smartphone” has been replaced with “look at that collection of logical gates connected to a radio antenna, a speaker, and a microphone.” In an embodiment of the invention, the process carried out by document technology scope shifting implementation 3500 may be iterative, where each iteration decreases or increases the technology scope by a single level, and the document is iteratively shifted until the desired scope has been reached.

Semantic Corpus Analyzer Implementation 4100

Referring now to FIG. 1K, FIG. 1K illustrates a semantic corpus analyzer implementation 4100 according to various embodiments. In an embodiment, semantic corpus analyzer implementation 4100 may be used to analyze one or more corpora that are collected in various ways and through various databases. For example, in an embodiment, semantic corpus analyzer 4100 may receive a set of documents that are uploaded by one or more users, where the documents make up a corpus. In another embodiment, semantic corpus analyzer implementation 4100 may search one or more document repositories, e.g., a database of case law (e.g., as captured by PACER or similar services), a database of court decisions such as WestLaw or Lexis (e.g., a scrapeable/searchable database 5520), a managed database such as Google Docs or Google Patents, or a less accessible database of documents. For example, a corpus could be a large number of emails stored in an email server, a scrape of a social networking site (e.g., all public postings on Facebook, for example), or a search of cloud services. For example, one input to the semantic corpus analyzer implementation 4100 could be a cloud storage services 5510 that dumps the contents of people's cloud drives to the analyzer for processing. In an embodiment, this could be permitted by the terms of use for the cloud storage services, e.g., if the data was processed in large batches without personally identifying information.

Referring again to FIG. 1K, in an embodiment, semantic corpus analyzer implementation 4100 may include corpus of related texts obtaining module 4110, which may obtain a corpus of texts, similarly to as described in the previous paragraph. In an embodiment, corpus of related texts obtaining module 4110 may include texts that have a common author receiving module 4112 which may receive a corpus of texts or may filter an existing corpus of texts for works that have a common author. In an embodiment, corpus of related texts obtaining module 4110 may include texts located in a similar database receiving module 4114 and set of judicial opinions from a particular judge receiving module 4116, which may retrieve particular texts as their names describe.

Referring again to FIG. 1K, in an embodiment, semantic corpus analyzer implementation 4100 may include corpus analysis module 4120 that is configured to perform an analysis on the corpus. In an embodiment, this analysis may be performed with artificial intelligence (AI). However, this is not necessary, as corpus analysis may be carried out using intelligence amplification (IA), e.g., machine-based tools and rule sets. For example, some corpora may have quantifiable outcomes assigned to them. For example, judicial opinions at the trial level may have an outcome of “verdict for plaintiff” or “verdict for defendant.” Critical reviews, whether of literature or other, may have an outcome of a numeric score or letter grade associated with the review. In such an implementation, documents that are related to a particular outcome (e.g., briefs related to a case in which verdict was rendered for plaintiff) are processed to determine objective factors, e.g., number of cases that were cited, total length, number of sentences that use passive verbs, average reading level as scored on one or more of the Flesch-Kincaid readability tests (e.g., one example of which is the Flesch reading ease test, which scores 206.835−1.015*(total words/total sentences)−84.6*(total syllables/total words)). Other proprietary readability tests may be used, including the Gunning fog index, the Dale-Chall readability formula, and the like. In an embodiment, documents may be analyzed for paragraph length, sentence length, sentence structure (e.g., what percentage of sentences follow classic subject-verb-object formulation). The above tests, as well as others, can be performed by machine analysis without resorting to artificial intelligence, neural networks, adaptive learning, or other advanced machine states, although such machine states may be used to improve processing and/or efficiency. These objective factors can be compared with the quantifiable outcomes to determine a correlation. The correlations may be simple, e.g., “briefs that used less than five words that begin with “Q” led to a positive outcome 90% of the time,” or more complex, e.g., “briefs that cited a particular line of authority led to a positive outcome 72% of the time when Judge Rader writes the final panel decision.” In an embodiment, the machine makes no judgment on the reliability of the correlations as causation, but merely passes the data along as correlation data. The foregoing illustrations in this paragraph are merely exemplary, are purposely limited in their complexity to ease understanding, and should not be considered as limiting.

Referring again to FIG. 1K, in an embodiment, semantic corpus analyzer implementation 4100 may include a data set generating module 4130 that is configured to generate a data set that indicates one or more patterns and or characteristics (e.g., correlations) relative to the analyzed corpus. For example, data set generating module 4130 may receive the correlations and data indicators received from corpus analysis performing module 4120, and package those correlations into a data structure, e.g., a database, e.g., dataset 4130. This dataset 4130 may be used to determine potential readership factors for document altering implementation 3100 of FIG. 1A, as previously described. In an embodiment, data set generating module 4130 may generate a relational database, but this is just exemplary, and other data structures or formats may be implemented.

Legal Document Outcome Prediction Implementation 5200

Referring now to FIG. 1M, FIG. 1M describes a legal document outcome prediction implementation 5200, according to embodiments. In an embodiment, for example, FIG. 1M shows document accepting module 5210 which receives a legal document, e.g., a brief. In the illustrated example, e.g., referring to FIG. 1H (to the “north” of FIG. 1M), a legal brief is submitted in an appellate case to try to convince a panel of judges to overturn a decision.

Referring again to FIG. 1M, legal document outcome prediction implementation 5200 may include readership determining module 5220, which may determine the readership for the legal brief, either through computational means or through user input, or another known method. For example, in an embodiment, readership determining module 5220 may include a user interface for readership selection presenting module 5222 which may be configured to present a user interface to allow a user 3005 to select the readership (e.g., the specific judge or panel, if known, or a pool of judges or panels, if not). In an embodiment, readership determining module 5220 may include readership selecting module 5224 which may search publicly available databases (e.g., lists of judges and/or scheduling lists) to make a machine-based inference about the potential readership for the brief. For example, readership selecting module 5224 may download a list of judges from a court website, and then determine the last twenty-five decision dates and judges to determine if there is any pattern.

Referring again to FIG. 1M, legal document outcome prediction implementation 5200 may include a source document structural analysis module 5230 which may perform analysis on the source document to determine various factors that can be quantified, e.g., reading level, number of citations, types of arguments made, types of authorities cited to, etc. In an embodiment, the analysis of the document may be performed in a different implementation, e.g., document outcome prediction assistance implementation 5900 illustrated in FIG. 1L, which will be discussed in more detail further herein.

Referring again to FIG. 1M, legal document outcome prediction implementation 5200 may include analyzed source document comparison with corpora performing module 5240. In an embodiment, analyzed source document comparison with corpora performing module 5240 may receive a corpus related to the determined readership, e.g., corpus 5550, or the data set 4130 referenced in FIG. 1K. In an embodiment, analyzed source document comparison with corpora performing module 5240 may compare the various correlations between documents that have the desired outcome and shared characteristics of those documents, and that data may be categorized and organized, and passed to outcome prediction module 5250.

In an embodiment, legal document outcome prediction implementation 5200 may include outcome prediction module 5250. Outcome prediction module 5250 may be configured to take the data from the analyzed source document compared to the corpus/data set, and predict a score or outcome, e.g., “this brief is estimated to result in reversal of the lower court 57% of the time.” In an embodiment, the outcome prediction module 5250 takes the various correlations determined by the comparison module 5240, compares these correlations to the correlations in the document, and makes a judgment based on the relative strength of the correlations. The correlations may be modified in strength by human factors (e.g., some factors, like “large number of cites to local authority” may be given more weight by human design), or the correlations may be treated as equal weight and processed in that manner. Thus, outcome prediction module predicts a score, outcome, or grade. Some exemplary results of outcome prediction module are listed in FIG. 1R (e.g., to the “South” of FIG. 1M).

Referring again to FIG. 1M, in an embodiment, legal document outcome prediction implementation 5200 may include predictive output presenting module 5260, which may present the prediction results in a user interface, e.g., on a screen or other format (e.g., auditory, visual, etc.).

Referring now to FIG. 1N, FIG. 1N shows a literary document outcome prediction implementation 5300 that is configured to predict how a particular critic or group of critics may receive a literary work, e.g., a novel. For example, in the embodiment depicted in the drawings, an example science fiction novel illustrated in FIG. 1I, e.g., the science fiction novel “The Atlantis Conspiracy” is presented to the literary document outcome prediction implementation. 5300 for processing, and a predictive outcome is computationally determined and presented, as will be described herein.

Referring again to FIG. 1N, literary document outcome prediction implementation 5300 may include a document accepting module 5310 configured to accept the literary document. Document accepting module 5310 may operate similarly to document accepting module 5210, that is, it may accept a document as text in a text box, or an upload/retrieval of a document or documents, or a specification of a document location on the Internet or on an intranet or cloud drive.

Referring again to FIG. 1N, literary document outcome prediction implementation 5300 may include readership determining module 5320, which may determine one or more critics to which the novel is targeted. These critics may be newspaper critics, bloggers, online reviewers, a community of people, whether real or online, and the like. Readership determining module 5320 may operate similarly to readership determining module 5220, in that it may accept user input of the readership, or search various online database for the readership. In an embodiment, readership determining module 5320 may include user interface for readership selection presenting module 5322, which may operate similarly to user interface for readership selection presenting module 5222, and which may be configured to accept user input regarding the readership. In an embodiment, readership determining module 5320 may include readership selecting module 5324, which may select an readership using, e.g., prescreened categories (e.g., teens, men aged 18-34, members of the scifi.com community, readers of a popular science fiction magazine, a list of people that have posted on a particular form, etc.).

Referring again to FIG. 1N, literary document outcome prediction implementation 5300 may include a source document structural analysis module 5330. Similarly to legal document outcome prediction implementation 5200, literary document outcome prediction implementation 5300 may perform the processing, or may transmit the document for processing at document outcome prediction assistance implementation 5900 referenced in FIG. 1L, which will be discussed in more detail herein. In an embodiment, source document structural analysis module 5330 may perform analysis on the literary document, including recognizing themes (e.g., Atlantis, government conspiracy, female lead, romantic backstory, etc.) through computational analysis of the text, or analyzing the reading level of the text, the length of the book, the “specialized” vocabulary (e.g., the use of words that have meaning only in-universe), and the like.

Referring again to FIG. 1N, in an embodiment, literary document outcome prediction implementation 5300 may include analyzed source document comparison with corpora module 5340, which may compare the source document with the corpus of critical reviews, as well as the underlying books. For example, in an embodiment, the critical review may be analyzed for praise or criticism of factors that are found in the source document. In another embodiment, the underlying work of the critical review may be analyzed to see how it correlates to the source document. In another embodiment, a combination of these approaches may be used.

Referring again to FIG. 1N, in an embodiment, literary document outcome prediction implementation 5300 may include score/outcome predicting module 5350 that is configured to predict a score/outcome based on performed corpora comparison. In an embodiment, module 5350 operates in a similar fashion to score/outcome predicting module 5250 of legal document outcome prediction implementation 5200, described in FIG. 1M.

Referring again to FIG. 1N, in an embodiment, literary document outcome prediction implementation 5300 may include predictive output presenting module 5360, which may be configured to present the score or output generated by score/outcome predicting module 5350. An example of some of the possible presented outputs are shown in FIG. 1S, to the “south” of FIG. 1N.

Referring now to FIG. 1-O (the alternate format is to avoid confusion with “FIG. 10”), FIG. 1-O shows multiple literary documents outcome prediction implementation 5400. In an embodiment, multiple literary documents outcome prediction implementation 5400 may include a documents accepting module 5410, an readership determining module 5420 (e.g., which, in some embodiments, may include a user interface for readership selection presenting module 5422 and/or an readership selecting module 5424), a source documents structural analysis module 5430, an analyzed source documents comparison with corpora performing module 5930, a score/outcome predicting module 5450 configured to generate a score/outcome prediction that is at least partly based on performed corpora comparison, and a predictive output presenting module 5460. These modules operate similarly to their counterparts in literary document outcome prediction implementation, with the exception that multiple documents are taken as inputs, and the outputs may include various rank-ordered lists of the documents by critic or set of critics. An exemplary output is shown in FIG. 1T (to the “south” of FIG. 1-O). In an embodiment, multiple literary documents outcome prediction implementation 5400 may receive reviews from critics, e.g., reviews from critic 5030A, reviews from critic 5030B, and reviews from critic 5030C.

Referring now to FIG. 1L, FIG. 1L shows a document outcome prediction assistance implementation 5900, which, in some embodiments, may be utilized by one or more of legal document outcome prediction implementation 5200, literary document outcome prediction implementation 5300, and multiple literary document outcome prediction assistance implementation 5400, illustrated in FIGS. 1M, 1N, and 1-O, respectively. In an embodiment, document outcome prediction assistance implementation 5900 may receive a source document at source document receiving module 5910, from one or more of legal document outcome prediction implementation 5200, literary document outcome prediction implementation 5300, and multiple literary document outcome prediction assistance implementation 5400, illustrated in FIGS. 1M, 1N, and 1-O, respectively.

Referring again to FIG. 1L, in an embodiment, document outcome prediction assistance implementation 5900 may include a received source document structural analyzing module 5920, which, in an embodiment, may include one or more of a source document structure analyzing module 5922, a source document style analyzing module 5924, and a source document reading level analyzing module 5926. In an embodiment, received source document structural analyzing module 5920 may operate similarly to modules 5230, 5330, and 5430 of legal document outcome prediction implementation 5200, literary document outcome prediction implementation 5300, and multiple literary document outcome prediction assistance implementation 5400, illustrated in FIGS. 1M, 1N, and 1-O, respectively.

Referring again to FIG. 1L, in an embodiment, document outcome prediction assistance implementation 5900 may include an analyzed source document comparison with corpora performing module 5930. Analyzed source document comparison with corpora performing module 5930 may include an in-corpora document with similar characteristic obtaining module 5932, which may obtain documents that are similar to the source document from the corpora. In an embodiment, analyzed source document comparison with corpora performing module 5930 may receive documents or information about documents from a corpora managing module 5980. Corpora managing module 5980 may include a corpora obtaining module 5982, which may obtain one or more corpora, from directly receiving or from searching and finding, or the like. Corpora managing module 5980 also may include database based on corpora analysis receiving module 5984, which may be configured to receive a data set that includes data regarding corpora, e.g., correlation data. For example, in an embodiment, database based on corpora analysis receiving module 5984 may receive the data set 4130 generated by semantic corpus analyzer implementation 4100 of FIG. 1K. It is noted that one or more of legal document outcome prediction implementation 5200, literary document outcome prediction implementation 5300, and multiple literary document outcome prediction assistance implementation 5400, illustrated in FIGS. 1M, 1N, and 1-O, respectively, also may receive data set 4130, although lines are not explicitly drawn in the system diagram.

Referring again to FIG. 1L, in an embodiment, document outcome prediction assistance implementation 5900 may include Score/outcome predicting module configured to generate a score/outcome prediction that is at least partly based on performed corpora comparison 5950. Module 5950 of document outcome prediction assistance implementation 5900 may operate similarly to modules 5250, 5350, and 5450 of legal document outcome prediction implementation 5200, literary document outcome prediction implementation 5300, and multiple literary document outcome prediction assistance implementation 5400, illustrated in FIGS. 1M, 1N, and 1-O, respectively.

Referring again to FIG. 1L, in an embodiment, document outcome prediction assistance implementation 5900 may include predictive result transmitting module 5960, which may transmit the result of score/outcome predicting module to one or more of legal document outcome prediction implementation 5200, literary document outcome prediction implementation 5300, and multiple literary document outcome prediction assistance implementation 5400, illustrated in FIGS. 1M, 1N, and 1-O, respectively.

Social Media Popularity Prediction Implementation 6400

Referring now to FIG. 1Q, FIG. 1Q shows a social media popularity prediction implementation 6400 that is configured to provide an interface for a user 3005 to receive an estimate of how popular the user's input to a social media network or other public or semi-public internet site will be. For example, in an embodiment, when a user 3005 is set to make a post to a social network, e.g., Facebook, Twitter, etc., or to a blog, e.g., through WordPress, or a comment on a YouTube video or ESPN.com article, prior to clicking the button that publishes the post or comment, they can click a button that will estimate the popularity of that post. This estimate may be directed to a particular readership (e.g., their friends, or particular people in their friend list), or to the public at large.

Social media popularity prediction implementation 6400 may be associated with an app on a phone or other device, where the app interacts with some or all communication made from that device. In addition, social media popularity prediction implementation 6400 can be used for user-to-user interactions, e.g., emails or text messages, whether to a group or to a single user. In an embodiment, social media popularity prediction implementation 6400 may be associated with a particular social network, as a distinguishing feature. In an embodiment, social media popularity prediction implementation 6400 may be packaged with the device, e.g., similarly to “Siri” voice recognition packaged with Apple-branded devices. In an embodiment, social media popularity prediction implementation 6400 may be downloaded from an “app store.” In an embodiment, social media popularity prediction implementation 6400 may be completely resident on a computer or other device. In an embodiment, social media popularity prediction implementation 6400 may utilized social media analyzing assistance implementation 6300, which will be discussed in more detail herein.

Referring again to FIG. 1Q, in an embodiment, social media popularity prediction implementation 6400 may include drafted text configured to be distributed to a social network user interface presentation facilitating module 6410, which may be configured to present at least a portion of a user interface to a user 3005 that is interacting with a social network. FIG. 1R (to the “east” of FIG. 1Q) gives a nonlimiting example of what that user interface might look like in the hypothetical social network site “twitbook.”

Referring again to FIG. 1Q, in an embodiment, social media popularity prediction implementation 6400 may include drafted text configured to be distributed to a social network accepting module 6420. Drafted text configured to be distributed to a social network accepting module 6420 may be configured to accept the text entered by the user 3005, e.g., through a text box.

Referring again to FIG. 1Q, in an embodiment, social media popularity prediction implementation 6400 may include acceptance of analytic parameter facilitating module 6430, which may be present in some embodiments, and in which may allow the user 3005 to determine the readership for which the popularity will be predicted. For example, some social networks may have groups of users or “friends,” that can be selected from, e.g., a group of “close friends,” “family,” “business associates,” and the like.

Referring again to FIG. 1Q, in an embodiment, social media popularity prediction implementation 6400 may include popularity score of drafted text predictive output generating/obtaining module 6440. Popularity score of drafted text predictive output generating/obtaining module 6440 may be configured to read a corpus of texts/posts made by various people, and their relative popularity (based on objective factors, such as views, responses, comments, “thumbs ups,” “reblogs,” “likes,” “retweets,” or other mechanisms by which social media implementations allow persons to indicate things that they approve of. This corpus of texts is analyzed using machine analysis to determine characteristics, e.g., structure, positive/negative, theme (e.g., political, sports, commentary, fashion, food), and the like, to determine correlations. These correlations then may be applied to the prospective source text entered by the user, to determine a prediction about the popularity of the source text.

Referring again to FIG. 1Q, in an embodiment, social media popularity prediction implementation 6400 may include predictive output presentation facilitating module 6450, which may be configured to present, e.g., through a user interface, the estimated popularity of the source text. An example of the output is shown in FIG. 1R (to the “east” of FIG. 1Q).

Referring now to FIG. 1V (to the “south” of FIG. 1Q), in an embodiment, social media popularity prediction implementation 6400 may include block of text publication to the social network facilitating module 6480, which may facilitate publication of the block of text to the social network.

Social Media Analyzing Assistance Implementation 6300

Referring now to FIG. 1P, FIG. 1P shows a social media analyzing implementation 6300, which may work in concert with social media popularity implementation 6400, or may work as a standalone operation. For example, in an embodiment, the popularity prediction mechanism may be run through the web browser of the user that is posting the text to social media, and social media analyzing assistance implementation 6300 may assist in such an embodiment. In an embodiment, social media analyzing assistance implementation 6300 may perform one or more of the steps, e.g., related to the processing or data needed from remote locations, for social media popularity prediction implementation 6400.

Referring again to FIG. 1P, in an embodiment, social media analyzing assistance implementation 6300 may include block of text receiving module 6310 that is configured to be transmitted to a social network for publication. The block of text receiving module 6310 may receive the text from a device or application that is operating the social media popularity prediction implementation 6400, or may receive the text directly from the user 3005, e.g., through a web browser interface.

Referring again to FIG. 1P, in an embodiment, the social media analyzing assistance implementation 6300 may include text block analyzing module 6320. In an embodiment, text block analyzing module 6320 may include text block structural analyzing module 6322, text block vocabulary analyzing module 6324, and text block style analyzing module 6326. In an embodiment, text block analyzing module 6320 may perform analysis on the text block to determine characteristics of the text block, e.g., readability, reading grade level, structure, theme, etc., as previously described with respect to other blocks of text herein.

Referring again to FIG. 1P, in an embodiment, the social media analyzing assistance implementation 6300 may include found similar post popularity analyzing module 6330, which may find one or more blocks of text (e.g., posts) that are similar in style to the analyzed text block, and analyze them for similar characteristics as above. The finding may be by searching the social media databases or through scraping publically available sites, and may not be limited to the social network in question.

Referring again to FIG. 1P, in an embodiment, the social media analyzing assistance implementation 6300 may include popularity score predictive output generating module 6340, which may use the analysis generated in module 6330 to generate a predictive output. Implementation 6300 also may include a generated popularity score predictive output presenting module 6350 configured to present the output to a user 3005, e.g., similarly to predictive output presentation facilitating module 6450 of social media popularity prediction implementation 6400. Social media analyzing assistance implementation 6300 also may include a generated popularity score predictive output transmitting module 6360 which may be configured to transmit the predictive output to social media popularity prediction implementation 6400 shown in FIG. 1Q.

Referring now to FIG. 1U (to the “south” of FIG. 1P), in an embodiment, social media popularity prediction implementation 6300 may include block of text publication to the social network facilitating module 6380, which may operate similarly to block of text publication to the social network facilitating module 6480 of social media popularity prediction implementation 6400, to facilitate publication of the block of text to the social network.

Legal Document Lexical Grouping Implementation 8100

Referring now to FIG. 1W, FIG. 1W shows a legal document lexical grouping implementation 8100, according to various embodiments. Referring to FIG. 1V, an evaluatable document, e.g., a legal document, e.g., a patent document, may be inputted to legal document lexical grouping implementation 8100.

Referring again to FIG. 1W, in an embodiment, legal document lexical grouping implementation 8100 may include a relevant portion selecting module 8110 which may be configured to select the relevant portions of the inputted evaluatable document, or which may be configured to allow a user 3005 to select the relevant portions of the document. For example, for a patent document, relevant portion selecting module may scan the document until it reaches the trigger words “what is claimed is,” and then may select the claims of the patent document as the relevant portion.

Referring again to FIG. 1W, in an embodiment, legal document lexical grouping implementation 8100 may include initial presentation of selected relevant portion module 8120, which may be configured to present, e.g., display, the selected relevant portion (e.g., the claim text), in a default view, e.g., in order, with the various words split out, e.g., if the claim is “ABCDE,” then displaying five boxes “A” “B” “C” “D” and “E.” The boxes may be selectable and manipulable by the user 3005. This default view may be computationally generated to give the operator a baseline with which to work.

Referring again to FIG. 1W, in an embodiment, legal document lexical grouping implementation 8100 may include input from interaction with user interface accepting module 8130 that is configured to allow the user to manually group lexical units into their relevant portions. For example, the user 3005 may break the claim ABCDE into lexical groupings AE, BC, and D. These lexical groupings may be packaged into a data structure, e.g., data structure 5090 (e.g., as shown in FIG. 1X) that represents the breakdown into lexical units.

Referring now to FIG. 1X, in an embodiment, legal document lexical grouping implementation 8100 may include presentation of three-dimensional model module 8140 that is configured to present the relevant portions that are broken down into lexical units, with other portions of the document that are automatically generated. For example, the module 8140 may search the document for the lexical groups “AE” “BC” and “D” and try to make pairings of the document, e.g., the specification if it is a patent document.

Referring again to FIG. 1X, in an embodiment, legal document lexical grouping implementation 8100 may include input from interaction with a user interface module 8150 that is configured to, with user input, allow binding of each lexical unit to additional portions of the document (e.g., specification). For example, the user 3005 may attach portions of the specification that define the lexical units in the claim terms, to the claim terms.

Referring now to FIG. 1Y, in an embodiment, legal document lexical grouping implementation 8100 may include a generation module 8160 that is configured to generate a data structure (e.g., a relational database) that links the lexical units to their portion of the specification. Referring now to FIG. 1Y, data structure 5091 may represent the lexical units and their associations with various portions of the document, e.g., the specification, to which they have been associated by the user. In an embodiment, data sets 5090 and/or 5091 may be used as inputs into the similar works finding implementation 6500, which will be discussed in more detail herein.

Similar Works Comparison Implementation 6500

Referring now to FIG. 1AA, FIG. 1AA illustrates a similar works comparison implementation 6500 that is configured to receive a source document, analyze the source document, find similar documents to the source document, and then generate a mapping of portions of the source document onto the one or more similar documents. For example, in the legal context, similar works comparison implementation 6500 could take as input a patent, and find prior art, and then generate rough invalidity claim charts based on the found prior art. Similar works comparison implementation 6500 will be discussed in more detail herein.

Referring again to FIG. 1AA, in an embodiment, similar works finding module 6500 may include source document receiving module 6510 configured to receive a source document that is to be analyzed so that similar documents may be found. For example, source document receiving module 6510 may receive various source documents, e.g., as shown in FIG. 1Z, e.g., a student paper that was plagiarized, a research paper that uses non-original research, and a U.S. patent. In an embodiment, source document receiving module 6510 may include one or more of student paper receiving module 6512, research paper receiving module 6514, and patent or patent application receiving module 6516.

Referring again to FIG. 1AA, in an embodiment, similar works finding module 6500 may include document construction/deconstruction module 6520. Document construction/deconstruction module 6520 may first determine the key portions of the document (e.g., the claims, if it is a patent document), and then pair those key portions of the document into lexical units. In an embodiment, document construction/deconstruction module 6520 may receive the data structure 5090 or 5091 which represents a human-based grouping of the lexical units of the document (e.g., the claims of the patent document). For example, deconstruction receiving module 6526 of document construction/deconstruction module 6520 may receive data structure 5090 or 5091. In another embodiment, document construction/deconstruction module 6520 may include construction module 6522, which may use automation to attempt to construe the auto-identified lexical units of the relevant portions of the document (e.g., the claims), e.g., through the use of intrinsic evidence (e.g., the other portions of the document, e.g., the specification) or extrinsic evidence (e.g., one or more dictionaries, etc.).

Referring now to FIG. 1AB, in an embodiment, similar works finding module 6500 may include a corpus comparison module 6530. Corpus comparison module 6530 may receive data set 4130 from the semantic corpus analyzer 4100 shown in FIG. 1K, or may obtain a corpus of texts, e.g., all the patents in a database, or all the articles from an article repository, e.g., the ACM document repository. Corpus comparison module 6530 may include the corpus obtaining module 6532 that obtains the corpus 5040, either from an internal source or an external source. Corpus comparison module 6530 also may include corpus filtering module 6534, which may filter out portions of the corpus (e.g., for a patent prior art search, it may filter by date, or may filter out certain references). Corpus comparison module 6530 also may include filtered corpus comparing module 6536, which may compare the filtered corpus to the source document.

It is noted that corpus comparing module 6536 may incorporate portions of the document time shifting implementation 3300 or the document technology scope shifting implementation 3500 from FIGS. 1C and 1E, respectively, in order to have the documents align in time or scope level, so that a better search can be made. Although in an embodiment, corpus comparing module 6536 may do simple text searching, it is not limited to word comparison and definition comparison. Corpus comparing module 6536 may search based on advanced document analysis, e.g., structural analysis, similar mode of communication, synonym analysis (e.g., even if the words in two different documents do not map exactly, that does not stop the corpus comparing module 6536, which may, in an embodiment, analyze the structure of the document, and using synonym analysis and definitional word replacement, perform more complete searching and retrieving of documents).

Referring again to FIG. 1AB, corpus comparison module 6530 may generate selected document 5050A and selected document 5050B (two documents are shown here, but this is merely exemplary, and the number of selected documents may be greater than two or less than two), which may then be given to received document to selected document mapping module 6540. Received document to selected document mapping module 6540 may use lexical analysis of the source document and the selected documents 5050A and/or 5050B to generate a mapping of the elements of the one or more selected documents to the source document, even if the vocabularies do not match up. Referring to FIG. 1AC, in an embodiment, received document to selected document mapping module 6540 may generate a mapped document 5060 that shows the mappings from the source document to the one or more selected documents. In another embodiment, received document 6540 may be used to match a person's writing style and vocabulary, usage, etc., to particular famous writers, e.g., to generate a statement such as “your writing is most similar to Ernest Hemmingway,” e.g., as shown in FIG. 1AC.

Referring again to FIG. 1AB, received document to selected document mapping module 6540 may include an all-element mapping module 6542 for patent documents, a data/chart mapping module 6544 for research documents, and a style/structure mapping module 6546 for student paper documents. Any of these modules may be used to generate the mapped document 5060.

Document Assistance Implementation

Referring now to FIG. 2A, FIG. 2A illustrates an example environment 200 in which methods, systems, circuitry, articles of manufacture, and computer program products and architecture, in accordance with various embodiments, may be implemented by one or more devices 230. As will be discussed in more detail herein, device 230 may be implemented as any kind of device, e.g., a smart phone, regular phone, tablet device, computer, laptop, server, and the like. In an embodiment, e.g., as shown in FIG. 2A, document processing device 230 may be a device, e.g., a server, or a cloud-type implementation, that communicates with a client device 220. In another embodiment, e.g., as shown in FIG. 3B, document processing device 230 may be a device that directly interacts with a client/user.

Referring again to FIG. 2A, in an embodiment, a client (e.g., a user) may operate a client device 220. For example, the client may be operating a word processing application, or copying document files, or reading an ebook, or any operation that involves a document or similar file. The client may wish to operate the systems described herein, e.g., to change portions of the document through automation and based on a potential audience for the document. In an embodiment, the client may interact with the client device 220, which may send all or a portion of the document to a document processing device, e.g., document processing device 230, which will be described in more detail with respect to FIG. 2B. In an embodiment, the portion of the document may be transmitted through use of a communication network, e.g., communication network 240.

Referring again to FIG. 2A, in an embodiment, the document processing device 230 may modify the document, at least partially based on the data set 210 about the potential document audience, e.g., the potential document readership, e.g., which may be guessed at, deduced, inputted, programmed, or otherwise determined. This process also will be described in more detail herein with respect to document processing device 230.

Referring again to FIG. 2A, in an embodiment, the modified document may be sent back to the client device 220. The modified document may be sent in place of the original document, or it may be sent with a copy of the original document, or the modifications may be implemented through some known markup technique, e.g., the commercial product DeltaView or Microsoft Word's Track Changes.

Referring again to FIG. 2A, in various embodiments, the communication network 240 may include one or more of a local area network (LAN), a wide area network (WAN), a metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, and so forth. The communication networks 240 may be wired, wireless, or a combination of wired and wireless networks. It is noted that “communication network” as it is used in this application refers to one or more communication networks, which may or may not interact with each other.

Referring now to FIG. 2B, FIG. 2B shows a more detailed version of client device 220, according to an embodiment. Client device 220 may be any electronic device or combination of devices, which may be located together or spread across multiple devices and/or locations. Client device 220 may be a server device, or may be a user-level device, e.g., including, but not limited to, a cellular phone, a network phone, a smartphone, a tablet, a music player, a walkie-talkie, a radio, an augmented reality device (e.g., augmented reality glasses and/or headphones), wearable electronics, e.g., watches, belts, earphones, or “smart” clothing, earphones, headphones, audio/visual equipment, media player, television, projection screen, flat screen, monitor, clock, appliance (e.g., microwave, convection oven, stove, refrigerator, freezer), a navigation system (e.g., a Global Positioning System (“GPS”) system), a medical alert device, a remote control, a peripheral, an electronic safe, an electronic lock, an electronic security system, a video camera, a personal video recorder, a personal audio recorder, and the like.

Referring again to FIG. 2B, client device 220 may include a device memory 245. In an embodiment, device memory 245 may include memory, random access memory (“RAM”), read only memory (“ROM”), flash memory, hard drives, disk-based media, disc-based media, magnetic storage, optical storage, volatile memory, nonvolatile memory, and any combination thereof. In an embodiment, device memory 245 may be separated from the device, e.g., available on a different device on a network, or over the air. For example, in a networked system, there may be many client devices 220 whose device memory 245 is located at a central server that may be a few feet away or located across an ocean. In an embodiment, device memory 245 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In an embodiment, memory 245 may be located at a single network site. In an embodiment, memory 245 may be located at multiple network sites, including sites that are distant from each other.

In an embodiment, e.g., as shown in FIG. 3B, client device 220 may interact directly with a client. In such an embodiment, referring again to FIG. 2B, client device 220 may transmit data to a client interface component 237 of a document processing device 230 (e.g., 230B, e.g., as shown in FIG. 3B), which may receive the client data, although this is not required, because, in an embodiment, client device 220 may handle all of the processing, and document processing device 230 may be eliminated.

Referring again to FIG. 2B, FIG. 2B shows a more detailed description of client device 220. In an embodiment, client device 220 may include a processor 222. Processor 222 may include one or more microprocessors, Central Processing Units (“CPU”), a Graphics Processing Units (“GPU”), Physics Processing Units, Digital Signal Processors, Network Processors, Floating Point Processors, and the like. In an embodiment, processor 222 may be a server. In an embodiment, processor 222 may be a distributed-core processor. Although processor 222 is as a single processor that is part of a single client device 220, processor 222 may be multiple processors distributed over one or many client device 220, which may or may not be configured to operate together.

Processor 222 is illustrated as being configured to execute computer readable instructions in order to execute one or more operations described above, and as illustrated in FIGS. 7, 8A-8D, 9A-9D, and 10A-10G. In an embodiment, processor 222 is designed to be configured to operate as processing module 250, which may include one or more of a document that includes at least one particular lexical unit submission accepting module 252, an acquisition of document adaptation data that includes data configured to be used to adapt the particular document facilitating module 254, and an adapted document in which at least a portion of at least one occurrence of the at least one particular lexical unit has been replaced with at least a portion of an acquired replacement lexical unit that is at least partly based on the document adaptation data obtaining module 256.

Referring now to FIG. 3A, FIG. 3A shows an exemplary embodiment of a client device 220A operating in another exemplary environment, e.g., environment 300A. In an embodiment, document processing device 230A may operate similarly to document processing device 230, except that, instead of generating a single document, many documents may be generated, with each being changed a different amount, including “none” and “entire document changed.” The amount of change applied to each document may be controlled by fuzzer factors 215, which may, in an embodiment, be based on how much the previous document was modified. For example, in an embodiment, the first new document generated may have a 5% modification, and the fuzzer may double that, so the next document generated may have a 10% modification, and the subsequent document may have a 20% modification. This is a simple example meant for exemplary purposes, and any other factors, linear or nonlinear, applied or random, and determinative or nondeterminative, may be used to implement the fuzzer. In an embodiment, the fuzzer may use human feedback to determine the next amount of fuzzing to do on the document, for example, the fuzzer may generate a first document, then receive human feedback to “change less,” and the fuzzer factor will be changed accordingly.

Referring now to FIG. 3B, FIG. 3B shows an exemplary embodiment of a client device 220B and a document processing device 230B operating in another exemplary environment, e.g., environment 300B. For example, in an embodiment, document processing device 230B may be resident on a computing device as part of a word processor, or as part of a separate application on a phone device, or the like. In another embodiment, document processing device 230B may be operated on a computer through a web browser interface, e.g., as a java applet or as an HTML 5 application.

Referring now to FIG. 3C, FIG. 3C shows an exemplary embodiment of a client device 220C and a document processing device 230C in environment 300C. For example, in an embodiment, client device 220C may accept the submission of a document, and facilitate the acquisition of document modification data. In an embodiment, the document modification data may include a target time period that the submitted document is to be shifted to. This may be accomplished, e.g., through a user interface with a sliding scale for the year. In an embodiment, the document modification data and the submitted document may be transmitted to client device interface component 237, which may receive the submitted document and the document modification data. Then, coupled with the time-shifting data 210C, the submitted document may be outputted as a time-shifted document in which one or more words of the document have been time-shifted from one time period to another, through use of automation. This process will be described in more detail in the context of specific examples herein. In an embodiment, document processing device 230C may be part of client device 220C.

Referring now to FIG. 3D FIG. 3D shows an exemplary embodiment of a client device 220D and a document processing device 230D in an environment 300D. For example, in an embodiment, client device 220D may accept the submission of a document, and facilitate the acquisition of document modification data. In an embodiment, the document modification data may include a target level of abstraction that the submitted document is to be shifted to. This may be accomplished, e.g., through a user interface with a sliding scale for the level of abstraction. In an embodiment, the document modification data and the submitted document may be transmitted to client device interface component 237, which may receive the submitted document and the document modification data. Then, coupled with the abstraction level-shifting data 210D, the submitted document may be outputted as an abstraction level-shifted document in which one or more words of the document have been changed from one level of abstraction to another, through use of automation. This process will be described in more detail in the context of specific examples herein. In an embodiment, document processing device 230D may be part of client device 220D.

FIGS. 4-6 illustrate exemplary embodiments of the various modules that form portions of processor 250. In an embodiment, the modules represent hardware, either that is hard-coded, e.g., as in an application-specific integrated circuit (“ASIC”) or that is physically reconfigured through gate activation described by computer instructions, e.g., as in a central processing unit.

Referring now to FIG. 4, FIG. 4 illustrates an exemplary implementation of the document that includes at least one particular lexical unit submission accepting module 252. As illustrated in FIG. 4, the document that includes at least one particular lexical unit submission accepting module may include one or more sub-logic modules in various alternative implementations and embodiments. For example, as shown in FIG. 4, e.g., FIG. 4A, in an embodiment, module 252 may include one or more of particular document that includes at least one particular lexical unit submission receiving module 402, indication of interaction with a client interface that is configured to indicate submission of the particular document receiving module 406, and legal document that includes at least one particular lexical unit submission accepting module 410. In an embodiment, module 402 may include particular document that includes at least one particular lexical unit submission receiving from a client module 404. In an embodiment, module 406 may include indication of interaction with a button of a word processor that is configured to indicate submission of the particular document receiving module 408. In an embodiment, module 410 may include legal document that includes at least one particular lexical unit that is a legal citation submission accepting module 412.

Referring again to FIG. 4, e.g., FIG. 4B, in an embodiment, module 252 may include one or more patent document that includes at least one particular lexical unit submission accepting module 414, fictional document that includes at least one particular lexical unit submission accepting module 418, particular document that includes at least one particular lexical unit that has one or more particular types submission accepting module 420, and particular document that includes at least one particular lexical unit that includes one or more particular types submission accepting module 422. In an embodiment, module 414 may include patent document that includes at least one particular technological phrase submission accepting module 416.

Referring again to FIG. 4, e.g., FIG. 4C, in an embodiment, module 252 may include one or more of particular document that includes at least one particular lexical unit that appears a particular number of times in the particular document submission accepting module 424, particular document that includes at least one particular lexical unit that is determined to be written at a particular grade level in the particular document submission accepting module 426, and particular document that includes at least one particular lexical unit that includes one or more words that have a particular characteristic in the particular document submission accepting module 428. In an embodiment, module 428 may include one or more of particular document that includes at least one particular lexical unit that includes one or more words that form a particular passive verb clause submission accepting module 430, particular document that includes at least one particular lexical unit that includes one or more words that are repeated a particular number of times within a particular portion of the particular document submission accepting module 432, and particular document that includes at least one particular lexical unit that includes one or more words that include a recognized colloquialism associated with a particular readership submission accepting module 434.

Referring again to FIG. 4, e.g., FIG. 4D, in an embodiment, module 252 may include one or more of particular document submission receiving module 436, lexical unit property data that describes at least one property of the at least one particular lexical unit acquiring module 438, at least one particular lexical unit identifying in the particular document module 440, particular document that includes the at least one particular lexical unit submission receiving module 442, and at least one particular lexical unit identifying in the particular document at least partly based on a potential document audience data for the acquired document module 444.

Referring now to FIG. 5, FIG. 5 illustrates an exemplary implementation of acquisition of document adaptation data that includes data configured to be used to adapt the particular document facilitating module 254. As illustrated in FIG. 5, the acquisition of document adaptation data that includes data configured to be used to adapt the particular document facilitating module 254 may include one or more sub-logic modules in various alternative implementations and embodiments. For example, as shown in FIG. 5, e.g., FIG. 5A, in an embodiment, module 254 may include one or more of document adaptation data that includes data configured to be used to adapt the particular document acquiring module 502, document adaptation data that includes data that describes an adaptation to be applied to particular document acquiring module 504, and document adaptation data that includes data that describes an adaptation to be applied to particular document obtaining module 506.

Referring again to FIG. 5, e.g., FIG. 5B, in an embodiment, module 254 may include acquisition of document adaptation data that includes data that regards a potential audience for the particular document facilitating module 508. In an embodiment, module 508 may include one or more of acquisition of document adaptation data that includes data that regards a likely demographic profile for the audience for the particular document facilitating module 510 and acquisition of document adaptation data that includes data includes a list of one or more members of the potential audience for the particular document facilitating module 514. In an embodiment, module 510 may include acquisition of document adaptation data that includes data that describes a property of one or more members of the potential audience for the particular document facilitating module 512. In an embodiment, module 514 may include acquisition of document adaptation data that includes data includes a list of one or more members of the potential audience designated for evaluation of the particular document facilitating module 516. In an embodiment, module 516 may include one or more of acquisition of document adaptation data that includes data includes a list of one or more judges designated to decide an outcome of an event at least partially based on the particular document facilitating module 518 and acquisition of document adaptation data that includes data includes a list of one or more critics designated to assign an evaluation to the particular document facilitating module 520.

Referring again to FIG. 5, e.g., FIG. 5C, in an embodiment, module 254 may include one or more of inputted document adaptation data that includes data configured to be used to adapt the particular document receiving module 522, received inputted document adaptation data that includes data configured to be used to adapt the particular document transmitting to a document adaptation entity module 524, acquisition of time period data that includes a target time period for an adaptation of the particular document facilitating module 526, and acquisition of time period data that includes a source time period for the particular document facilitating module 530. In an embodiment, module 526 may include user interface that allows input of time period data that includes a target time period for an adaptation of the particular document presentation facilitating module 528. In an embodiment, module 530 may include one or more of time period data that includes a source time period for the particular document obtaining through analysis of submission time of the particular document module 532 and user interface that allows input of time period data that includes a source time period for an adaptation of the particular document presentation facilitating module 534.

Referring again to FIG. 5, e.g., FIG. 5D, in an embodiment, module 254 may include one or more of acquisition of level data that includes data that indicates a target level of technological abstraction for the particular document facilitating module 536 and acquisition of level data that includes data that indicates a source level of technological abstraction for the particular document facilitating module 540. In an embodiment, module 536 may include user interface that allows input of the target level of technological abstraction for the particular document presentation facilitating module 538. In an embodiment, module 540 may include level data that includes data that indicates a source level of technological abstraction for the particular document acquiring through analysis of one or more document lexical units module 542.

Referring now to FIG. 6, FIG. 6 illustrates an exemplary implementation of adapted document in which at least a portion of at least one occurrence of the at least one particular lexical unit has been replaced with at least a portion of an acquired replacement lexical unit that is at least partly based on the document adaptation data obtaining module 256. As illustrated in FIG. 6A, the adapted document in which at least a portion of at least one occurrence of the at least one particular lexical unit has been replaced with at least a portion of an acquired replacement lexical unit that is at least partly based on the document adaptation data obtaining module 256 may include one or more sub-logic modules in various alternative implementations and embodiments. For example, as shown in FIG. 6, e.g., FIG. 6A, in an embodiment, module 256 may include adapted document in which at least a portion of at least one occurrence of the at least one particular lexical unit has been replaced with at least a portion of an acquired replacement lexical unit that is at least partly based on the document adaptation data and that is related to the particular lexical unit obtaining module 602. In an embodiment, module 602 may include one or more of adapted document in which at least a portion of at least one occurrence of the at least one particular lexical unit has been replaced with at least a portion of an acquired replacement lexical unit that is at least partly based on the document adaptation data and that is represents a shift in time period from the particular lexical unit obtaining module 604 and adapted document in which at least a portion of at least one occurrence of the at least one particular lexical unit has been replaced with at least a portion of an acquired replacement lexical unit that is at least partly based on the document adaptation data and that is represents a shift in technological level of abstraction from the particular lexical unit obtaining module 606.

Referring again to FIG. 6, e.g., FIG. 6B, in an embodiment, module 256 may include one or more of adapted document in which at least a portion of at least one occurrence of the at least one particular lexical unit has been replaced with at least a portion of an acquired replacement lexical unit that is at least partly based on the document adaptation data that includes potential readership data obtaining module 608 and adapted document in which at least a portion of at least one occurrence of the at least one particular lexical unit has been replaced with at least a portion of an acquired replacement lexical unit that is at least partly based on the document adaptation data and is a similar one or more words as the particular lexical unit obtaining module 612. In an embodiment, module 608 may include adapted document in which at least a portion of at least one occurrence of the at least one particular lexical unit has been replaced with at least a portion of an acquired replacement lexical unit that is at least partly based on one or more preferences expressed in the potential readership data obtaining module 610. In an embodiment, module 612 may include adapted document in which at least a portion of at least one occurrence of the at least one particular lexical unit has been replaced with at least a portion of an acquired replacement lexical unit that is at least partly based on the document adaptation data and is a replacement from a target time period of one or more words of the particular lexical unit obtaining module 614. In an embodiment, module 614 may include adapted document in which at least a portion of at least one occurrence of the at least one particular lexical unit has been replaced with at least a portion of an acquired replacement lexical unit that is at least partly based on the document adaptation data and is one or more synonym words from a target time period of one or more words of the particular lexical unit obtaining module 616.

Referring again to FIG. 6, e.g., FIG. 6C, in an embodiment, module 256 may include one or more of adapted document in which at least a portion of at least one occurrence of the at least one particular lexical unit has been replaced with at least a portion of an acquired replacement lexical unit that is at least partly based on the document adaptation data and includes a similar one or more words used in a particular time period to the particular lexical unit that did not have a same meaning in the particular time period as in a current time period obtaining module 618, adapted document in which at least a portion of at least one occurrence of the at least one particular lexical unit has been replaced with at least a portion of an acquired replacement lexical unit that is at least partly based on the document adaptation data and includes a similar one or more words used in a particular time period to the particular lexical unit that was not in use in the particular time period obtaining module 620, adapted document in which at least a portion of at least one occurrence of the at least one particular lexical unit has been replaced with at least a portion of an acquired replacement lexical unit that is at least partly based on the document adaptation data and includes the particular lexical unit expressed in a vocabulary associated with a particular time period obtaining module 622, and adapted document in which at least a portion of at least one occurrence of the at least one particular lexical unit has been replaced with at least a portion of an acquired replacement lexical unit that is at least partly based on the document adaptation data and includes a similar one or more words used in a particular time period to the particular lexical unit that had a different meaning in the particular time period than in a current time period obtaining module 624.

Referring again to FIG. 6, e.g., FIG. 6D, in an embodiment, module 256 may include one or more of adapted document in which at least a portion of at least one occurrence of the at least one particular lexical unit has been replaced with at least a portion of an acquired replacement lexical unit that is at least partly based on the document adaptation data and includes a similar one or more words used in a particular time period to the particular lexical unit that was not in common use in the particular time period obtaining module 626 and adapted document in which at least a portion of at least one occurrence of the at least one particular lexical unit has been replaced with at least a portion of an acquired replacement lexical unit that is at least partly based on the document adaptation data receiving from a location of acquisition of the replacement lexical unit module 628. In an embodiment, module 628 may include one or more of adapted document in which at least a portion of at least one occurrence of the at least one particular lexical unit has been replaced with at least a portion of an acquired replacement lexical unit that is at least partly based on the document adaptation data receiving from a location of acquisition of the replacement lexical unit that is at least partly based on potential readership data module 630, adapted document in which at least a portion of at least one occurrence of the at least one particular lexical unit has been replaced with at least a portion of an acquired replacement lexical unit that is at least partly based on the document adaptation data receiving from a location of acquisition of the replacement lexical unit that is at least partly based on a time-period based dictionary module 632, and adapted document in which at least a portion of at least one occurrence of the at least one particular lexical unit has been replaced with at least a portion of an acquired replacement lexical unit that is at least partly based on the document adaptation data receiving from a location of acquisition of the replacement lexical unit that is at least partly based on one or more technical specifications module 634.

Referring again to FIG. 6, e.g., FIG. 6E, in an embodiment, module 256 may include module 628, as previously described. In an embodiment, module 628 may include adapted document in which at least a portion of at least one occurrence of the at least one particular lexical unit has been replaced with at least a portion of an acquired replacement lexical unit that is at least partly based on the document adaptation data receiving from a location of acquisition of the replacement lexical unit that is at least partly acquired through use of one or more tools for altering a technical level of abstraction module.

Referring again to FIG. 6, e.g., FIG. 6F, in an embodiment, module 256 may include adapted document in which at least a portion of at least one occurrence of the at least one particular lexical unit has been replaced with at least a portion of an acquired replacement lexical unit that is at least partly based on the document adaptation data and that includes one or more words related to the particular lexical unit obtaining module 638. In an embodiment, module 638 may include one or more of adapted document in which at least a portion of at least one occurrence of the at least one particular lexical unit has been replaced with at least a portion of an acquired replacement lexical unit that is at least partly based on the document adaptation data and that includes one or more words that represent a different level of technological abstraction than the particular lexical unit obtaining module 640, adapted document in which at least a portion of at least one occurrence of the at least one particular lexical unit has been replaced with at least a portion of an acquired replacement lexical unit that is at least partly based on the document adaptation data and that includes one or more words that express a level of technological abstraction using different words than the particular lexical unit obtaining module 642, adapted document in which at least a portion of at least one occurrence of the at least one particular lexical unit has been replaced with at least a portion of an acquired replacement lexical unit that is at least partly based on the document adaptation data and that includes one or more words that express a level of technological abstraction using words generated by a computerized analysis of the particular lexical unit obtaining module 644, and adapted document in which at least a portion of at least one occurrence of the at least one particular lexical unit has been replaced with at least a portion of an acquired replacement lexical unit that is at least partly based on the document adaptation data and that includes one or more words that express a level of technological abstraction using words selected through use of one or more dictionaries that include the particular lexical unit obtaining module 646.

Referring again to FIG. 6, e.g., FIG. 6G, in an embodiment, module 256 may include adapted document in which at least a portion of at least one occurrence of the at least one particular lexical unit has been replaced with at least a portion of an acquired replacement lexical unit that is selected at least partly based on prior analysis of one or more existing documents obtaining module 648. In an embodiment, module 648 may include adapted document in which at least a portion of at least one occurrence of the at least one particular lexical unit has been replaced with at least a portion of an acquired replacement lexical unit that is selected at least partly based on prior analysis of one or more existing documents that have a common property obtaining module 650. In an embodiment, module 650 may include one or more of adapted document in which at least a portion of at least one occurrence of the at least one particular lexical unit has been replaced with at least a portion of an acquired replacement lexical unit that is selected at least partly based on prior analysis of one or more existing documents that were authored for a common readership obtaining module 652, adapted document in which at least a portion of at least one occurrence of the at least one particular lexical unit has been replaced with at least a portion of an acquired replacement lexical unit that is selected at least partly based on prior analysis of one or more existing documents that resulted in a particular measurable event outcome obtaining module 654, and adapted document in which at least a portion of at least one occurrence of the at least one particular lexical unit has been replaced with at least a portion of an acquired replacement lexical unit that is selected at least partly based on prior analysis of one or more existing documents that have a common property with the particular document obtaining module 656. In an embodiment, module 656 may include adapted document in which at least a portion of at least one occurrence of the at least one particular lexical unit has been replaced with at least a portion of an acquired replacement lexical unit that is selected at least partly based on prior analysis of one or more existing documents that were authored for a common readership with the particular document obtaining module 658.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 7 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 8 as well as the other operations to be described herein may be performed by at least one of a machine, an article of manufacture, or a composition of matter.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

Referring now to FIG. 7, FIG. 7 shows operation 700, e.g., an example operation of document processing device 230 operating in an environment 200. In an embodiment, operation 700 may include operation 702 depicting accepting a submission of a particular document that includes at least one particular lexical unit. For example, FIG. 2, e.g., FIG. 2B, shows document that includes at least one particular lexical unit submission accepting module 252 accepting (e.g., obtaining, acquiring, calculating, selecting from a list or other data structure, retrieving, receiving information regarding, performing calculations to find out, retrieving data that indicates, receiving notification, receiving information that leads to an inference, whether by human or automated process, or being party to any action or transaction that results in informing, inferring, or deducting, including but not limited to circumstances without absolute certainty, including more-likely-than-not and/or other thresholds) a submission (e.g., through typing the document, uploading it, clicking on a button, or some other action, a user that is interacting with the system submits the document or a portion of the document as a submission) of a particular document (e.g., any representation of words and/or concepts that are linked together in any fashion, whether cogent, readable, or comprehensible, or not) that includes (e.g., that is composed at least partly of) at least one particular lexical unit (e.g., one or more, e.g., various, not necessarily all the same, of a word, set of words, phrase, sentence, paragraph, concept, heading, citation, colloquialism, exclamation, part of speech, etc.).

Referring again to FIG. 7, operation 700 may include operation 704 depicting facilitating acquisition of document modification data that includes data configured to be used to determine a modification to the particular document. For example, FIG. 2, e.g., FIG. 2B, shows acquisition of document adaptation data that includes data configured to be used to adapt the particular document facilitating module 254 facilitating (e.g., taking one or more steps to assist in the furtherance of, whether successful or not, including actions that record steps or create other steps, and actions that ultimately result in an unintended result) acquisition of (e.g., obtaining, receiving, calculating, selecting from a list or other data structure, retrieving, receiving information regarding, performing calculations to find out, retrieving data that indicates, receiving notification, receiving information that leads to an inference, whether by human or automated process, or being party to any action or transaction that results in informing, inferring, or deducting, including but not limited to circumstances without absolute certainty, including more-likely-than-not and/or other thresholds) document modification data (e.g., data that may describe how to modify the document, or data that may be used to determine how to modify the document, which may be inputted by a user, determined from the document itself, determined by a computer that receives the document, etc.) that includes data configured to be used (e.g., data that is capable of being used, e.g., as is, or after performance of one or more modifications, by a human or by automation inclusively) to determine a modification (e.g., a change to one or more properties, words, sections, styles, etc., whether visible or invisible) to the particular document (e.g., any representation of words and/or concepts that are linked together in any fashion, whether cogent, readable, or comprehensible, or not)

Referring again to FIG. 7, operation 700 may include operation 706 depicting receiving an updated document in which at least a portion of at least one occurrence of the at least one particular lexical unit has been replaced with at least a portion of an acquired replacement lexical unit that is at least partly based on the document modification data. For example, FIG. 2, e.g., FIG. 2B, shows adapted document in which at least a portion of at least one occurrence of the at least one particular lexical unit has been replaced with at least a portion of an acquired replacement lexical unit that is at least partly based on the document adaptation data obtaining module 256 receiving an updated document (e.g., a document to which at least one modification has been applied, regardless of whether the modification was successful in changing the document or whether the modification is visible) in which at least a portion of at least one occurrence of the particular lexical unit (e.g., one or more, e.g., various, not necessarily all the same, of a word, set of words, phrase, sentence, paragraph, concept, heading, citation, colloquialism, exclamation, part of speech, etc.) has been replaced with at least a portion of an acquired replacement lexical unit (e.g., the one or more of a word, set of words, phrase, sentence, paragraph, concept, heading, citation, colloquialism, exclamation, part of speech, etc., that will be used to replace all or a portion of the particular lexical unit, including the null or empty set (e.g., a deletion)) that is at least partly based on the document modification data (e.g., directly, e.g., the acquired document modification data may include the replacement lexical unit, or indirectly, e.g., the acquired document modification data gives guidance on the selection of the replacement lexical unit, or as it relates to the particular lexical unit, e.g., by identifying particular lexical units to be replaced, whether exact or suggested, or, the document modification data is used to determine one or more of the particular lexical unit and the replacement lexical unit, e.g., the document modification data may be audience data for the document, or a target time period or level of abstraction for the document).

FIGS. 8A-8D depict various implementations of operation 702, depicting accepting a submission of a particular document that includes at least one particular lexical unit according to embodiments. Referring now to FIG. 8A, operation 702 may include operation 802 depicting receiving the submission of the particular document that includes at least one particular lexical unit. For example, FIG. 4, e.g., FIG. 4A shows particular document that includes at least one particular lexical unit submission receiving module 402 receiving the submission (e.g., through typing the document, uploading it, clicking on a button, or some other action, a user that is interacting with the system submits the document or a portion of the document as a submission)

Referring again to FIG. 8A, operation 802 may include operation 804 depicting receiving, from a client, the submission of the particular document that includes the at least one particular lexical unit. For example, FIG. 4, e.g., FIG. 4A, shows particular document that includes at least one particular lexical unit submission receiving from a client module 404 receiving, from a client (e.g., the person or other entity that is operating the system), the submission (e.g., either through typing the document, uploading it, clicking on a button, or some other action, a user that is interacting with the system submits the document or a portion of the document as a submission) of the particular document that includes the at least one particular lexical unit (e.g., a phrase, e.g., “she sputtered”).

Referring again to FIG. 8A, operation 702 may include operation 806 depicting receiving an indication that a portion of a user interface was interacted with, said portion of the user interface configured to indicate submission of the particular document that includes the at least one particular lexical unit. For example, FIG. 4, e.g., FIG. 4A, shows indication of interaction with a client interface that is configured to indicate submission of the particular document receiving module 406 receiving an indication that a portion of a user interface (e.g., a program was executed by clicking on the icon or dragging the document over a particular area) was interacted with, said portion of the user interface (e.g., a display on a touchscreen or other screen) configured to indicate submission of the particular document (e.g., a fictional document) that includes the at least one particular lexical unit passive verb clause (e.g., a clause that uses a verb in the “to be” form, which is criticized in some forms of writing (e.g., creative writing)).

Referring again to FIG. 8A, operation 806 may include operation 808 depicting receiving the indication that a button of a word processor was selected, said button of the word processor configured to indicate the submission of the particular document that is open in the word processor and that includes the at least one particular lexical unit. For example, FIG. 4, e.g., FIG. 4A, shows indication of interaction with a button of a word processor that is configured to indicate submission of the particular document receiving module 408 receiving the indication that a button of a word processor (e.g., Microsoft's Word, or Corel's WordPerfect) was selected, said button of the word processor configured to indicate the submission of the particular document that is open in the word processor and that includes the at least one particular lexical unit (e.g., the phrase “much and more”).

Referring again to FIG. 8A, operation 702 may include operation 810 depicting accepting the submission of a legal document that includes the at least one particular lexical unit. For example, FIG. 4, e.g., FIG. 4A, shows legal document that includes at least one particular lexical unit submission accepting module 410 accepting the submission of a legal document (e.g., a brief, a memorandum, a judicial opinion, a transcript of an oral argument, a trial exhibit, an e-mail drafted to a client from an attorney, a legal scholarly article, a trade magazine article written by an attorney, and the like) that includes the at least one particular lexical unit (e.g., the word “heretofore”).

Referring again to FIG. 8A, operation 810 may include operation 812 depicting accepting the submission of the legal document that includes at least one particular legal citation. For example, FIG. 4, e.g., FIG. 4A, shows legal document that includes at least one particular lexical unit that is a legal citation submission accepting module 412 accepting the submission of the legal document e.g., a brief, a memorandum, a judicial opinion, a transcript of an oral argument, a trial exhibit, an e-mail drafted to a client from an attorney, a legal scholarly article, a trade magazine article written by an attorney, and the like) that includes at least one particular legal citation at least one particular legal citation (e.g., a citation to some legal authority, e.g., a case, a statute, a regulation, etc.).

Referring now to FIG. 8B, operation 702 may include operation 814 depicting accepting the submission of a patent document that includes the at least one particular lexical unit. For example, FIG. 4, e.g., FIG. 4B, shows patent document that includes at least one particular lexical unit submission accepting module 414 accepting the submission of a patent document (e.g., a patent application, a response to an office action, a document to be submitted before the patent office, or a legal document in a patent proceeding) that includes the at least one particular lexical unit (e.g., a single word, e.g., the word “invention”).

Referring again to FIG. 8B, operation 814 may include operation 816 depicting accepting the submission of the patent document that includes a particular technological phrase. For example, FIG. 4, e.g., FIG. 4B, shows patent document that includes at least one particular technological phrase submission accepting module 416 accepting the submission of the patent document (e.g., a patent application) that includes a particular technological phrase (e.g., a “personal digital assistant” or a “series of RS and D flip-flops”).

Referring again to FIG. 8B, operation 702 may include operation 818 depicting accepting the submission of a fictional document that includes the at least one particular lexical unit. For example, FIG. 4, e.g., FIG. 4B, shows fictional document that includes at least one particular lexical unit submission accepting module 418 accepting the submission of a fictional document (e.g., an alternate historical fiction document) that includes the at least one particular lexical unit (e.g., a word, e.g., the word “Nazi”).

Referring again to FIG. 8B, operation 702 may include operation 820 depicting accepting the submission of the particular document that includes the at least one particular lexical unit, wherein the particular lexical unit is one or more of a word, a collection of words, a phrase, a sentence, and a paragraph. For example, FIG. 4, e.g., FIG. 4B, shows particular document that includes at least one particular lexical unit that has one or more particular types submission accepting module 420 accepting the submission of the particular document (e.g., a term paper written for a graduate-level class) that includes that includes the at least one particular lexical unit, wherein the particular lexical unit is one or more of a word, a collection of words, a phrase, a sentence, and a paragraph.

Referring again to FIG. 8B, operation 702 may include operation 822 depicting accepting the submission of the particular document that includes the at least one particular lexical unit, wherein the particular lexical unit includes one or more of a word lexical unit, a word collection lexical unit, a phrase lexical unit, a sentence lexical unit, and a paragraph lexical unit. For example, FIG. 4, e.g., FIG. 4B, shows particular document that includes at least one particular lexical unit that includes one or more particular types submission accepting module 422 accepting the submission of the particular document (e.g., a science fiction novella) that includes the at least one particular lexical unit, wherein the particular lexical unit includes one or more of a word lexical unit, a word collection lexical unit, a phrase lexical unit, a sentence lexical unit, and a paragraph lexical unit.

Referring now to FIG. 8C, operation 702 may include operation 824 depicting accepting the submission of the particular document that includes the at least one particular lexical unit, wherein the particular lexical unit is defined as a lexical unit that appears in the particular document more than a particular number of times. For example, FIG. 4, e.g., FIG. 4C, shows particular document that includes at least one particular lexical unit that appears a particular number of times in the particular document submission accepting module 424 accepting the submission of the particular document (e.g., a fictional short story) that includes at least one particular lexical unit (e.g., a phrase, as detailed herein), wherein the at least one particular lexical unit is defined as a lexical unit that appears in the particular document more than a particular number of times (e.g., a well-known fantasy author uses the phrase “words are wind” many times, and that would be detected by the system).

Referring again to FIG. 8C, operation 702 may include operation 826 depicting accepting the submission of the particular document that includes the at least one particular lexical unit, wherein the particular lexical unit is a set of one or more words that are determined to be written at a particular grade level. For example, FIG. 4, e.g., FIG. 4C, shows particular document that includes at least one particular lexical unit that is determined to be written at a particular grade level in the particular document submission accepting module 426 accepting the submission of the particular document (e.g., a blog post on a well-known blog) that includes the at least one particular lexical unit, wherein the particular lexical unit is a set of one or more words that are determined to be written at a particular grade level (e.g., as automatically scored, e.g., using the Flesch-Kincaid Grade Level test).

Referring again to FIG. 8C, operation 702 may include operation 828 depicting accepting the submission of the particular document that includes the at least one particular lexical unit, wherein the particular lexical unit is one or more words that have a particular characteristic. For example, FIG. 4, e.g., FIG. 4C, shows particular document that includes at least one particular lexical unit that includes one or more words that have a particular characteristic in the particular document submission accepting module 428 accepting the submission of the particular document that includes the at least one particular lexical unit, wherein the particular lexical unit is one or more words that have a particular characteristic (e.g., a particular level of technical detail (e.g., software code, hardware schematics, gate array design, etc.).

Referring again to FIG. 8C, operation 828 may include operation 830 depicting accepting the submission of the particular document that includes the at least one particular lexical unit, wherein the particular lexical unit is a passive verb clause. For example, FIG. 4, e.g., FIG. 4C, shows particular document that includes at least one particular lexical unit that includes one or more words that form a particular passive verb clause submission accepting module 430 accepting the submission (e.g., the document file is copied to the computer) of the particular document (e.g., a short story for entry in a contest) that includes the at least one particular lexical unit, wherein the particular lexical unit is a passive verb clause.

Referring again to FIG. 8C, operation 828 may include operation 832 depicting accepting the submission of the particular document that includes the at least one particular lexical unit, wherein the particular lexical unit is a phrase that is repeated a particular number of times in a particular proximity. For example, FIG. 4, e.g., FIG. 4C, shows particular document that includes at least one particular lexical unit that includes one or more words that are repeated a particular number of times within a particular portion of the particular document submission accepting module 432 accepting the submission of the particular document (e.g., a fictional short story) that includes at least one particular lexical unit (e.g., a phrase, as detailed herein), wherein the particular lexical unit is a phrase that is repeated a particular number of times in a particular proximity (e.g., a well-known fantasy author uses the phrase “much and more” three times in the same paragraph, and that would be detected by the system).

Referring again to FIG. 8C, operation 828 may include operation 834 depicting accepting the submission of the particular document that includes the at least one particular lexical unit, wherein the particular lexical unit is recognized as a colloquialism associated with a particular readership. For example, FIG. 4, e.g., FIG. 4C, shows particular document that includes at least one particular lexical unit that includes one or more words that include a recognized colloquialism associated with a particular readership submission accepting module 434 accepting the submission (e.g., the document is submitted automatically when the user hits “save”) of the particular document (e.g., a text of a political speech) that includes at least one particular lexical unit (e.g., a phrase), wherein the at least one particular lexical unit is recognized as a colloquialism (e.g., “gun nuts”) associated with a particular readership (e.g., a certain audience may be predisposed to like or dislike such a characterization/colloquialism).

Referring now to FIG. 8D, operation 702 may include operation 836 depicting receiving the submission of the particular document. For example, FIG. 4, e.g., FIG. 4D, shows particular document submission receiving module 436 receiving the submission of the particular document (e.g., a legal document).

Referring again to FIG. 8D, operation 702 may include operation 838, which may appear in conjunction with operation 836, operation 838 depicting receiving data that defines one or more characteristics of the at least one particular lexical unit. For example, FIG. 4, e.g., FIG. 4D, shows lexical unit property data that describes at least one property of the at least one particular lexical unit acquiring module 438 receiving data that defines one or more characteristics of the at least one particular lexical unit (e.g., a citation to a case in the Ninth Circuit Court of Appeals, e.g., may be forbidden because this is a court that doesn't like their cases, which may be determined, e.g., by data about what sort of cases and legal theories the particular court likes and dislikes, that is derived from analysis of the briefs that were filed in winning cases to determine patterns and correlations, and thus, a citation, e.g., to a case in the Ninth Circuit Court of Appeals, may be identified as a particular lexical unit because this is a court that it is determined through analysis of the winning cases that 73% of briefs that cited cases in the Ninth Circuit Court of Appeals ended up losing, and 82% of the cases that did not cite cases in the Ninth Circuit Court of Appeals ended up winning).

Referring again to FIG. 8D, operation 702 may include operation 840, which may appear in conjunction with one or more of operation 836 and operation 838, operation 840 depicting identifying, in the particular document, the at least one particular lexical unit. For example, FIG. 4, e.g., FIG. 4D, shows at least one particular lexical unit identifying in the particular document module 440 identifying, in the particular document, the at least one particular lexical unit (e.g., the citations to the Ninth Circuit Court of Appeals).

Referring again to FIG. 8D, operation 702 may include operation 842 depicting receiving the submission of the particular document. For example, FIG. 4, e.g., FIG. 4D, shows particular document that includes the at least one particular lexical unit submission receiving module 442 receiving the submission of the particular document (e.g., a legal document).

Referring again to FIG. 8D, operation 702 may include operation 844, which may appear in conjunction with operation 842, operation 844 depicting identifying the at least one particular lexical unit in the particular document. For example, FIG. 4, e.g., FIG. 4D, shows at least one particular lexical unit identifying in the particular document at least partly based on a potential document audience data for the acquired document module 444 identifying the at least one particular lexical unit (e.g., the lexical unit is a paragraph, and the identification involves using automation to identify “redundant” paragraphs through analysis of which words appear in each paragraph and in what order, for example, if a paragraph uses 97% of the same words as a previous paragraph, and is 60% in the same structure as determined by a device traversing the paragraph, then the paragraph may be identified as a particular lexical unit for replacement/deletion) in the particular document.

FIGS. 9A-9D depict various implementations of operation 704, depicting facilitating acquisition of document modification data that includes data configured to be used to determine a modification to the particular document, according to embodiments. Referring now to FIG. 9A, operation 704 may include operation 902 depicting acquiring document modification data that includes data that describes a modification configured to be applied to the particular document. For example, FIG. 5, e.g., FIG. 5A, shows document adaptation data that includes data configured to be used to adapt the particular document acquiring module 502 acquiring document modification data (e.g., a time-shifting data that indicates the period to shift the document to) that includes data that describes a modification configured to be applied to the document (e.g., the user indicated that the target time period for the document is “1974,” and so the data describes the modification of the document, to be time-shifted to 1974 through use of various dictionaries to change out words and phrases, whether technological, colloquial, or other, as will be described in more detail herein).

Referring again to FIG. 9A, operation 704 may include operation 904 depicting receiving document modification data that includes data that describes a modification configured to be applied to the particular document. For example, FIG. 5, e.g., FIG. 5A, shows document adaptation data that includes data that describes an adaptation to be applied to particular document acquiring module 504 receiving (e.g., from the user) document modification data (e.g., the target audience of the document) that includes data that describes a modification (e.g., a modification of the citations to conform to the particular judges that are the likely audience of the document, as previously described) configured to be applied to the particular document (e.g., a legal document).

Referring again to FIG. 9A, operation 704 may include operation 906 depicting obtaining document modification data that includes data that describes a modification configured to be applied to the particular document. For example, FIG. 5, e.g., FIG. 5A, shows document adaptation data that includes data that describes an adaptation to be applied to particular document obtaining module 506 obtaining document modification data that describes a modification (e.g., a removal of passive voice verbs) configured to be applied to the particular document (e.g., a fictional document).

Referring now to FIG. 9B, operation 704 may include operation 908 depicting acquiring document modification data that identifies a target audience for the particular document. For example, FIG. 5, e.g., FIG. 5B, shows acquisition of document adaptation data that includes data that regards a potential audience for the particular document facilitating module 508 acquiring (e.g., determining, through a series of survey questions presented to the user) document modification data that identifies a target audience (e.g., “males 18-34,” or more or less specific) for the particular document (e.g., a fictional novel about Navy SEALs).

Referring again to FIG. 9B, operation 908 may include operation 910 depicting acquiring document modification data that describes a target demographic for the particular document. For example, FIG. 5, e.g., FIG. 5B, shows acquisition of document adaptation data that includes data that regards a likely demographic profile for the audience for the particular document facilitating module 510 acquiring (e.g., determining, through document analysis) document modification data that describes a target demographic for the particular document. In this example, machine processing of the document may be used to determine its audience by analyzing, e.g., proper nouns. For example, if the document contains references to “Miley Cyrus” and “Hannah Montana,” then, through use of machine-initiated internet searches and proper noun identification, the automation can determine that the target audience is females ages 12-20).

Referring again to FIG. 9B, operation 910 may include operation 912 depicting acquiring document modification data that describes a characteristic of one or more persons intended as the audience for the particular document. For example, FIG. 5, e.g., FIG. 5B, shows acquisition of document adaptation data that includes data that describes a property of one or more members of the potential audience for the particular document facilitating module 512 acquiring document modification data that describes a characteristic (e.g., an educational level, or a particular critical board or panel the person is part of) of one or more persons intended as the audience for the particular document (e.g., a scientific research paper).

Referring again to FIG. 9B, operation 908 may include operation 914 depicting acquiring document modification data that includes a list of one or more entities that are designated to read the particular document. For example, FIG. 5, e.g., FIG. 5B, shows acquisition of document adaptation data that includes data includes a list of one or more members of the potential audience for the particular document facilitating module 514 acquiring (e.g., retrieving from a server that provides legal docket data) document modification data that includes a list of one or more entities that are designated to read the particular document (e.g., a list of administrative judges on a panel for an administrative hearing that is based on a legal document).

Referring again to FIG. 9B, operation 914 may include operation 916 depicting acquiring document modification data that includes a list of one or more entities that are designated to substantively evaluate the particular document. For example, FIG. 5, e.g., FIG. 5B, shows acquisition of document adaptation data that includes data includes a list of one or more members of the potential audience designated for evaluation of the particular document facilitating module 516 acquiring (e.g., using prior data to estimate, e.g., using automated searches to find prior reviews of similar books, and the authors of those prior reviews) document modification data that includes a list of one or more entities (e.g., critics that work for known websites, journals, magazines, or papers) that are designated to substantively evaluate the particular document (e.g., a creative writing essay).

Referring again to FIG. 9B, operation 916 may include operation 918 depicting acquiring document modification data that includes a list of one or more judges that are designated to decide an outcome of an event at least partially based on the particular document. For example, FIG. 5, e.g., FIG. 5B, shows acquisition of document adaptation data that includes data includes a list of one or more judges designated to decide an outcome of an event at least partially based on the particular document facilitating module 518 acquiring document modification data that includes a list of one or more judges that are designated to decide an outcome of an event (e.g., a judicial hearing, e.g., a trial) at least partially based on the particular document (e.g., a legal brief on the merits).

Referring again to FIG. 9B, operation 916 may include operation 920 depicting acquiring document modification data that includes a list of one or more critics that are configured to define a score for the particular document. For example, FIG. 5, e.g., FIG. 5B, shows acquisition of document adaptation data that includes data includes a list of one or more critics designated to assign an evaluation to the particular document facilitating module 520 acquiring document modification data that includes a list of one or more critics that are configured to define a score for the particular document (e.g., a fictional novel).

Referring now to FIG. 9C, operation 704 may include operation 922 depicting receiving inputted document modification data that includes data configured to be used to determine the modification to the particular document. For example, FIG. 5, e.g., FIG. 5C, shows inputted document adaptation data that includes data configured to be used to adapt the particular document receiving module 522 receiving inputted document modification data that includes data configured to be used to determine the modification to the particular document (e.g., the data here could be anything from demographic info to a list of words that are disliked, to a specific time period to automatically shift the document to, or to a specific level of technological abstraction).

Referring again to FIG. 9C, operation 704 may include operation 924, which may appear in conjunction with operation 922, operation 924 depicting transmitting the received document modification data that includes data configured to be used to determine a modification to the particular document, to an entity configured to perform modification on the particular document. For example, FIG. 5, e.g., FIG. 5C, shows received inputted document adaptation data that includes data configured to be used to adapt the particular document transmitting to a document adaptation entity module 524 transmitting the received document modification data that includes data configured to be used to determine a modification to the particular document (e.g., a technical writeup) to an entity (e.g., a remote server under the control of a services provider, e.g., Google) configured to perform modification on the particular document (e.g., a technical writeup).

Referring again to FIG. 9C, operation 704 may include operation 926 depicting facilitating acquisition of time period data that includes data that indicates a target time period for the particular document. For example, FIG. 5, e.g., FIG. 5C, shows acquisition of time period data that includes a target time period for an adaptation of the particular document facilitating module 526 facilitating acquisition of time period data that includes a target time period (e.g., the 1970s) for the particular document (e.g., a patent document that was written in 1990, but for which the user wants to search art from the 1970s to find potentially invalidating art).

Referring again to FIG. 9C, operation 526 may include operation 928 depicting facilitating presentation of a user interface component configured to allow input of the target time period for the particular document. For example, FIG. 5, e.g., FIG. 5C, shows user interface that allows input of time period data that includes a target time period for an adaptation of the particular document presentation facilitating module 528 facilitating presentation of a user interface component configured to allow input of the target time period for the particular document (e.g., a legal document).

Referring again to FIG. 9C, operation 704 may include operation 930 depicting facilitating acquisition of time period data that includes data that indicates a source time period for the particular document. For example, FIG. 5, e.g., FIG. 5C, shows acquisition of time period data that includes a source time period for the particular document facilitating module 530 facilitating acquisition of time period data that includes data that indicates a source time period for the particular document (e.g., if the document is being typed as a submission, then the source time period may be the time as recorded by the local device that is interacting with the user, or, in an embodiment, the document may be submitted by the user to the computer, and the user may specify a source time).

Referring again to FIG. 9C, operation 530 may include operation 932 depicting determining time period data that includes data that indicates a source time period for the particular document at least partly based on a time when the particular document was submitted. For example, FIG. 5, e.g., FIG. 5C, shows time period data that includes a source time period for the particular document obtaining through analysis of submission time of the particular document module 532 determining time period data that includes data that indicates a source time period for the particular document (e.g., a science fiction novel) at least partly based on a time when the particular document was submitted.

Referring again to FIG. 9C, operation 530 may include operation 934 depicting facilitating presentation of a user interface component configured to allow input of the source time period for the particular document. For example, FIG. 5, e.g., FIG. 5C, shows user interface that allows input of time period data that includes a source time period for an adaptation of the particular document presentation facilitating module 534 facilitating presentation of a user interface component (e.g., a sliding scale that is interactive) configured to allow input of the source time period for the particular document (e.g., the user slides the scale from left (earliest) to right (current date) to input the source time period for the particular document).

It is noted that, in an embodiment, the source time period for the particular document may be determined by the words used in the document themselves, e.g., through analysis of proper names, technical terms, style of writing, and the like, through automation.

Referring now to FIG. 9D, operation 704 may include operation 936 depicting facilitating acquisition of a level data that indicates a target level of technological abstraction for the particular document. For example, FIG. 5, e.g., FIG. 5D, shows acquisition of level data that includes data that indicates a target level of technological abstraction for the particular document facilitating module 536 facilitating acquisition of a level data that indicates a target level of technological abstraction (e.g., component, chip, logic gate, device, system) for the particular document (e.g., a bid proposal for building a system).

Referring again to FIG. 9D, operation 936 may include operation 938 depicting facilitating presentation of a user interface component configured to allow input of the target level of technological abstraction for the particular document. For example, FIG. 5, e.g., FIG. 5D, shows user interface that allows input of the target level of technological abstraction for the particular document presentation facilitating module 538 facilitating presentation of a user interface component (e.g., a sliding scale that is interactive, with “lowest level of abstraction” on the left and “highest level of abstraction” on the right) configured to allow input (e.g., and, in an embodiment, that input may be interactive, so when the user slides the slider bar, the document is updated in near-real-time and the user can see what the result will look like) of the target level of technological abstraction for the particular document.

Referring again to FIG. 9D, operation 704 may include operation 940 depicting facilitating acquisition of a level data that indicates a source level of technological abstraction for the particular document. For example, FIG. 5, e.g., FIG. 5D, shows acquisition of level data that includes data that indicates a source level of technological abstraction for the particular document facilitating module 540 facilitating acquisition of a level data that indicates a source level of technological abstraction for the particular document (e.g., a patent document).

Referring again to FIG. 9D, operation 704 may include operation 942 depicting obtaining the level data that indicates the source level of technological abstraction for the particular document through analysis of one or more lexical units of the particular document. For example, FIG. 5, e.g., FIG. 5D, shows level data that includes data that indicates a source level of technological abstraction for the particular document acquiring through analysis of one or more document lexical units module 542 obtaining the level data that indicates the source level of technological abstraction for the particular document through analysis of one or more lexical units of the document (e.g., there are certain words associated with various levels of technological abstraction, and by recognizing which of those words appear in the document, and with which frequency, a determination regarding the source (e.g., the original, or current) level of abstraction can be obtained through automated analysis of the document).

FIGS. 10A-10G depict various implementations of operation 706, depicting receiving an updated document in which at least a portion of at least one occurrence of the at least one particular lexical unit has been replaced with at least a portion of an acquired replacement lexical unit that is at least partly based on the document modification data, according to embodiments. Referring now to FIG. 10A, operation 706 may include operation 1002 depicting obtaining the updated document in which at least a portion of at least one occurrence of the at least one particular lexical unit has been replaced with at least a portion of the acquired replacement lexical unit that is at least partly based on the document modification data and that is related to the particular lexical unit. For example, FIG. 6, e.g., FIG. 6A, shows adapted document in which at least a portion of at least one occurrence of the at least one particular lexical unit has been replaced with at least a portion of an acquired replacement lexical unit that is at least partly based on the document adaptation data and that is related to the particular lexical unit receiving module 602 obtaining the updated document (e.g., an appeal brief to be submitted to a particular appeals court) in which at least a portion of at least one occurrence of the at least one particular lexical unit (e.g., a passive verb phrase in a particular section of the document that recites the facts of the case) has been replaced with at least a portion of an acquired replacement lexical unit (e.g., an active verb phrase that was generated from the passive verb phrase through automation) that is at least partly based on the document modification data (e.g., the document modification data suggests that passive verbs in that section are bad, and, in an embodiment, the document modification data includes the algorithm for converting passive verb clauses to active verb clauses) and that is related to the particular lexical unit (e.g., is the active verb clause related to the original passive verb clause).

Referring again to FIG. 10A, operation 1002 may include operation 1004 depicting obtaining the updated document in which at least a portion of at least one occurrence of the at least one particular lexical unit has been replaced with at least a portion of the acquired replacement lexical unit that is at least partly based on the document modification data and that represents a shift in time period from the particular lexical unit. For example, FIG. 6, e.g., FIG. 6A, shows adapted document in which at least a portion of at least one occurrence of the at least one particular lexical unit has been replaced with at least a portion of an acquired replacement lexical unit that is at least partly based on the document adaptation data and that is represents a shift in time period from the particular lexical unit receiving module 604 obtaining the updated document (e.g., a movie script set in the 1980s) in which at least a portion of at least one occurrence of the at least one particular lexical unit (e.g., one or more conversational terms from the 1980s) has been replaced with at least a portion of the acquired replacement lexical unit (e.g., one or more conversational terms from the 1960s) that is at least partly based on the document modification data (e.g., which indicates that movies set in the 1960s are currently more popular) and that represents a shift in time period from the particular lexical unit (e.g., the replacement lexical units are all the same expressions as the particular lexical units, but replaced with lingo from the 1960s). The replacement could be accomplished through a custom dictionary, e.g., one that lists 1960s equivalents of 1980s words that is used to traverse the document, or through use of two different dictionaries, one from the 1980s, and one from the 1960s, that include slang and colloquialisms, in which certain particular lexical units are looked up in the dictionary from the 1980s and their definition obtained, and then that definition is cross-referenced against the definitions in the 1960s dictionary to find the closest word, and if it is a different word or words, that lexical unit is designated for replacement with its 1960s counterpart. In this way, the system can use automation to change a 1980s script into a 1960s script.

Referring again to FIG. 10A, operation 1002 may include operation 1006 depicting obtaining the updated document in which at least a portion of at least one occurrence of the at least one particular lexical unit has been replaced with at least a portion of the acquired replacement lexical unit that is at least partly based on the document modification data and that represents a shift in level of technological abstraction from the particular lexical unit. For example, FIG. 6, e.g., FIG. 6A, shows adapted document in which at least a portion of at least one occurrence of the at least one particular lexical unit has been replaced with at least a portion of an acquired replacement lexical unit that is at least partly based on the document adaptation data and that is represents a shift in technological level of abstraction from the particular lexical unit receiving module 606 obtaining the updated document (e.g., an updated patent document) in which at least a portion of at least one occurrence of the at least one particular lexical unit (e.g., the name of a particular device, e.g., an Apple-branded iPhone, or a Samsung-branded Galaxy Tab) has been replaced with at least a portion of the acquired replacement lexical unit replacement lexical unit (e.g., a list of components for the particular device) that is at least partly based on the document modification data (e.g., which includes the technical specifications of devices, so that when a device is found, it can be shifted into its component parts) and that represents a shift in level of technological abstraction (e.g., from “device” to “component parts”) from the particular lexical unit (e.g., the name of the device). It is noted here that “level of technological abstraction” refers to the level at which the details of the operations of the device are obscured. For example, at a top level, the device might describe what it does, e.g., a “smartphone.” At a lower level of technological abstraction, that might be changed to a “device equipped with a Wi-Fi radio and a cellular radio.” At a lower level of technological abstraction, the device might be described as “an input/output touchscreen coupled to a processor that communicates with an antenna, a memory, and one or more sensors.” Each lower level of technological abstraction defines the parts in more and more of their working detail, until at the lowest level of abstraction it becomes a listing of unit parts, e.g., logical gates and smallest-breakdown components, e.g., flip-flops, transistors, and the like. Not every component of a device may be listed at the same level of technological abstraction, for example, the processor in a smartphone may be listed at a lower level of technological abstraction that, for example, a touchscreen.

Referring now to FIG. 10B, operation 1002 may include operation 1008 depicting obtaining the updated document in which at least the portion of the at least one occurrence of the at least one particular lexical unit has been replaced with at least the portion of the acquired replacement lexical unit that was selected at least partly based on acquired potential readership data. For example, FIG. 6, e.g., FIG. 6B, shows adapted document in which at least a portion of at least one occurrence of the at least one particular lexical unit has been replaced with at least a portion of an acquired replacement lexical unit that is at least partly based on the document adaptation data that includes potential readership data receiving module 608 obtaining the updated document (e.g., a poem that is to be submitted for publication in a magazine) in which at least the portion of the at least one occurrence of the at least one particular lexical unit (e.g., a particular adjective phrase) has been replaced with at least the portion of the acquired replacement lexical unit (e.g., a different adjective phrase) that was selected at least partly based on acquired potential readership data (e.g., data regarding the 10,000 readers of the magazine that were polled regarding different adjective phrases, and the adjective phrase of the replacement lexical unit polled substantially better than the adjective phrase of the particular lexical unit).

Referring again to FIG. 10B, operation 1008 may include operation 1010 depicting obtaining the updated document in which at least a portion of the at least one occurrence of the at least one particular lexical unit has been replaced with at least a portion of an acquired replacement lexical unit that was selected at least partly based on one or more preferences expressed in the acquired potential readership data. For example, FIG. 6, e.g., FIG. 6B, shows adapted document in which at least a portion of at least one occurrence of the at least one particular lexical unit has been replaced with at least a portion of an acquired replacement lexical unit that is at least partly based on one or more preferences expressed in the potential readership data receiving module 610 obtaining (e.g., generating, e.g., the one or more operations needed to obtain the updated document occur locally, with remote data being used if necessary) the updated document in which at least a portion of the at least one occurrence of the at least one particular lexical unit (e.g., a word related to “ice”) has been replaced with at least a portion of an acquired replacement lexical unit (e.g., a word related to “water” that has a similar definition) that was selected at least partly based on one or more preferences expressed in the acquired potential readership data (e.g., either through polling, or through use of the generic avatar system (see. e.g., U.S. Pat. No. 8,195,593 B2).

Referring again to FIG. 10B, operation 806 may include operation 1012 depicting obtaining the updated document in which at least one occurrence of the at least one particular lexical unit has been replaced with at least a portion of an acquired replacement lexical unit, wherein the acquired replacement lexical unit is a similar one or more words as the particular lexical unit. For example, FIG. 6, e.g., FIG. 6B, shows adapted document in which at least a portion of at least one occurrence of the at least one particular lexical unit has been replaced with at least a portion of an acquired replacement lexical unit that is at least partly based on the document adaptation data and is a similar one or more words as the particular lexical unit receiving module 612 obtaining (e.g., receiving) the updated document (e.g., an updated patent application document) in which at least one occurrence of the at least one particular lexical unit (e.g., a particular technical reference term that is somewhat archaic) has been replaced with at least a portion of an acquired replacement lexical unit (e.g., a synonymous technical reference term), wherein the acquired replacement lexical unit is a similar one or more words as the particular lexical unit (e.g., they refer to the same technical reference, but one may be a bit more precise, or well understood by artisans of a particular field, etc.).

Referring again to FIG. 10B, operation 1012 may include operation 1014 depicting obtaining the updated document in which at least one occurrence of the at least one particular lexical unit has been replaced with at least a portion of an acquired replacement lexical unit, wherein the acquired replacement lexical unit is a replacement for the particular lexical unit from a particular time period. For example, FIG. 6, e.g., FIG. 6B, shows adapted document in which at least a portion of at least one occurrence of the at least one particular lexical unit has been replaced with at least a portion of an acquired replacement lexical unit that is at least partly based on the document adaptation data and is a replacement from a target time period of one or more words of the particular lexical unit receiving module 614 obtaining the updated document (e.g., a newspaper article) in which at least one occurrence of the at least one particular lexical unit (e.g., a sentence written at a grade 12 level) has been replaced with at least a portion of an acquired replacement lexical unit (e.g., a sentence written at a grade 5 level, which has been automatically generated by assigning a complexity score to each word in the sentence and then replacing the most complex words with simpler synonymous words in turn until the sentence reaches the appropriate reading level), wherein the acquired replacement lexical unit is a replacement for the particular lexical unit from a particular time period.

Referring again to FIG. 10B, operation 1014 may include operation 1016 depicting obtaining the updated document in which at least one occurrence of the at least one particular lexical unit has been replaced with at least a portion of the acquired replacement lexical unit, wherein the acquired replacement lexical unit is a synonym for the particular lexical unit that was used in the particular time period. For example, FIG. 6, e.g., FIG. 6B, shows obtaining the updated document (e.g., a novel set in the 1950s) in which at least one occurrence of the at least one particular lexical unit (e.g., a word that is out of place in the document because it wasn't commonly used in that time period and for one or more other filters (e.g., education level, wealth level, geographic location) of the character or setting to which it applies) has been replaced with at least a portion of the acquired replacement lexical unit (e.g., a synonymous word that is appropriate for the time period and the various other factors), wherein the acquired replacement lexical unit is a synonym for the particular lexical unit that was used in the particular time period (e.g., the particular time period is the time period from the original word, e.g., the present day when the author is writing the book).

Referring now to FIG. 10C, operation 706 may include operation 1018 depicting obtaining the updated document in which at least one occurrence of the at least one particular lexical unit has been replaced with at least a portion of an acquired replacement lexical unit, wherein the acquired replacement lexical unit is a similar one or more words used in a particular time period as the particular lexical unit that did not have a same meaning in the particular time period as in a current time period. For example, FIG. 6, e.g., FIG. 6C, shows adapted document in which at least a portion of at least one occurrence of the at least one particular lexical unit has been replaced with at least a portion of an acquired replacement lexical unit that is at least partly based on the document adaptation data and includes a similar one or more words used in a particular time period to the particular lexical unit that did not have a same meaning in the particular time period as in a current time period obtaining module 618 obtaining the updated document (e.g., an instruction manual) in which at least one occurrence of the at least one particular lexical unit (e.g., a term for one of the components, e.g., a touchscreen) has been replaced with at least a portion of an acquired replacement lexical unit, wherein the acquired replacement lexical unit is a similar one or more words used in a particular time period (e.g., the words in the replacement lexical unit have a similar meaning in the particular time period (e.g., the 1980s) as the particular lexical unit does when the particular lexical unit was used, e.g., in the 2010s) are used as the particular lexical unit that did not have a same meaning in the particular time period as in a current time period (e.g., the particular lexical unit did not mean the same thing in the 1980s as in the 2010s, e.g., “computer monitor” in the 1980s generally meant a CRT, whereas “computer monitor” in the 2010s usually means a flat screen LCD, so that the term “monitor” might be replaced with “CRT device.”

Referring again to FIG. 10C, operation 706 may include operation 1020 depicting obtaining the updated document in which at least one occurrence of the at least one particular lexical unit has been replaced with at least a portion of an acquired replacement lexical unit, wherein the acquired replacement lexical unit is a similar one or more words used in a particular time period as the particular lexical unit that was not in use in the particular time period. For example, FIG. 6, e.g., FIG. 6C, shows adapted document in which at least a portion of at least one occurrence of the at least one particular lexical unit has been replaced with at least a portion of an acquired replacement lexical unit that is at least partly based on the document adaptation data and includes a similar one or more words used in a particular time period to the particular lexical unit that was not in regular use in the particular time period obtaining module 620 obtaining the updated document (e.g., a historical document) in which at least one occurrence of the at least one particular lexical unit has been replaced with at least a portion of an acquired replacement lexical unit, wherein the acquired replacement lexical unit is a similar one or more words used in a particular time period as the particular lexical unit that was not in use in the particular time period (e.g., the original word as part of the particular lexical unit was not in use at the target time for the document, so a replacement lexical unit that means the same thing and that was in use at the target time for the document is selected).

Referring again to FIG. 10C, operation 706 may include operation 1022 depicting obtaining the updated document in which at least one occurrence of the at least one particular lexical unit has been replaced with at least a portion of the acquired replacement lexical unit, wherein the acquired replacement lexical unit represents the particular lexical unit expressed in a vocabulary from a particular time period. For example, FIG. 6, e.g., FIG. 6C, shows adapted document in which at least a portion of at least one occurrence of the at least one particular lexical unit has been replaced with at least a portion of an acquired replacement lexical unit that is at least partly based on the document adaptation data and includes the particular lexical unit expressed in a vocabulary associated with a particular time period obtaining module 622 obtaining the updated document in which at least one occurrence of the at least one particular lexical unit has been replaced with at least a portion of the acquired replacement lexical unit, wherein the acquired replacement lexical unit represents the particular lexical unit expressed in a vocabulary from a particular time period.

Referring again to FIG. 10C, operation 706 may include operation 1024 depicting receiving the updated document in which at least one occurrence of the at least one particular lexical unit has been replaced with at least a portion of the acquired replacement lexical unit, wherein the acquired replacement lexical unit represents the particular lexical unit expressed in a vocabulary from a target time period in which the particular lexical unit had a different meaning in the target time period than a source time period in which the particular document was authored. For example, FIG. 6, e.g., FIG. 6C, shows adapted document in which at least a portion of at least one occurrence of the at least one particular lexical unit has been replaced with at least a portion of an acquired replacement lexical unit that is at least partly based on the document adaptation data and includes a similar one or more words used in a particular time period to the particular lexical unit that did not have a same meaning in the particular time period as in a current time period obtaining module 624 receiving the updated document (e.g., a white paper describing a technology) in which at least one occurrence of the at least one particular lexical unit has been replaced with at least a portion of the acquired replacement lexical unit, wherein the acquired replacement lexical unit represents the particular lexical unit expressed in a vocabulary from a target time period in which the particular lexical unit had a different meaning in the target time period than a source time period in which the particular document was authored.

Referring now to FIG. 10D, operation 706 may include operation 1026 depicting obtaining the updated document in which at least one occurrence of the at least one particular lexical unit has been replaced with at least a portion of the acquired replacement lexical unit, wherein the acquired replacement lexical unit represents the particular lexical unit expressed in a vocabulary from a target time period in which the particular lexical unit was not in common use. For example, FIG. 6, e.g., FIG. 6D, shows adapted document in which at least a portion of at least one occurrence of the at least one particular lexical unit has been replaced with at least a portion of an acquired replacement lexical unit that is at least partly based on the document adaptation data and includes a similar one or more words used in a particular time period to the particular lexical unit that was not in common use in the particular time period obtaining module 626 obtaining the updated document in which at least one occurrence of the at least one particular lexical unit has been replaced with at least a portion of the acquired replacement lexical unit, wherein the acquired replacement lexical unit represents the particular lexical unit expressed in a vocabulary from a target time period in which the particular lexical unit was not in common use.

Referring again to FIG. 10D, operation 706 may include operation 1028 depicting receiving the updated document in which at least a portion of at least one occurrence of the at least one particular lexical unit has been replaced with at least the portion of the acquired replacement lexical unit, wherein said obtaining is from a location at which the replacement lexical unit was acquired. For example, FIG. 6, e.g., FIG. 6D, shows adapted document in which at least a portion of at least one occurrence of the at least one particular lexical unit has been replaced with at least a portion of an acquired replacement lexical unit that is at least partly based on the document adaptation data receiving from a location of acquisition of the replacement lexical unit module 628 receiving the updated document (e.g., a newspaper article) in which at least a portion of at least one occurrence of the at least one particular lexical unit (e.g., a word that indicates a particular political slant that may not be appropriate for the newspaper's audience) has been replaced with at least the portion of the acquired replacement lexical unit (e.g., a word with a similar meaning but a different or absent political slant), wherein said receiving is from a location at which the replacement lexical unit was acquired (e.g., the updated document is received from the location, e.g., the remote server, that determined the particular lexical unit and replaced it with the replacement lexical unit).

Referring again to FIG. 10D, operation 1028 may include operation 1030 depicting obtaining the updated document in which at least one occurrence of the at least one particular lexical unit has been replaced with the acquired replacement lexical unit, wherein said obtaining is from the location at which the replacement lexical unit was acquired from potential readership data. For example, FIG. 6, e.g., FIG. 6D, shows adapted document in which at least a portion of at least one occurrence of the at least one particular lexical unit has been replaced with at least a portion of an acquired replacement lexical unit that is at least partly based on the document adaptation data receiving from a location of acquisition of the replacement lexical unit that is at least partly based on potential readership data module 630 obtaining the updated document (e.g., a patent application, a response to an office action, a document to be submitted before the patent office, or a legal document in a patent proceeding) in which at least one occurrence of the at least one particular lexical unit (e.g., the words “present invention”) has been replaced with the acquired replacement lexical unit (e.g., nothing, null set, or blank space, as appropriate), wherein said receiving is from the location (e.g., a remote server that is performing automation to view the patent document through a subscription-based legal services provider) at which the replacement lexical unit was acquired from potential readership data (e.g., the readership data indicated that the readership (examiner, judge, appeals board, potential licensee, etc.) does not like the words “present invention”) and the automation decides to remove the words rather than replace them with other words. It is noted that, as in the foregoing example, the replacement lexical unit may be empty space, or no character at all (deletion).

Referring again to FIG. 10D, operation 1028 may include operation 1032 depicting obtaining the updated document in which at least one occurrence of the at least one particular lexical unit has been replaced with the acquired replacement lexical unit, wherein said obtaining is from the location at which the replacement lexical unit was acquired through use of a time period-based dictionary. For example, FIG. 6, e.g., FIG. 6D, shows adapted document in which at least a portion of at least one occurrence of the at least one particular lexical unit has been replaced with at least a portion of an acquired replacement lexical unit that is at least partly based on the document adaptation data receiving from a location of acquisition of the replacement lexical unit that is at least partly based on a time-period based dictionary module 632 obtaining the updated document (e.g., an alternate-world historical fiction document) in which at least one occurrence of the at least one particular lexical unit has been replaced with the acquired replacement lexical unit, wherein said receiving is from the location at which the replacement lexical unit was acquired through use of a time-period based dictionary (e.g., the Microsoft Computer Dictionary from 1980, a dictionary of computer architecture that explicitly lists how part names evolved over time, a dictionary that includes all the specific terms to a particular brand, e.g., Apple, and a dictionary that is time-linked explicitly).

Referring again to FIG. 10D, operation 1028 may include operation 1034 depicting obtaining the updated document in which at least one occurrence of the at least one particular lexical unit has been replaced with the acquired replacement lexical unit, wherein said obtaining is from the location at which the replacement lexical unit was acquired through use of one or more specifications of technical material. For example, FIG. 6, e.g., FIG. 6D, shows adapted document in which at least a portion of at least one occurrence of the at least one particular lexical unit has been replaced with at least a portion of an acquired replacement lexical unit that is at least partly based on the document adaptation data receiving from a location of acquisition of the replacement lexical unit that is at least partly based on one or more technical specifications module 634 obtaining the updated document (e.g., an updated instruction page for a device teardown for a website) in which at least one occurrence of the at least one particular lexical unit (e.g., a trade name of a device, e.g., an “Apple iPad”) has been replaced with the acquired replacement lexical unit (e.g., a list of parts of the Apple iPad at a different level of technological abstraction), wherein said obtaining is from the location at which the replacement lexical unit was acquired through use of one or more specifications of technical material (e.g., schematics of the device trade name).

Referring now to FIG. 10E, operation 1028 may include operation 1036 depicting obtaining the updated document in which at least one occurrence of the at least one particular lexical unit has been replaced with the acquired replacement lexical unit, wherein said obtaining is from the location at which the replacement lexical unit was acquired through use of one or more tools for altering a level of technological abstraction. For example, FIG. 6, e.g., FIG. 6D, shows adapted document in which at least a portion of at least one occurrence of the at least one particular lexical unit has been replaced with at least a portion of an acquired replacement lexical unit that is at least partly based on the document adaptation data receiving from a location of acquisition of the replacement lexical unit that is at least partly acquired through use of one or more tools for altering a technical level of abstraction module 636 obtaining the updated document (e.g., a document for engineers that describes several proprietary programs) in which at least one occurrence of the at least one particular lexical unit (e.g., a name of a particular proprietary program) has been replaced with the acquired replacement lexical unit (e.g., a decompiled version of the program that reveals a portion of the source code), wherein said obtaining is from the location at which the replacement lexical unit (e.g., the decompiled version that reveals a portion of the source code) was acquired through use of one or more tools for altering a level of technological abstraction (e.g., one or more known decompiler tools). It is noted that although levels of technological abstraction can refer to software levels of abstraction, as here, it is not limited to this embodiment, as other levels of abstraction, e.g., component/hardware levels of abstraction also may be included, as described in one or more of the following examples).

Referring now to FIG. 10F, operation 706 may include operation 1038 depicting obtaining the updated document in which at least one occurrence of the at least one particular lexical unit has been replaced with at least a portion of an acquired replacement lexical unit, wherein the acquired replacement lexical unit includes one or more words related to the particular lexical unit. For example, FIG. 6, e.g., FIG. 6E, shows adapted document in which at least a portion of at least one occurrence of the at least one particular lexical unit has been replaced with at least a portion of an acquired replacement lexical unit that is at least partly based on the document adaptation data and that includes one or more words related to the particular lexical unit obtaining module 638 obtaining the updated document (e.g., a narrative work crafted for a court as a statement of underlying facts) in which at least one occurrence of the at least one particular lexical unit (e.g., a phrase, e.g., “she sputtered”), has been replaced with at least a portion of an acquired replacement lexical unit (e.g., a different said bookism, e.g., “she said”), wherein the acquired replacement lexical unit includes one or more words related to the particular lexical unit (e.g., the particular lexical unit has a similar meaning to the replacement lexical unit.

Referring again to FIG. 10F, operation 1038 may include operation 1040 depicting obtaining the updated document in which at least one occurrence of the at least one particular lexical unit has been replaced with at least a portion of an acquired replacement lexical unit, wherein the acquired replacement lexical unit includes one or more words that represent a different level of technological abstraction of the particular lexical unit. For example, FIG. 6, e.g., FIG. 6F, shows adapted document in which at least a portion of at least one occurrence of the at least one particular lexical unit has been replaced with at least a portion of an acquired replacement lexical unit that is at least partly based on the document adaptation data and that includes one or more words that represent a different level of technological abstraction than the particular lexical unit obtaining module 640 obtaining the updated document (e.g., an article for an IEEE publication) in which at least one occurrence of the at least one particular lexical unit (e.g., a high-level description of an earthquake detection device) has been replaced with at least a portion of an acquired replacement lexical unit (e.g., a description of the components of the earthquake detection device and how they interrelate), wherein the acquired replacement lexical unit includes one or more words that represent a different level of technological abstraction (e.g., components vs. device) of the particular lexical unit (e.g., the words used to describe the earthquake detection device).

Referring again to FIG. 10F, operation 1038 may include operation 1042 depicting obtaining the updated document in which at least one occurrence of the at least one particular lexical unit has been replaced with at least a portion of an acquired replacement lexical unit, wherein the acquired replacement lexical unit includes one or more words that express the particular lexical unit at a different level of technological abstraction than the particular lexical unit. For example, FIG. 6, e.g., FIG. 6F, shows adapted document in which at least a portion of at least one occurrence of the at least one particular lexical unit has been replaced with at least a portion of an acquired replacement lexical unit that is at least partly based on the document adaptation data and that includes one or more words that express a level of technological abstraction using different words than the particular lexical unit obtaining module 642 obtaining the updated document (e.g., a to-be-filed patent application) in which at least one occurrence of the at least one particular lexical unit has been replaced with at least a portion of an acquired replacement lexical unit, wherein the acquired replacement lexical unit includes one or more words that express the particular lexical unit at a different level of technological abstraction (e.g., at a chip level rather than a component level) than the particular lexical unit (e.g., which may operate at a component level).

Referring again to FIG. 10F, operation 1038 may include operation 1044 depicting obtaining the updated document in which at least one occurrence of the at least one particular lexical unit has been replaced with at least a portion of an acquired replacement lexical unit, wherein the acquired replacement lexical unit includes one or more words that express the particular lexical unit at a different level of technological abstraction through computerized analysis of the particular lexical unit. For example, FIG. 6, e.g., FIG. 6F, shows adapted document in which at least a portion of at least one occurrence of the at least one particular lexical unit has been replaced with at least a portion of an acquired replacement lexical unit that is at least partly based on the document adaptation data and that includes one or more words that express a level of technological abstraction using words generated by a computerized analysis of the particular lexical unit obtaining module 644 obtaining the updated document (e.g., an updated account of an event) in which the at least one occurrence of the at least one particular lexical unit (e.g., a technical description of a collection of parts) has been replaced with at least a portion of an acquired replacement lexical unit (e.g., a higher level of abstraction word that represents the collection of parts as they are arranged), wherein the acquired replacement lexical unit includes one or more words that express the particular lexical unit at a different level of technological abstraction (e.g., in this instance, a higher level of technological abstraction, e.g., more workings of the device are hidden) through computerized analysis of the particular lexical unit (e.g., a comparison of the parts and their arrangement to known devices, modules, and circuits, which can be performed through automation that has access to databases of known existing arrangements of similar parts).

Referring again to FIG. 10F, operation 1038 may include operation 1046 depicting obtaining the updated document in which at least one occurrence of the at least one particular lexical unit has been replaced with at least a portion of an acquired replacement lexical unit, wherein the acquired replacement lexical unit includes one or more words that express the particular lexical unit at a different level of technological abstraction through use of one or more dictionaries that include the particular lexical unit. For example, FIG. 6, e.g., FIG. 6F, shows adapted document in which at least a portion of at least one occurrence of the at least one particular lexical unit has been replaced with at least a portion of an acquired replacement lexical unit that is at least partly based on the document adaptation data and that includes one or more words that express a level of technological abstraction using words selected through use of one or more dictionaries that include the particular lexical unit obtaining module 646 obtaining the updated document (e.g., a technical document) in which at least one occurrence of the at least one particular lexical unit (e.g., a particular word of a device in the technical document) has been replaced with at least a portion of an acquired replacement lexical unit (e.g., a different word), wherein the acquired replacement lexical unit includes one or more words that express the particular lexical unit at a different level of technological abstraction through use of one or more dictionaries (e.g., the Microsoft Computer Dictionary, a dictionary of computer architecture, a dictionary that includes all the specific terms to a particular brand, e.g., Apple) that include the particular lexical unit (e.g., a particular device listed in the document).

Referring now to FIG. 10G, operation 706 may include operation 1048 depicting obtaining the updated document in which at least a portion of at least one occurrence of the at least one particular lexical unit has been replaced with at least a portion of an acquired replacement lexical unit that was selected based on prior analysis of one or more existing documents. For example, FIG. 6, e.g., FIG. 6G, shows adapted document in which at least a portion of at least one occurrence of the at least one particular lexical unit has been replaced with at least a portion of an acquired replacement lexical unit that is selected at least partly based on prior analysis of one or more existing documents obtaining module 648 obtaining the updated document (e.g., an appeal brief written to the Patent and Trademark Appeals Board) in which at least a portion of at least one occurrence of the at least one particular lexical unit (e.g., a particular way of formatting a citation to the record) has been replaced with at least a portion of an acquired replacement lexical unit (e.g., a different way of formatting a citation to the record of the application prosecution) that was selected based on prior analysis of one or more existing documents (e.g., an analysis of winning and losing briefs was conducted, and it was found that a particular method of citation resulted in a correlation of a 5% greater winning rate).

Referring again to FIG. 10G, operation 1048 may include operation 1050 depicting obtaining the updated document in which at least a portion of at least one occurrence of the at least one particular lexical unit has been replaced with at least a portion of an acquired replacement lexical unit that was selected based on prior analysis of one or more existing documents that have a particular feature in common. For example, FIG. 6, e.g., FIG. 6G, shows adapted document in which at least a portion of at least one occurrence of the at least one particular lexical unit has been replaced with at least a portion of an acquired replacement lexical unit that is selected at least partly based on prior analysis of one or more existing documents that have a common property obtaining module 650 obtaining the updated document (e.g., a science-fiction/fantasy novel) in which at least a portion of at least one occurrence of the at least one particular lexical unit (e.g., a reference to vampires) has been replaced with at least a portion of an acquired replacement lexical unit (e.g., a reference to some other mythical creature that polled well for sales) that was selected based on prior analysis of one or more existing documents (e.g., existing science-fiction/fantasy novels that were consumed by a particular demographic) that have a particular feature in common (e.g., belong to the same genre, or purchased in a particular number by a particular demographic, or contain greater than 200,000 words, for example).

Referring again to FIG. 10G, operation 1050 may include operation 1052 depicting obtaining the updated document in which at least a portion of at least one occurrence of the at least one particular lexical unit has been replaced with at least a portion of an acquired replacement lexical unit that was selected based on prior analysis of one or more existing documents that were authored for a particular readership. For example, FIG. 6, e.g., FIG. 6G, shows adapted document in which at least a portion of at least one occurrence of the at least one particular lexical unit has been replaced with at least a portion of an acquired replacement lexical unit that is selected at least partly based on prior analysis of one or more existing documents that were authored for a common readership obtaining module 652 obtaining the updated document (e.g., a scientific journal article) in which at least a portion of at least one occurrence of the at least one particular lexical unit (e.g., paragraphs without a topic sentence) has been replaced with at least a portion of an acquired replacement lexical unit (e.g., a same paragraph with a topic sentence that is automatically generated through scanning and performing word/concept recognition of the paragraph (e.g., but the topic sentence may need to be proofread or refined by a human, so, in an embodiment, the newly added topic sentence may be marked in some manner, e.g., through Track Changes in a Microsoft Word-branded word processor)) that was selected based on prior analysis (e.g., all the articles that were submitted for a journal and a list of the ones that were published were analyzed, and it was determined that having a topic sentence in every paragraph correlated to a 25% increased chance of getting published in that particular journal) of one or more documents (e.g., submitted journal articles) that were authored for a particular readership (e.g., the panel that selects documents for journal inclusion; or, the readership of the journal to which the document is to be submitted).

Referring again to FIG. 10G, operation 1050 may include operation 1054 depicting obtaining the updated document in which at least a portion of at least one occurrence of the at least one particular lexical unit has been replaced with at least a portion of an acquired replacement lexical unit that was selected based on prior analysis of one or more existing documents that resulted in a particular objective outcome. For example, FIG. 6, e.g., FIG. 6G, shows adapted document in which at least a portion of at least one occurrence of the at least one particular lexical unit has been replaced with at least a portion of an acquired replacement lexical unit that is selected at least partly based on prior analysis of one or more existing documents that resulted in a particular measurable event outcome obtaining module 654 obtaining (e.g., receiving) the updated document (e.g., a legal brief) in which at least a portion of at least one occurrence of the at least one particular lexical unit (e.g., a citation to a case in a specific court that is viewed disfavorably by one or more judges that potentially may read the opinion) has been replaced with at least a portion of an acquired replacement lexical unit (e.g., an alternate citation that was found through use of machine searching of a database of case law for the same/similar legal proposition, and cited in a court that is not viewed disfavorably by one or more judges that potentially may read the opinion) that was selected based on prior analysis (e.g., machine analysis of legal briefs and the outcomes that were generated by the legal briefs, with a large enough sample size to remove noise from the underlying facts (e.g., sometimes a brief is good but the facts are bad, or vice versa, but with a large enough sample size for the population, those factors can be reduced or minimized)) of one or more existing documents (e.g., previously filed legal briefs in cases whose outcome is known and trackable) that resulted in a particular objective outcome (e.g., winning or losing the case for a particular side, e.g., plaintiff or defendant).

Referring again to FIG. 10G, operation 1050 may include operation 1056 depicting obtaining the updated document in which at least a portion of at least one occurrence of the at least one particular lexical unit has been replaced with at least a portion of an acquired replacement lexical unit that was selected based on prior analysis of one or more existing documents that have a particular feature in common with the particular document. For example, FIG. 6, e.g., FIG. 6G, shows adapted document in which at least a portion of at least one occurrence of the at least one particular lexical unit has been replaced with at least a portion of an acquired replacement lexical unit that is selected at least partly based on prior analysis of one or more existing documents that have a common property with the particular document obtaining module 656 obtaining the updated document (e.g., a fictional novel) in which at least a portion of at least one occurrence of the at least one particular lexical unit (e.g., a paragraph written in intentionally nonstandard English (e.g., similar to the writings of Cormac McCarthy) with at least a portion of an acquired replacement lexical unit (e.g., a the same paragraph written in proper English, which was generated automatically through use of a grammar correcting algorithm) that was selected based on prior analysis (e.g., analysis that revealed that critics in the target audience had a strong dislike (e.g., wrote bad reviews for) documents that used intentionally nonstandard English) of one or more existing documents (e.g., other works of fiction) that have a particular feature in common with the particular document (e.g., the other existing documents were all works of fiction).

Referring again to FIG. 10G, operation 1050 may include operation 1058 depicting obtaining the updated document in which at least a portion of at least one occurrence of the at least one particular lexical unit has been replaced with at least a portion of an acquired replacement lexical unit that was selected based on prior analysis of one or more existing documents that were authored for a similar audience as the particular document. For example, FIG. 6, e.g., FIG. 6G, shows adapted document in which at least a portion of at least one occurrence of the at least one particular lexical unit has been replaced with at least a portion of an acquired replacement lexical unit that is selected at least partly based on prior analysis of one or more existing documents that were authored for a common readership with the particular document obtaining module 658 obtaining the updated document (e.g., the document in which the particular lexical unit has been replaced with the replacement lexical unit, e.g., a patent application document in which the term “smartphone” has been replaced with the term “internet-enabled cellular and wi-fi radio device”) in which at least a portion of at least one occurrence of the at least one particular lexical unit (e.g., the term “smartphone”) has been replaced with at least a portion of an acquired replacement lexical unit (e.g., the term “internet-enabled cellular and wi-fi radio device”) that was selected based on prior analysis (e.g., grouping the existing documents and their objectively measurable outcomes, drawing correlations between contents of the documents and outcomes, and generating hypotheses based on the drawn correlations) of one or more existing documents (e.g., patent applications in a similar technological field) that were authored for a similar audience (e.g., a particular set of patent examiners) as the particular document (e.g., a patent application which is likely to be examined by a particular set of patent examiners in a particular technological art unit).

It is noted that, in the foregoing examples, various concrete, real-world examples of terms that appear in the following claims are described. These examples are meant to be exemplary only and non-limiting. Moreover, any example of any term may be combined or added to any example of the same term in a different place, or a different term in a different place, unless context dictates otherwise.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.)

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Throughout this application, the terms “in an embodiment,” ‘in one embodiment,” “in an embodiment,” “in several embodiments,” “in at least one embodiment,” “in various embodiments,” and the like, may be used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the invention. The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1. A computationally-implemented method, comprising:
accepting a submission of a particular document that includes at least one particular lexical unit;
facilitating acquisition of document modification data that includes data configured to be used to determine a modification to the particular document; and
receiving an updated document in which at least a portion of at least one occurrence of the at least one particular lexical unit has been replaced with at least a portion of an acquired replacement lexical unit that is at least partly based on the document modification data.

2. (canceled)

3. (canceled)

4. The computationally-implemented method of claim 1, wherein said accepting a submission of a particular document that includes at least one particular lexical unit comprises:
receiving an indication that a portion of a user interface was interacted with, said portion of the user interface configured to indicate submission of the particular document that includes the at least one particular lexical unit.

5. (canceled)

6. The computationally-implemented method of claim 1, wherein said accepting a submission of a particular document that includes at least one particular lexical unit comprises:
accepting the submission of a legal document that includes the at least one particular lexical unit.

7. (canceled)

8. The computationally-implemented method of claim 1, wherein said accepting a submission of a particular document that includes at least one particular lexical unit comprises:
accepting the submission of a patent document that includes the at least one particular lexical unit.

9. (canceled)

10. (canceled)

11. (canceled)

12. (canceled)

13. The computationally-implemented method of claim 1, wherein said accepting a submission of a particular document that includes at least one particular lexical unit comprises:
accepting the submission of the particular document that includes the at least one particular lexical unit, wherein the particular lexical unit is defined as a lexical unit that appears in the particular document more than a particular number of times.

14. (canceled)

15. The computationally-implemented method of claim 1, wherein said accepting a submission of a particular document that includes at least one particular lexical unit comprises:
accepting the submission of the particular document that includes the at least one particular lexical unit, wherein the particular lexical unit is one or more words that have a particular characteristic.

16. (canceled)

17. (canceled)

18. The computationally-implemented method of claim 15, wherein said accepting the submission of the particular document that includes the at least one particular lexical unit, wherein the particular lexical unit is one or more words that have a particular characteristic comprises:
accepting the submission of the particular document that includes the at least one particular lexical unit, wherein the particular lexical unit is recognized as a colloquialism associated with a particular readership.

19. The computationally-implemented method of claim 1, wherein said accepting a submission of a particular document that includes at least one particular lexical unit comprises:
receiving the submission of the particular document;
receiving data that defines one or more characteristics of the at least one particular lexical unit; and
identifying, in the particular document, the at least one particular lexical unit.

20. The computationally-implemented method of claim 1, wherein said accepting a submission of a particular document that includes at least one particular lexical unit comprises:
receiving the submission of the particular document; and
identifying the at least one particular lexical unit in the particular document.

21. (canceled)

22. (canceled)

23. (canceled)

24. The computationally-implemented method of claim 1, wherein said facilitating acquisition of document modification data that includes data configured to be used to determine a modification to the particular document comprises:
acquiring document modification data that identifies a target audience for the particular document.

25. (canceled)

26. (canceled)

27. The computationally-implemented method of claim 24, wherein said acquiring document modification data that identifies a target audience for the particular document comprises:
acquiring document modification data that includes a list of one or more entities that are designated to read the particular document.

28. The computationally-implemented method of claim 27, wherein said acquiring document modification data that includes a list of one or more entities that are designated to read the particular document comprises:
acquiring document modification data that includes a list of one or more entities that are designated to substantively evaluate the particular document.

29. The computationally-implemented method of claim 28, wherein said acquiring document modification data that includes a list of one or more entities that are designated to substantively evaluate the particular document comprises:
acquiring document modification data that includes a list of one or more judges that are designated to decide an outcome of an event at least partially based on the particular document.

30. (canceled)

31. The computationally-implemented method of claim 1, wherein said facilitating acquisition of document modification data that includes data configured to be used to determine a modification to the particular document comprises:
receiving inputted document modification data that includes data configured to be used to determine the modification to the particular document; and
transmitting the received document modification data that includes data configured to be used to determine a modification to the particular document, to an entity configured to perform modification on the particular document.

32. The computationally-implemented method of claim 1, wherein said facilitating acquisition of document modification data that includes data configured to be used to determine a modification to the particular document comprises:
facilitating acquisition of time period data that includes data that indicates a target time period for the particular document.

33. (canceled)

34. The computationally-implemented method of claim 1, wherein said facilitating acquisition of document modification data that includes data configured to be used to determine a modification to the particular document comprises:
facilitating acquisition of time period data that includes data that indicates a source time period for the particular document.

35. (canceled)

36. (canceled)

37. The computationally-implemented method of claim 1, wherein said facilitating acquisition of document modification data that includes data configured to be used to determine a modification to the particular document comprises:
facilitating acquisition of a level data that indicates a target level of technological abstraction for the particular document.

38. (canceled)

39. The computationally-implemented method of claim 1, wherein said facilitating acquisition of document modification data that includes data configured to be used to determine a modification to the particular document comprises:
facilitating acquisition of a level data that indicates a source level of technological abstraction for the particular document.

40. The computationally-implemented method of claim 39, wherein said facilitating acquisition of a level data that indicates a source level of technological abstraction for the particular document comprises:
obtaining the level data that indicates the source level of technological abstraction for the particular document through analysis of one or more lexical units of the particular document.

41. The computationally-implemented method of claim 1, wherein said receiving an updated document in which at least a portion of at least one occurrence of the at least one particular lexical unit has been replaced with at least a portion of an acquired replacement lexical unit that is at least partly based on the document modification data comprises:
obtaining the updated document in which at least a portion of at least one occurrence of the at least one particular lexical unit has been replaced with at least a portion of the acquired replacement lexical unit that is at least partly based on the document modification data and that is related to the particular lexical unit.

42. The computationally-implemented method of claim 41, wherein said obtaining the updated document in which at least a portion of at least one occurrence of the at least one particular lexical unit has been replaced with at least a portion of the acquired replacement lexical unit that is at least partly based on the document modification data and that is related to the particular lexical unit comprises:
obtaining the updated document in which at least a portion of at least one occurrence of the at least one particular lexical unit has been replaced with at least a portion of the acquired replacement lexical unit that is at least partly based on the document modification data and that represents a shift in time period from the particular lexical unit.

43. The computationally-implemented method of claim 41, wherein said obtaining the updated document in which at least a portion of at least one occurrence of the at least one particular lexical unit has been replaced with at least a portion of the acquired replacement lexical unit that is at least partly based on the document modification data and that is related to the particular lexical unit comprises:
obtaining the updated document in which at least a portion of at least one occurrence of the at least one particular lexical unit has been replaced with at least a portion of the acquired replacement lexical unit that is at least partly based on the document modification data and that represents a shift in level of technological abstraction from the particular lexical unit.

44. The computationally-implemented method of claim 1, wherein said receiving an updated document in which at least a portion of at least one occurrence of the at least one particular lexical unit has been replaced with at least a portion of an acquired replacement lexical unit that is at least partly based on the document modification data comprises:
obtaining the updated document in which at least the portion of the at least one occurrence of the at least one particular lexical unit has been replaced with at least the portion of the acquired replacement lexical unit that was selected at least partly based on acquired potential readership data.

45. (canceled)

46. (canceled)

47. (canceled)

48. (canceled)

49. The computationally-implemented method of claim 1, wherein said receiving an updated document in which at least a portion of at least one occurrence of the at least one particular lexical unit has been replaced with at least a portion of an acquired replacement lexical unit that is at least partly based on the document modification data comprises:
obtaining the updated document in which at least one occurrence of the at least one particular lexical unit has been replaced with at least a portion of an acquired replacement lexical unit, wherein the acquired replacement lexical unit is a similar one or more words used in a particular time period as the particular lexical unit that did not have a same meaning in the particular time period as in a current time period.

50. The computationally-implemented method of claim 1, wherein said receiving an updated document in which at least a portion of at least one occurrence of the at least one particular lexical unit has been replaced with at least a portion of an acquired replacement lexical unit that is at least partly based on the document modification data comprises:
obtaining the updated document in which at least one occurrence of the at least one particular lexical unit has been replaced with at least a portion of an acquired replacement lexical unit, wherein the acquired replacement lexical unit is a similar one or more words used in a particular time period as the particular lexical unit that was not in use in the particular time period.

51. (canceled)

52. (canceled)

53. The computationally-implemented method of claim 1, wherein said receiving an updated document in which at least a portion of at least one occurrence of the at least one particular lexical unit has been replaced with at least a portion of an acquired replacement lexical unit that is at least partly based on the document modification data comprises:
obtaining the updated document in which at least one occurrence of the at least one particular lexical unit has been replaced with at least a portion of the acquired replacement lexical unit, wherein the acquired replacement lexical unit represents the particular lexical unit expressed in a vocabulary from a target time period in which the particular lexical unit was not in common use.

54. The computationally-implemented method of claim 1, wherein said receiving an updated document in which at least a portion of at least one occurrence of the at least one particular lexical unit has been replaced with at least a portion of an acquired replacement lexical unit that is at least partly based on the document modification data comprises:
receiving the updated document in which at least a portion of at least one occurrence of the at least one particular lexical unit has been replaced with at least the portion of the acquired replacement lexical unit, wherein said obtaining is from a location at which the replacement lexical unit was acquired.

55. (canceled)

56. The computationally-implemented method of claim 54, wherein said receiving the updated document in which at least a portion of at least one occurrence of the at least one particular lexical unit has been replaced with at least the portion of the acquired replacement lexical unit, wherein said obtaining is from a location at which the replacement lexical unit was acquired comprises:
obtaining the updated document in which at least one occurrence of the at least one particular lexical unit has been replaced with the acquired replacement lexical unit, wherein said obtaining is from the location at which the replacement lexical unit was acquired through use of a time period-based dictionary.

57. The computationally-implemented method of claim 54, wherein said receiving the updated document in which at least a portion of at least one occurrence of the at least one particular lexical unit has been replaced with at least the portion of the acquired replacement lexical unit, wherein said obtaining is from a location at which the replacement lexical unit was acquired comprises:
obtaining the updated document in which at least one occurrence of the at least one particular lexical unit has been replaced with the acquired replacement lexical unit, wherein said obtaining is from the location at which the replacement lexical unit was acquired through use of one or more specifications of technical material.

58. The computationally-implemented method of claim 54, wherein said receiving the updated document in which at least a portion of at least one occurrence of the at least one particular lexical unit has been replaced with at least the portion of the acquired replacement lexical unit, wherein said obtaining is from a location at which the replacement lexical unit was acquired comprises:
obtaining the updated document in which at least one occurrence of the at least one particular lexical unit has been replaced with the acquired replacement lexical unit, wherein said obtaining is from the location at which the replacement lexical unit was acquired through use of one or more tools for altering a level of technological abstraction.

59. The computationally-implemented method of claim 1, wherein said receiving an updated document in which at least a portion of at least one occurrence of the at least one particular lexical unit has been replaced with at least a portion of an acquired replacement lexical unit that is at least partly based on the document modification data comprises:
obtaining the updated document in which at least one occurrence of the at least one particular lexical unit has been replaced with at least a portion of an acquired replacement lexical unit, wherein the acquired replacement lexical unit includes one or more words related to the particular lexical unit.

60. (canceled)

61. The computationally-implemented method of claim 59, wherein said obtaining the updated document in which at least one occurrence of the at least one particular lexical unit has been replaced with at least a portion of an acquired replacement lexical unit, wherein the acquired replacement lexical unit includes one or more words related to the particular lexical unit comprises:
obtaining the updated document in which at least one occurrence of the at least one particular lexical unit has been replaced with at least a portion of an acquired replacement lexical unit, wherein the acquired replacement lexical unit includes one or more words that express the particular lexical unit at a different level of technological abstraction than the particular lexical unit.

62. The computationally-implemented method of claim 59, wherein said obtaining the updated document in which at least one occurrence of the at least one particular lexical unit has been replaced with at least a portion of an acquired replacement lexical unit, wherein the acquired replacement lexical unit includes one or more words related to the particular lexical unit comprises:
obtaining the updated document in which at least one occurrence of the at least one particular lexical unit has been replaced with at least a portion of an acquired replacement lexical unit, wherein the acquired replacement lexical unit includes one or more words that express the particular lexical unit at a different level of technological abstraction through computerized analysis of the particular lexical unit.

63. (canceled)

64. The computationally-implemented method of claim 1, wherein said receiving an updated document in which at least a portion of at least one occurrence of the at least one particular lexical unit has been replaced with at least a portion of an acquired replacement lexical unit that is at least partly based on the document modification data comprises:
obtaining the updated document in which at least a portion of at least one occurrence of the at least one particular lexical unit has been replaced with at least a portion of an acquired replacement lexical unit that was selected based on prior analysis of one or more existing documents.

65. The computationally-implemented method of claim 64, wherein said obtaining the updated document in which at least a portion of at least one occurrence of the at least one particular lexical unit has been replaced with at least a portion of an acquired replacement lexical unit that was selected based on prior analysis of one or more existing documents comprises:
obtaining the updated document in which at least a portion of at least one occurrence of the at least one particular lexical unit has been replaced with at least a portion of an acquired replacement lexical unit that was selected based on prior analysis of one or more existing documents that have a particular feature in common.

66. The computationally-implemented method of claim 65, wherein said obtaining the updated document in which at least a portion of at least one occurrence of the at least one particular lexical unit has been replaced with at least a portion of an acquired replacement lexical unit that was selected based on prior analysis of one or more existing documents that have a particular feature in common comprises:
obtaining the updated document in which at least a portion of at least one occurrence of the at least one particular lexical unit has been replaced with at least a portion of an acquired replacement lexical unit that was selected based on prior analysis of one or more existing documents that were authored for a particular readership.

67. The computationally-implemented method of claim 65, wherein said obtaining the updated document in which at least a portion of at least one occurrence of the at least one particular lexical unit has been replaced with at least a portion of an acquired replacement lexical unit that was selected based on prior analysis of one or more existing documents that have a particular feature in common comprises:
obtaining the updated document in which at least a portion of at least one occurrence of the at least one particular lexical unit has been replaced with at least a portion of an acquired replacement lexical unit that was selected based on prior analysis of one or more existing documents that resulted in a particular objective outcome.

68. (canceled)

69. (canceled)

70. (canceled)

71. A computationally-implemented system, comprising
means for accepting a submission of a particular document that includes at least one particular lexical unit;
means for facilitating acquisition of document modification data that includes data configured to be used to determine a modification to the particular document; and
means for receiving an updated document in which at least a portion of at least one occurrence of the at least one particular lexical unit has been replaced with at least a portion of an acquired replacement lexical unit that is at least partly based on the document modification data.

72-142. (canceled)

143. A device defined by a computational language comprising:
one or more interchained physical machines ordered for accepting a submission of a particular document that includes at least one particular lexical unit;
one or more interchained physical machines ordered for facilitating acquisition of document modification data that includes data configured to be used to determine a modification to the particular document; and
one or more interchained physical machines ordered for receiving an updated document in which at least a portion of at least one occurrence of the at least one particular lexical unit has been replaced with at least a portion of an acquired replacement lexical unit that is at least partly based on the document modification data.
